(19) United States
(12) Patent Application Publication
(10) Pub. No.: US 2001/0047279 A1
(43) Pub. Date: Nov. 29, 2001

(54) Automating high-level business functions in a generic manner

(76) Inventor: Peter Sebastian Gargone, New York, NY (US)

Correspondence Address: MORGAN & FINNEGAN, L.L.P., 345 Park Avenue, New York, NY, 10154-0053, US

(21) Appl. No.: 09/834,287

(22) Filed: Apr. 12, 2001

Related U.S. Application Data
(60) Provisional application No. 60/196,816, filed on Apr. 13, 2000.

(51) Int. Cl. G06F 17/60

(52) U.S. Cl. 705/1

(57) ABSTRACT

A method, apparatus and system for performing a business function in an object architecture. the method comprises utilizing configuration information for directing at least one process to perform the business function, utilizing a reference library for defining data external to the object architecture and supporting the configuration information, interfacing the process associated with the object architecture with at least one in-memory object, and utilizing at least one data storage object for preserving the data affected by the process. According to one embodiment, the object architecture may be use to monitor data integrity in a computing system, where the computing system has a plurality of data sources. The monitoring process comprises analyzing data from the data sources, configuring the computing system to support data reconciliation for the data, and reconciling data from the data sources.

This application claims priority to the U.S. provisional application with Ser. No. 60/196,816 and attorney docket number 3984-4000, filed on Apr. 13, 2000, and entitled “System and method and system for supporting the data and operational requirements of a business function.”

### BACKGROUND OF THE INVENTION

1. Field of The Invention

The present invention relates to a method and system for automating the processing requirements of given high level business functions, and more particularly to a method and system which automates the business functions in a generic manner such that the invention enables the related business functions to be automated and performed under varying conditions with no recoding of core application objects and processes.

2. Description of Related Art

In today's computing environment, existing applications attempt to bundle many individual business functions as part of large comprehensive solutions or tend to support smaller sets of business functions in very isolated circumstances. These applications by their very nature fail to support variation in how their related processes are performed and what information those processes are performed on. This lack of variation support results in applications which can not be adapted to perform their related business functions in the many different environments without significant modification. These solutions do not provide common platforms for automating their related business functions and result in duplication of processing, data, and effort.

One example of a business function supported in this manner is data reconciliation and data quality management. Data reconciliation and data quality management is the process of ensuring that duplicate business data, which resides in different systems or sub-systems across an organization remains consistent throughout those systems.

The data reconciliation and data quality management function is traditionally implemented in two modes of operation. In the first mode the required reconciliation processes and data required to support these processes are part of a larger system's processes and data. In the second mode of implementing the reconciliation business function is provided as separate application but will function only for very specific or isolated classes of information such as financial data or inventory data.

In both of these instances, organizations need to have multiple and perhaps many different data reconciliation or data quality management solutions resulting in much wasted effort and inefficiencies. These inefficiencies emphasizes the need for an application which automates the reconciliation business function in a manner, which is flexible and can be used in any number of the different computing environments with out re-development.

### SUMMARY OF THE INVENTION

The present invention overcomes the above-mentioned disadvantages. One aspect of the present invention provides for a system, method and apparatus for providing a multi-tier object architecture for supporting the automation of well-defined business functions. These functions may be characterized by individual business processes which tend to be wide spread across medium to large organizations and occur with a significant degree of variation, while being capable of being isolated or segmented from other related processes.

The object architecture provides a very high level of automated flexibility, which enables the architecture to support variations in the underlying requirements of a given business process, without requiring additional coding, programming and/or redevelopment. The flexibility across the architecture impacts every aspect of processing from data storage and display to the functioning of individual algorithms. According to one of the embodiments, the flexibility may be exploited in the design of high-level processes for performing generic tasks and the use of configuration objects to guide the detailed implementation of a given task at run time.

In one exemplary embodiment, the present system, method and apparatus may be used for automating and centralizing the data reconciliation and data quality management process across any number of data sources of an organization, which may be located internally or externally thereto. Data reconciliation and data quality management is the process of ensuring that duplicate business data, which resides in different systems or sub-systems across an organization and is generally updated through complex sets of manual or automated processes, remains consistent between the various systems connected by the reconciliation application of the present invention.

The above advantages and features are of representative embodiments only, and are not exhaustive and/or exclusive. They are presented only to assist in understanding the invention. It should be understood that they are not representative of all the inventions defined by the claims, to be considered limitations on the invention as defined by the claims, or limitations on equivalents to the claims. For instance, some of these advantages may be mutually contradictory, in that they cannot be simultaneously present in a single embodiment. Similarly, some advantages are applicable to one aspect of the invention, and inapplicable to others. Furthermore, certain aspects of the claimed invention have not been discussed herein. However, no inference should be drawn regarding those discussed herein relative to those not discussed herein other than for purposes of space and reducing repetition. Thus, this summary of features and advantages should not be considered dispositive in determining equivalence. Additional features and advantages of the invention will become apparent in the following description, from the drawings, and from the claims.

### BRIEF DESCRIPTION OF THE DRAWINGS

FIG. 1 illustrates the logical representation of the object types in the object architecture in accordance with one embodiment of the present invention;

FIG. 2 illustrates the steps required to transform the object architecture into an application for supporting a given set of business requirements;

FIG. 3 illustrates the steps required to configure one of the architecture's applications to meet the processing requirements of a given computing environment;

FIG. 4 illustrates the operational steps required to receive and process data on a regular basis, through one of the architecture's applications;

FIG. 5 illustrates the basic user interaction facilities provided by one of the architecture's applications;

FIG. 6a-b provides a high-level business representation of the configuration operational flow of the architecture's reconciliation embodiment;

FIG. 7 provides an overview the steps required for configuring the reconciliation embodiment for operation in a specific computing environment;

FIG. 8 shows the operation steps required for receiving and processing data through the reconciliation embodiment;

FIG. 9 shows the user interaction facilities provided by the reconciliation embodiment;

FIG. 10 shows a subset of the reconciliation embodiment's in memory objects organized by their parent child relationships;

FIG. 11 shows the user interface adapter programs of the reconciliation embodiment;

FIG. 12 shows core in-memory objects of the reconciliation embodiment;

FIG. 13 shows the first portion of the in-memory reference library objects of the reconciliation embodiment;

FIG. 14 shows the second portion of in-memory reference library objects of the reconciliation embodiment;

FIG. 15 shows the third portion of the in-memory reference library objects of the reconciliation embodiment;

FIG. 16 shows the first part of the in-memory data manipulation objects of the reconciliation embodiment;

FIG. 17 shows the second part of the in-memory data manipulation objects of the reconciliation embodiment;

FIG. 18 shows the in-memory archive data manipulation object of the reconciliation embodiment;

FIG. 19 provides a detailed view of some of the miscellaneous in-memory objects of the reconciliation embodiment;

FIGS. 20-22 is a detailed view of some of the database tables, indexes, and constraints of the reconciliation embodiment;

FIG. 23 outlines the process for defining a source system for the reference library of the reconciliation embodiment;

FIG. 24 outlines the process for defining a system field for an individual source system of the reconciliation embodiment;

FIG. 25 outlines the process for creating a reconciliation definition;

FIG. 26 outlines the process for adding a source system to a given reconciliation definition;

FIG. 27 outlines the process for adding a key field to a given reconciliation system;

FIG. 28 outlines the process for creating a data comparison in a given reconciliation definition;

FIG. 29 outlines the process for adding a data field to an individual reconciliation system's data comparison;

FIG. 30 outlines the reconciliation embodiment's process for adding an information field to a given reconciliation system;

FIG. 31 outlines the process flow for deleting in-memory objects from the application, in accordance with the reconciliation embodiment;

FIG. 32 outlines the reconciliation embodiment's process for receiving and processing a singe text message containing related reconciliation information from a designated source system;

FIG. 33 outlines the process for creating a reconciliation item object from the text message received in FIG. 32;

FIG. 34 outlines the process for decomposing the reconciliation item of FIG. 33 into a set of related in-memory and related database objects;

FIG. 35 outlines the utility process for creating a temporary in-memory structure containing the data elements of a given XML based text string that normally has reconciliation data from a particular source system;

FIG. 36 outlines the process for validating and storing the header information of the message data contained in temporary memory structure created in FIG. 35;

FIG. 37 outlines the process for creating a match key string for a reconciliation message whose data is contained in the temporary memory structure created in FIG. 35;

FIG. 38 outlines the process for creating the data elements for a reconciliation message whose data is contained in the temporary memory structure created in FIG. 35;

FIG. 39 outlines the process for creating the information elements for a reconciliation message whose data is contained in the temporary memory structure created in FIG. 35;

FIG. 40 outlines the reconciliation embodiment's initial process for matching a given reconciliation item to the application's existing reconciliation data and data groups based on the match key string created in FIG. 37;

FIG. 41 outlines the first sub-process for matching a given reconciliation item to the application's existing reconciliation data utilizing specialized application features for group and record replace;

FIG. 42 outlines the second sub-process for matching a given reconciliation item to the application's existing reconciliation data utilizing specialized application features for creating new groups and records;

FIG. 43 outlines the process for creating a reconciliation data object based on the results of the matching process described in FIGS. 40-42;

FIG. 44 outlines the process for creating a data group object based on the results of the matching process described in FIGS. 40-42;

FIG. 45 outlines the process for reconciling the individual reconciliation items of a given data group object;

FIG. 46 outlines the process for integrating the flow of reconciliation messages from external source systems via method calls directly into the reconciliation application;

FIG. 47 outlines the process for integrating the flow of reconciliation information to and from external source systems into and out-of the reconciliation application via a direct data source link;

FIG. 48 outlines the process for integrating the flow of reconciliation messages from the external source systems via file based data transfer into the reconciliation application;

FIG. 49 outlines the facilities and processes for supporting the retrieval, review, and modification, of reconciliation data in the reconciliation application;

FIG. 50 outlines the facilities and processes for supporting reporting and/or updating of status and result details for individual reconciliations;

FIG. 51 outlines the facilities for modifying client related configuration information in the reconciliation embodiment;

FIG. 52 outlines the facilities for modifying user and user security related information in the reconciliation embodiment;

FIG. 53 outlines the process for archiving data from the application's live data objects to the application's online archive;

FIG. 54 outlines the reconciliation embodiment's process for restoring archived data from the application's online archive to the application's live data objects;

FIG. 55a outlines the facilities for supporting the initiation of the archiving process for a given reconciliation;

FIG. 55b outlines the facilities for retrieving reviewing, and restoring the archive data of the reconciliation embodiment;

FIG. 56 outlines the facilities for managing processing errors in the reconciliation application;

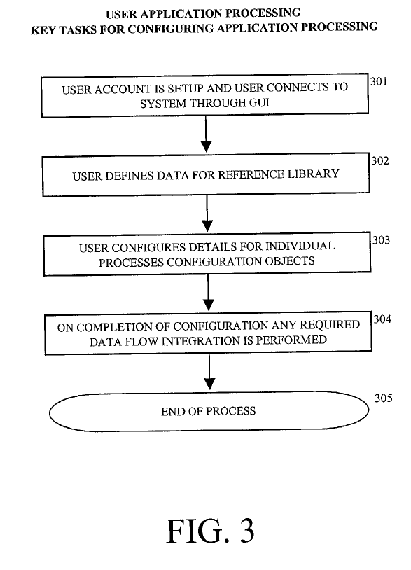

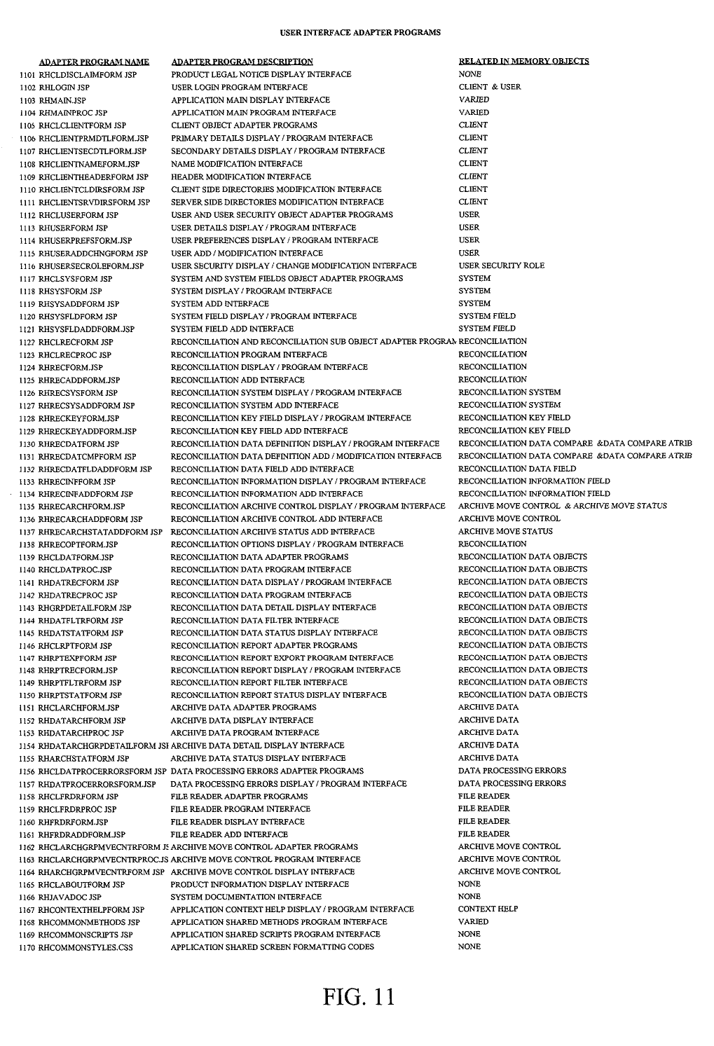

With reference to the following detailed description, the aforementioned drawings will be described in greater detail below. The leading reference numeral in each drawing indicates the first drawing in which the reference numeral is introduced (e.g., elements 320 and 1140 are introduced in FIGS. 3 and 11 respectively).

### DETAILED DESCRIPTION

The present invention relates to a system, method and apparatus for providing a multi-tier object architecture for supporting the automation of well-defined business functions. These functions may be characterized by individual business processes which tend to be wide spread across medium to large organizations and occur with a significant degree of variation, while being capable of being isolated or segmented from other related processes.

The object architecture provides a very high level of automated flexibility, which enables the architecture to support variations in the underlying requirements of a given business process, without requiring additional coding, programming and/or redevelopment. The flexibility across the architecture impacts every aspect of processing from data storage and display to the functioning of individual algorithms. According to one of the embodiments, the flexibility may be exploited in the design of high-level processes for performing generic business processes and the use of configuration objects to guide the detailed implementation of a given business process at run time.

In a nutshell, this object architecture is utilized in three primary stages. In the first stage, the architecture is adapted to provide a specific business application, producing a set of core configuration objects and related processes for the application. In the second stage, these objects are configured to meet the specific processing requirements of a given installation/client. In the third stage, the client may utilize the application by performing any required integration and subsequently passing related information through the application for ongoing processing, analysis, adjustment, and reporting.

Some examples of business functions that may utilize the disclosed object architecture are data reconciliation and data quality management, position keeping and inventory management, risk management and/or the like. The object architecture supports these business functions by providing independent applications for each of the given business functions. In other words, each of the applications may be an adaptation of the architecture's core configuration objects, processes, and concepts. Throughout the remainder of the document data reconciliation and data quality management are referred to interchangeably. It is to be understood that the term “application” is used to indicate an embodiment of the object architecture disclosed and claimed herein.

In accordance with the present invention, the object architecture is described in greater detail with the exemplary embodiment of a reconciliation manager for automating the processes of identifying, managing, and correcting data inconsistencies in an organization's computer systems. While the detailed description discusses the particular example of a reconciliation manager, it should be noted that the scope of the present invention is not to be limited to the embodiment of a reconciliation manager, but instead covers any and all embodiments within the scope of the object architecture disclosed and claimed herein.

The exemplary embodiment is a system, method and apparatus for reconciling data from a plurality of different computer systems internal or external to an organization for maintaining integrity thereof.

In a nutshell, the exemplary embodiment of the present invention is a system, method and apparatus for automating and centralizing the data reconciliation process across any number of data systems of an organization, which may be located internally or externally thereto. Data reconciliation is the process of ensuring that duplicate business data, which resides in different systems or sub-systems across an organization and is generally updated through complex sets of manual or automated processes, remains consistent between the various systems connected by the reconciliation application of the present invention.

This process of reconciliation generally involves the key steps of gathering related information from different source systems, matching the appropriate records together, comparing the detailed data elements of these matched records, determining which elements and records are in error, and then, specifying and applying required corrections back to related source systems.

The present invention is unique in that it enables an organization to create one central data integrity control and integration process for each particular class of information across their entire organization, such as for their clients, accounts, inventory and/or the like. Using the application's different integration facilities, such as the file based message feed, the direct message based connection facilities, and/or the direct data source linking facilities, information flows to and from the source systems/users and the reconciliation manager is automated. Once the data integrity controls are structured and information flow is automated, an organization will regularly process its related information through the reconciliation manager and use the application's facilities to discover and correct any data inconsistencies existing in the related source systems.

The system of the present invention, which may also be called reconciliation manager, works through a onetime multi-step configuration process, as well as a set of ongoing post configuration operational process. Initially, the configuration involves defining the data sources and data elements of the organization. Next, the data source and data element definitions are combined, through configuration, into the required reconciliation controls. Finally, the flow of information is automated between the data sources and the system of the present invention. Throughout the remainder of the document data source and source system are referred to interchangeably.

Once the configuration is complete, data is received or extracted by the reconciliation manager. It should be noted that the data is received independently for each data integrity control source-system pair. This data is then decomposed, matched, and reconciled based on the application's configuration. The product is then used to manage the process of determining the correct action for data inconsistencies and returning, or applying the correction back to the originating source systems.

With reference to the figures, various embodiments of the present invention will now be described in greater detail. It is to be understood that the tasks shown in the figures and described in this description can be sequenced in many different orders to achieve the desired result. The order or sequence of tasks illustrated in the figures is merely intended to be exemplary of the concepts defined herein.

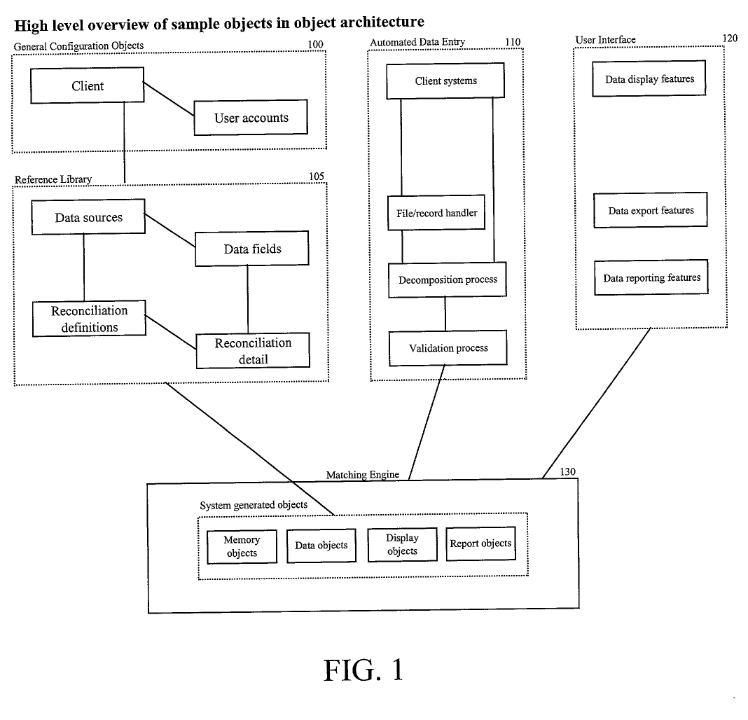

FIG. 1 provides a high-level overview of the sample objects in the object architecture in accordance with the present invention. The first segment 100 represents a set of general in-memory configuration object, which comprises a client object that defines the individual clients that interface with the application. Related to these client objects, the application may also contain sets of user and user related objects, such as user accounts.

The second segment 105 represents a set of reference library or reference-library-related in-memory objects. The reference library is a set of application components which provide flexibility to the architecture by enabling the changing of details of the manner in which processes are performed and the data on which these processes are performed through configuration. The reference library is to be understood to mean the combination of data definition objects and business process configuration objects. The data definition objects define in detail the data and data sources external to the application, and where the business process configuration objects direct the business process in conjunction with the data definition objects. It is to be understood that the term “application” is used to indicate an embodiment of the object architecture disclosed and claimed herein.

These reference library objects 105 are used by applications of the architecture to support the user configuration features of related applications and to control the processing and object creation/management functions of a given application for performing its related business tasks after configuration. Also related to the client objects, the reference library objects may contain details on the individual client's available data sources and their related data fields. Further, related to the client information and particular to the reconciliation embodiment's usage of the present architecture, the reference library objects may contain sets of reconciliation definition objects and their related reconciliation configuration detail. Additional embodiments may also contain sets of business function related reference library objects. These other business objects may vary in detail from the reconciliation definition and configuration objects represented here. However, business objects will consistently function in a similar manner, providing business process control and flexibility within the related application embodiment of the architecture.

The second segment 120 of the diagram shows some of the automated data entry/integration facilities. These data integration facilities 120 are used by the architecture's applications to support the automated flow of business related data to and from the individual data sources for related clients. As can be seen by this representation, the structure generally contains some interface to client/source systems, which are external to the architecture and its related applications, but may be interfaced using a variety of facilities such as file or record handlers, direct message based connections into the architecture or, direct database level connections into the architecture. Using the connection facilities, data is pushed or pulled from the client systems and fed for processing through initial application decomposition and validation functions. These decomposition and validation processes utilize the reference library information in performing their individual functions and when complete, pass the related information or resulting business objects on for further processing within a given application of the architecture.

The third segment 130 of the diagram represents some of business-related processes or objects, which may be constructed utilizing the architecture to perform a given business function. The information shown in 130 relates to the reconciliation embodiment of the present invention and depicts a business process for matching the data arriving through the data integration facilities 120. The example also depicts the matching engines process for creating sets of related memory objects, data objects, display objects and report objects, based on the information it is receiving and the information contained in the related reference library objects. Data objects are also referred to as data storage objects in this application. This matching process 130 is representative of how the many processes of each of the set of processes required for any of the given application's of the architecture are constructed to utilize information flow, existing system objects, and reference library detail to achieve their individual business functions in a flexible manner. In matching engine 130, memory objects refer to the total set of in-memory objects in the architecture which includes both in-memory representations of the data objects, reference library objects, general configuration objects and/or the like.

The fourth and final segment 140 of the diagram represents some of the features which may be available through the user interface of any of the architecture's individual applications. These user interface features 140 are utilized to provide a dynamic interface for users to retrieve, display, and update related business object and reference library information. The interface may also provide general features for exporting related business object or process data back to data sources or individuals in any number of different formats. In addition the interface may provide any range or reporting features for the related data. All of these related features are built on top of the individual application's reference library structure and utilize this object structure to maintain flexibility in how they display and manage the related classes of business information for each of the applications.

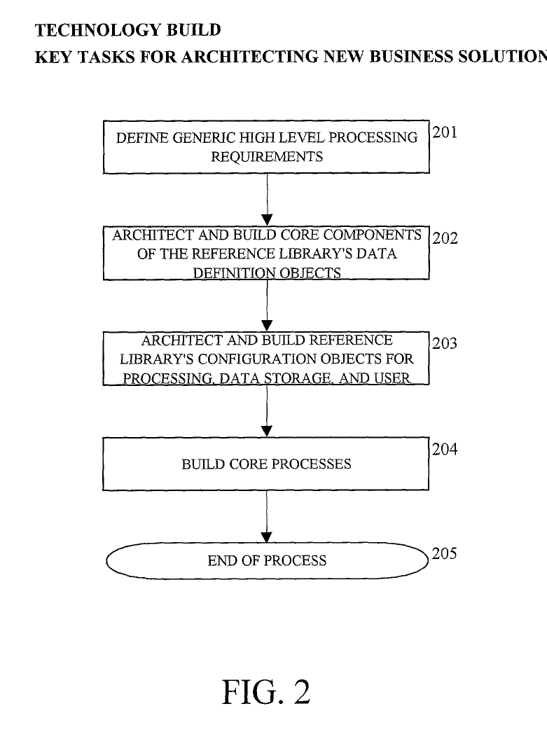

FIG. 2 describes the process of adapting the object architecture to create a new software solution for automating a given business process. This process of adaptation begins at step 201 in which the high-level processing requirements of the selected function(s) are defined. For one embodiment in which data is reconciled, some high-level business processes may include matching data records from different source systems based on a specified reconciliation designator and based on data contained in a user defined set of fields which when processed creates an individual match string, defining for any matched group of records which individual values are compared and also specifying how data elements are combined from individual data records to compute the related values.

In looking at a position keeping/inventory management embodiment, some high-level processes may include the ability to create a number of inventory tracking structures including a primary inventory classification and for each primary class any number of sub-classifications, and the ability to specify by data source which data elements are used to compute the mapping of information from the related source system to the application's inventory tracking structure down to a sub-classification level. This function may also include the ability to specify data transformation details for mapping inventory classifications between the application and the individual source system.

With the process of adapting the object architecture complete, the architecture's reference library functionality is examined for possible modification and/or enhancement in 202. The architecture's reference library may include a standard set of data abstraction, translation, and transformation services. The data definition object may include the ability to define the available data sources within an organization through user specified source system identifiers. The data definition object may also comprise the ability to specify the individual data elements available for each of the different source systems where the information may include the identifier, type, and format of the related data, the ability to load the related information in an automated or semi-automated fashion with the assistance of a data dictionary within the organization, the ability to specify for each data source a related database to use during the automated extraction of information from that system, and the ability to specify for each user-defined field identifier a related database field identifier as shown in box 202.

Once the reference library has been completed, the system's business configuration objects (also referred to as business process configuration objects), data storage objects, and user interface objects are designed in step 203. Business configuration objects are used in conjunction with the architectures data abstraction facilities to direct the individual business processes on how to perform their related business functions. One example of this type of object is the reconciliation key field object 1381, which allows the user to specify the system field objects 1311 from the data abstraction facilities that are used to compute the value of the match key string for the given data record. This set of related business configuration objects then works in conjunction with the build key process 3700 to provide the embodiment's ability to create any match key structure for a given reconciliation system.

Another example relates to an inventory management embodiment, and is the inventory classification map object, which allows a user to select the system field objects 1311 from the data abstraction facility. The system field objects 1311 are used to create the map key for targeting data from an individual source system to an inventory sub classification. The build classification map key process uses these related configuration objects to create map keys for transactions, as they are processes through the related application.

Once the set of required configuration objects has been created, the process moves to the step of defining and creating the individual data storage objects for supporting the application. Data storage objects are used by the infrastructure to preserve the data extracted or submitted from the various source systems in a state that indicate the results of the processes executed on that data. When these data storage objects are used in conjunction with the configuration objects and related processes, they deliver the required processing capability in a manner that supports the related application's flexibility. One example of this type of object from the reconciliation embodiment is the data group object 1661. This object is used to store the individual data groups created for each reconciliation and unique match key pair. The data storage objects when used in conjunction with related objects and processes forms the basis for preserving the mapping of individual data records into related grouping for further comparison and processing. A similar type of data storage object could be used in inventory management system, in which case the object would preserve the records of exactly which data transaction objects had been used to create a balance for a specific inventory sub classification.

After the set of object definitions has been completed, the process may move to completing the new application's user interface. In this regard, the infrastructure provides a standard structure or methodology for delivering a dynamic web base user interface. Using user interface templates, which are explained with respect to the reconciliation embodiment, in conjunction with the knowledge of processing requirements, data abstraction facilities, business process configuration and data storage objects, the application's user interface can be created. This process may involve creating individual sets of screens for functions such as process management, data management, date extraction, and/or data reporting.

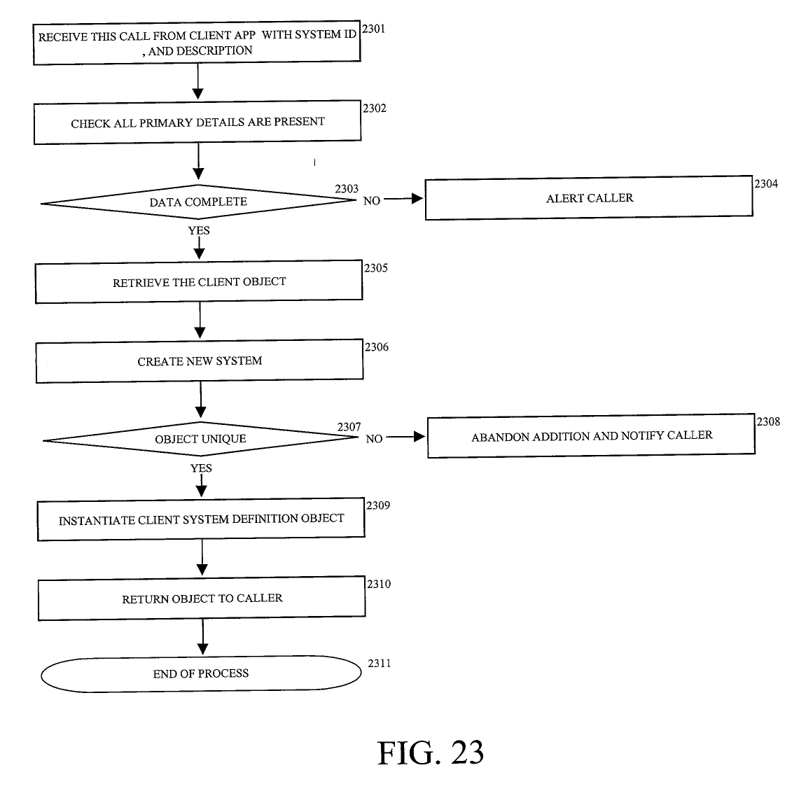

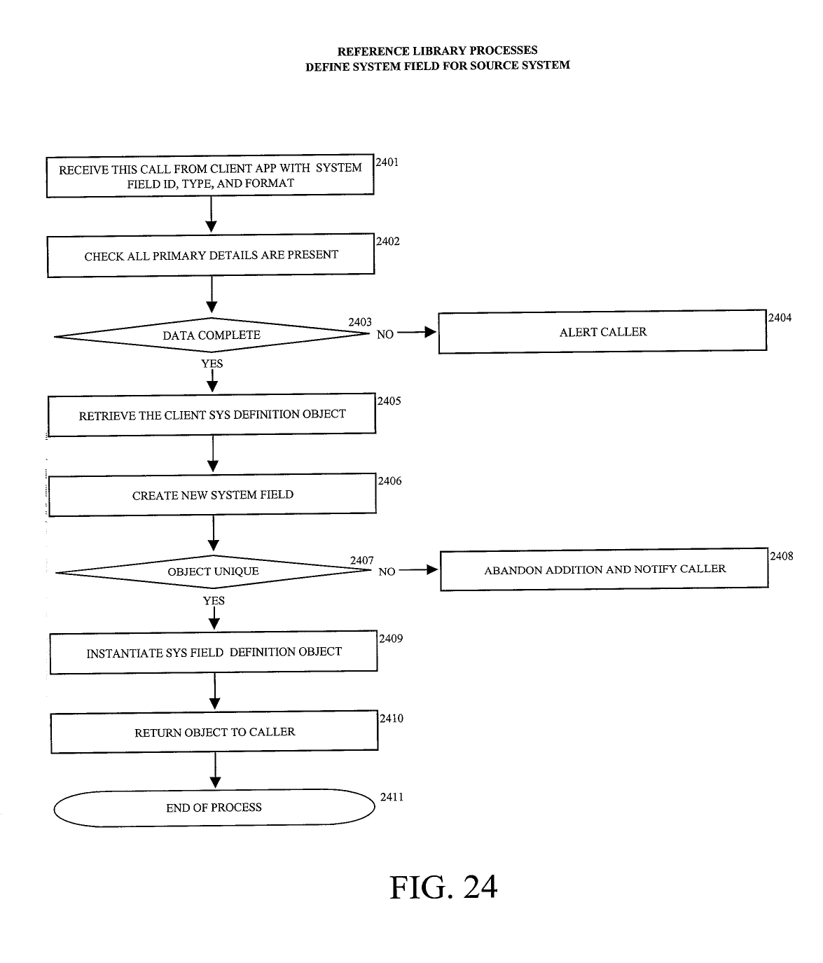

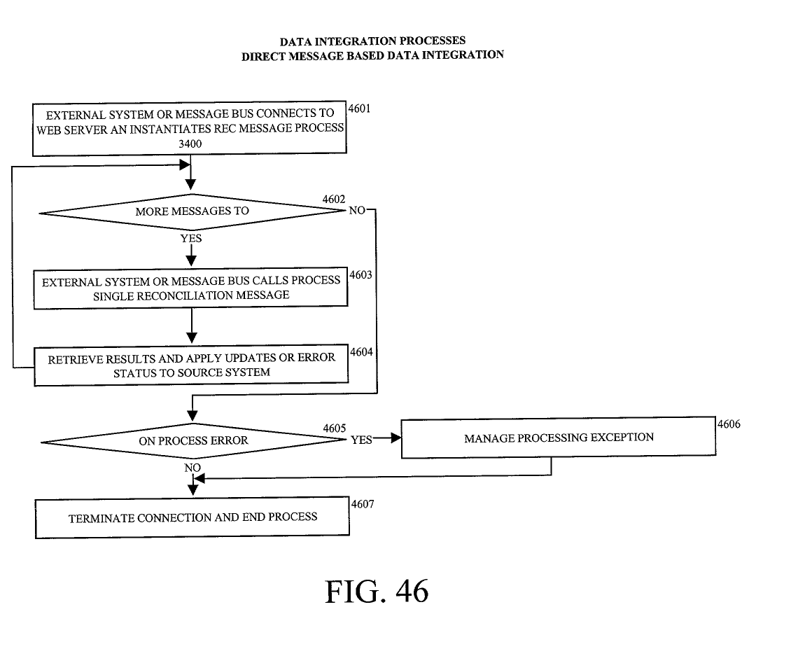

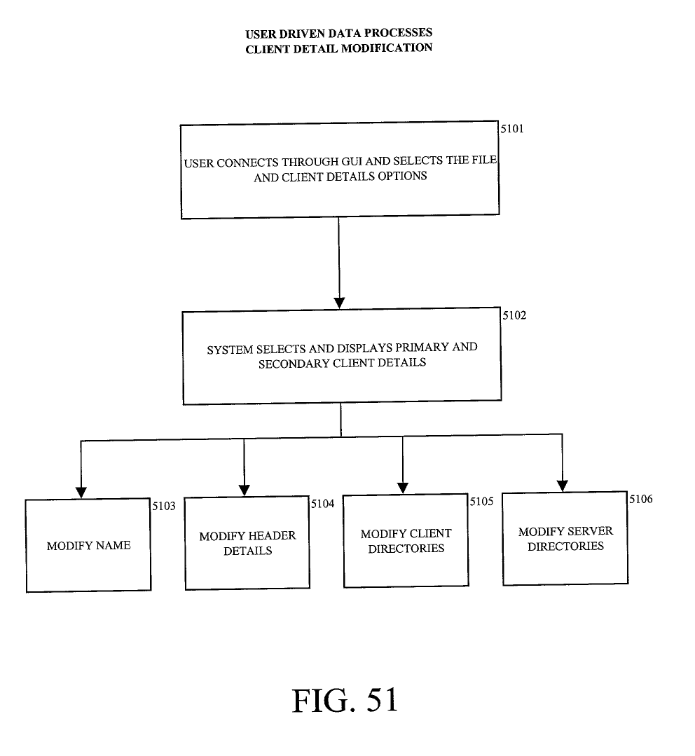

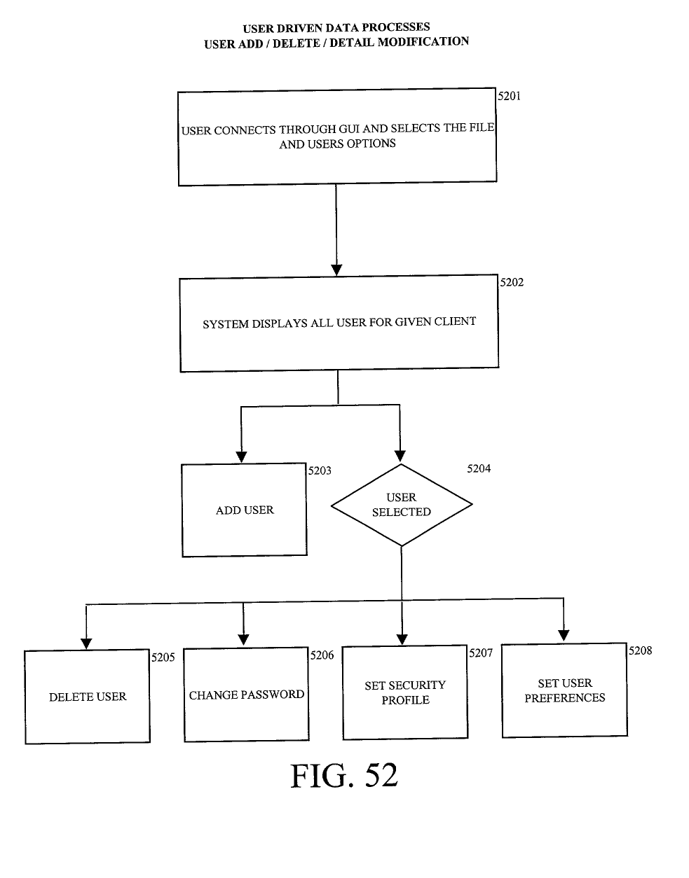

With these primary structures complete, the system's processes are constructed to deliver the required functionality in the flexible nature dictated by the overall architectural design. In this regard, many of the core processes that are built in step 204 are reused by the different application embodiments of the architecture, without any significant changes. Some of these reusable processes may include the system and system field definition processes that are shown in FIGS. 23 and 24, the data integration processes that are shown in FIGS. 46-48, and all related security, user, and client process that are shown in FIGS. 51-52. After step 204, the present system is complete and is ready to be adapted through configuration for use within a given client's environment.

FIG. 3 shows the steps required for configuring the architecture's related applications for use specifically within their organization's computing environment. In step 301, the user gains access to the applications configuration facilities provided through the web-based screens of the system. Once access has been provided, the configuration process of creating reference library information for the application's data abstraction layer (also referred to as data definition object(s)) begins, which is almost identical for each of the embodiments described herein. In cases where organizations utilize the architecture to deliver multiple systems, the ability to share or copy the related reference library information between applications is provided, as shown in box 302. In step 303, the user configures the related business process configuration objects of the application. This process is generally unique to the individual application, except for the data link definition process. A data link definition enables the application to automatically retrieve data for defined business objects from external source systems linked at a database level directly to the application's of the architecture. In the data link definition process, a user may specify a table or a view to receive related data for the given business object/process. Where the object architecture of present invention is used for data reconciliation, some business process configuration steps may include the creation of individual reconciliations; and, then for each reconciliation, indicating which source systems participate in that reconciliation. The remainder of the configuration steps, required for the reconciliation embodiment, are described in further detail below.

For the inventory management embodiment, the business process configuration may include creating the inventory tracking classifications, creating the mapping objects for directing transactions from specific source systems to individual book structures, and creating a definition of the products or instruments to be tracked, in 303.

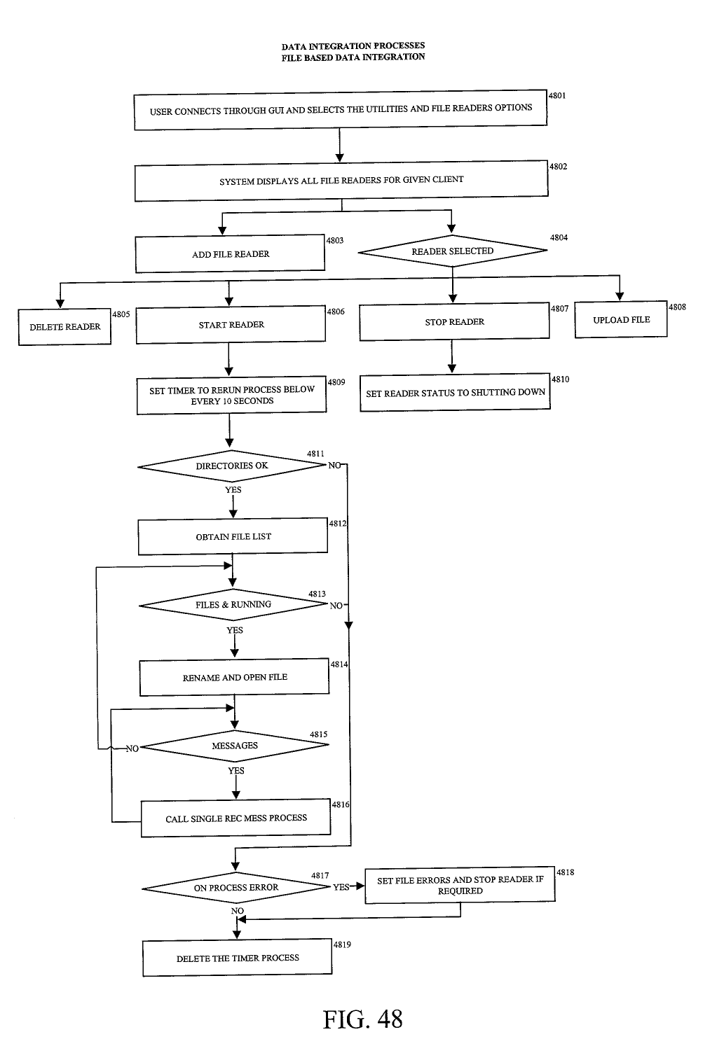

Once the application's processing has been configured, the architecture can support the automated integration of data flow with source systems in a number of ways. First, if message based integration is required, the application uses the business object configuration information and accompanying data transformation layer information to create XML based record layout templates for each of the sources and their related business objects. Developers can then use these templates to format data records which will flow from the source systems into the application hub from either the direct message based integration process that is described in FIG. 46 or the file based integration process that is described in FIG. 48. Alternatively, if the direct data source link based data integration is used, data is extracted for related business objects directly from the linked data sources on a schedule or at the request of a user. This extraction process is supported directly through the architecture's infrastructure without any message coding being required, in step 304. With integration complete, the application configuration process ends and the client is ready to move into production use of the application, as shown in box 305.

It should be noted, according to one embodiment, it is possible to just configure the business process configuration objects, where the data abstraction layer has been hard-coded into the architecture's related application, within the scope of the present invention. Alternately, it is possible to just configure the data abstraction layer, where the business process configuration objects has been hard-coded into the architecture's related application, within the scope of the present invention.

With integration completed, the application configuration process ends and the client is ready to move into production use of the application, as shown in box 305.

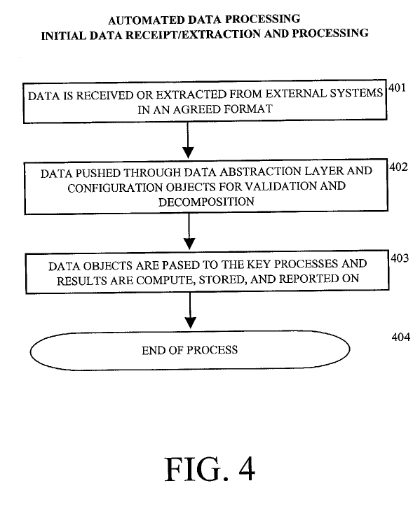

FIG. 4 describes the steps supporting the ongoing receipt and/or extraction of data and the data's submission for initial processing. In general, these events can happen on any schedule, based on the operational requirements of the individual application installation or its particular business objects. The process can begin in several ways, utilizing any combination of the architecture's data integration facilities. These integration facilities include the following embodiments. First, the ability for source systems to submit data messages for processing using the architecture's direct connect ENTERPRISE JAVABEANS (EJB) message based link. Second, the ability for source systems to submit data messages in message based files that are transferred either manually or automatically onto a predefined directory on the application's server or uploaded to this same directory manually through the application's user interface. Third, the ability for the data extraction process to attach to a defined table or data view in a source system database and extract information related to a given business object, and/or the like.

In step 401, after extraction, information is formatted and passed on for further processing. During this receipt and/or extraction process, the required content and format of the individual data messages is governed by the combination of the data abstraction layer objects and business process configuration objects.

After receiving the individual data message in step 402, the core architecture processes are used to work with the abstraction layer objects as well as the configuration object to validate the individual data elements of the related message, and to transform the message's data into the related data objects which are used for further processing. In most cases, the receipt of data triggers sets of core processes on the related data objects. This can be seen with respect to the reconciliation embodiment, which upon receiving a data message decomposes and validates the message and passes the resulting reconciliation item object 1701 on for matching and potentially reconciliation, in step 403. These processes can occur continuously throughout operation. However, once data processing is completed, for related sets of data the system generally moves the data to the next phase of application processing, which is described below.

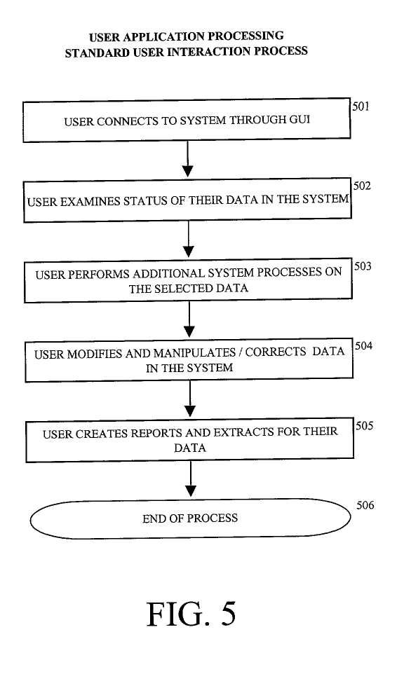

FIG. 5 describes the process of a user interacting with the applications facilities to review the business data, perform additional processing on the related data, adjust or modify the data, and report or communicate any required status information regarding the data. These facilities are provided to users through the applications web-based interface, in 501. The system may provide a screen or sets of screens for retrieving the related business data grouped, organized, and/or filtered by the status of one of the primary data storage objects. This embodiment is demonstrated in detail within the context of a data reconciliation system where data records are displayed in relation to their related data group object 1641. The system provides facilities for filtering the related information on fields such as business data, system date, and data group state in 502. From the applications' data review screens, the user can trigger a number of system related processes on the data being viewed. For example, in the case of the reconciliation embodiment, a user may select individual data groups and perform tasks such as manually closing the group or re-reconciling the group.

Another functionality for the reconciliation embodiment includes the ability to manually start the reconciliation process for a selected reconciliation object in 503. A user may manually adjust related business data and subsequently pass this data for reporting or other processing. According to one embodiment, these features may be supported through the application's web interface, and, in the case of the reconciliation embodiment may be seen in the users' ability to specify correction values for individual data breaks that arise through the reconciliation process in 504.

Once the data review and adjustment process has been completed, the user may use the application facilities to either manually or automatically communicate results or correction information back to individual data sources or source system owners. The information may be communicated using extracts, reports, emails containing EXCEL or HTML-based information, and/or the like. The creation and or transmission of this information may be automated or can be performed manually. According to another embodiment, users may apply correction and status information updates to sources systems tables as indicated in the data abstraction layer and the business object configuration process in 505.

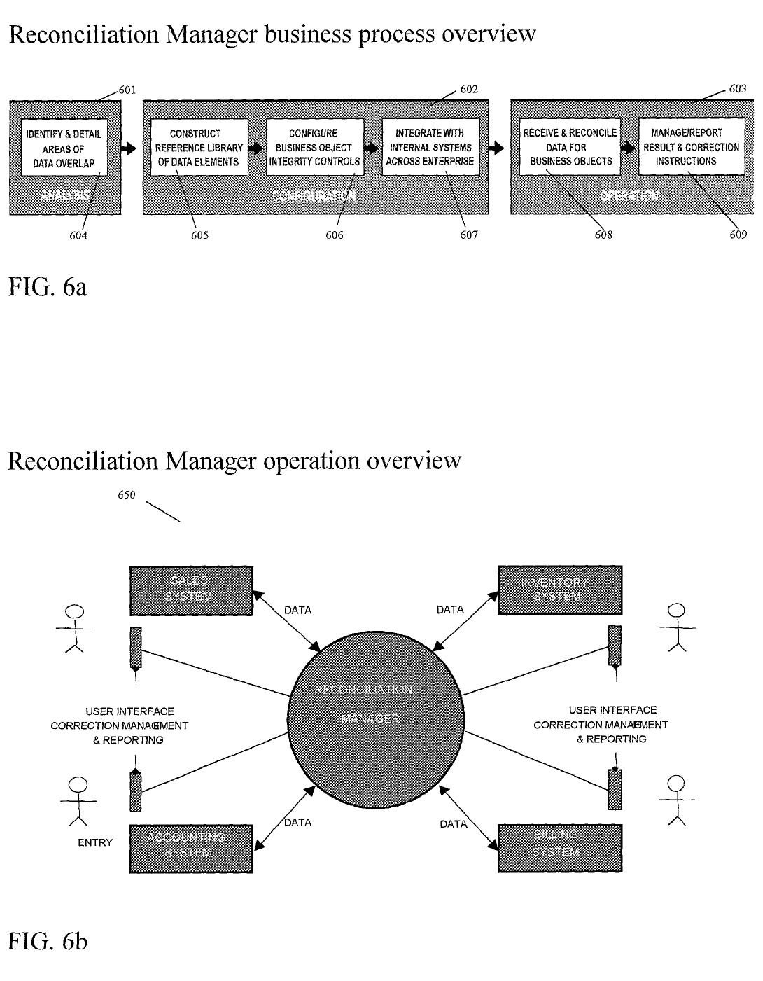

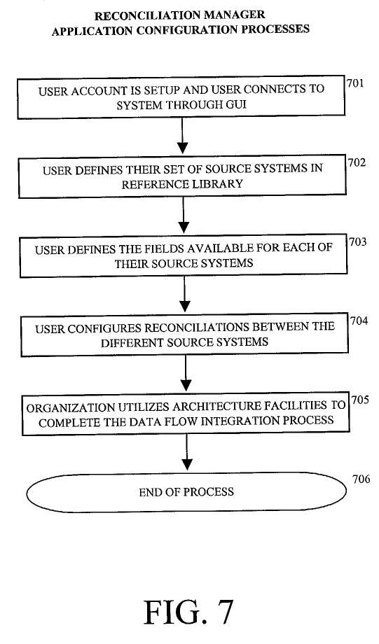

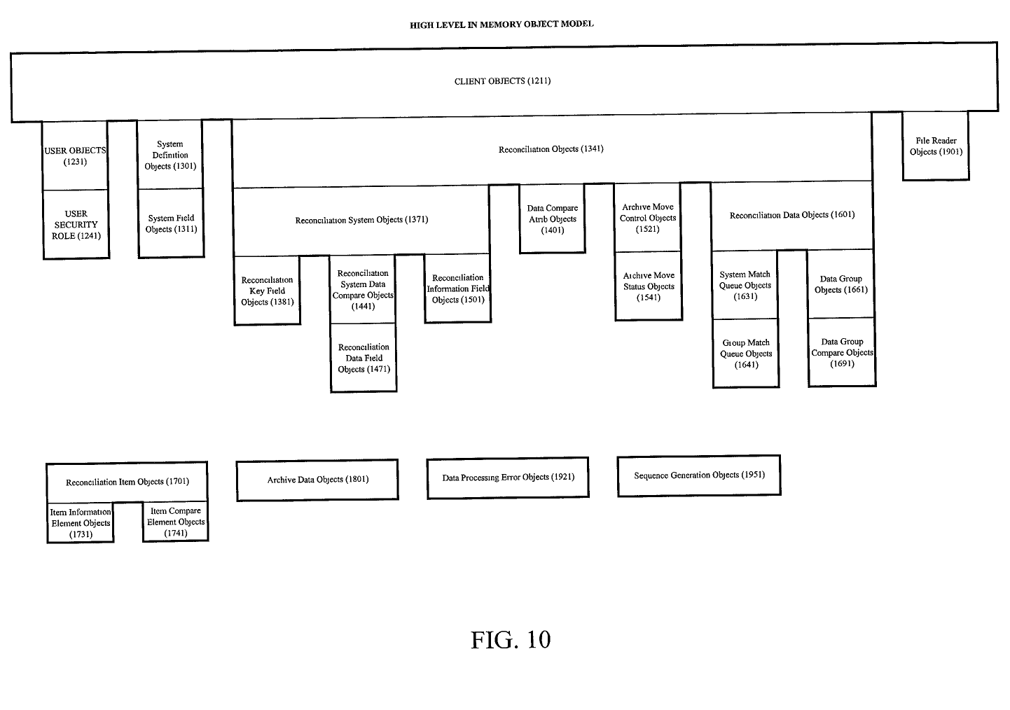

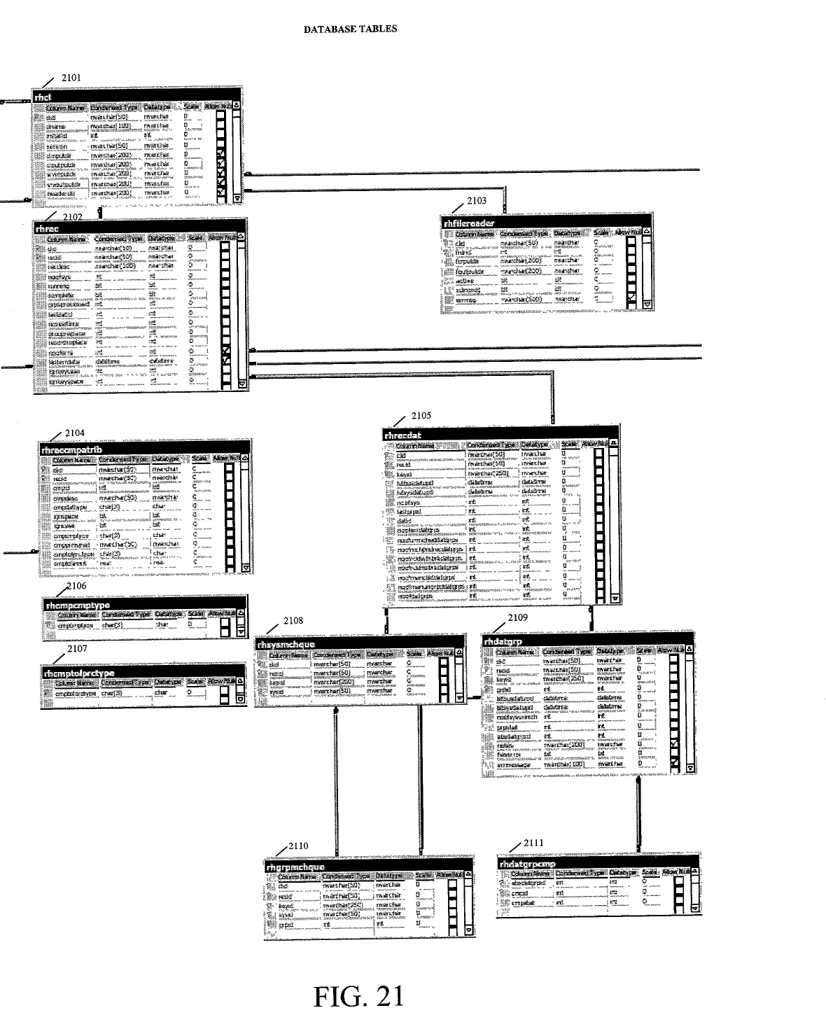

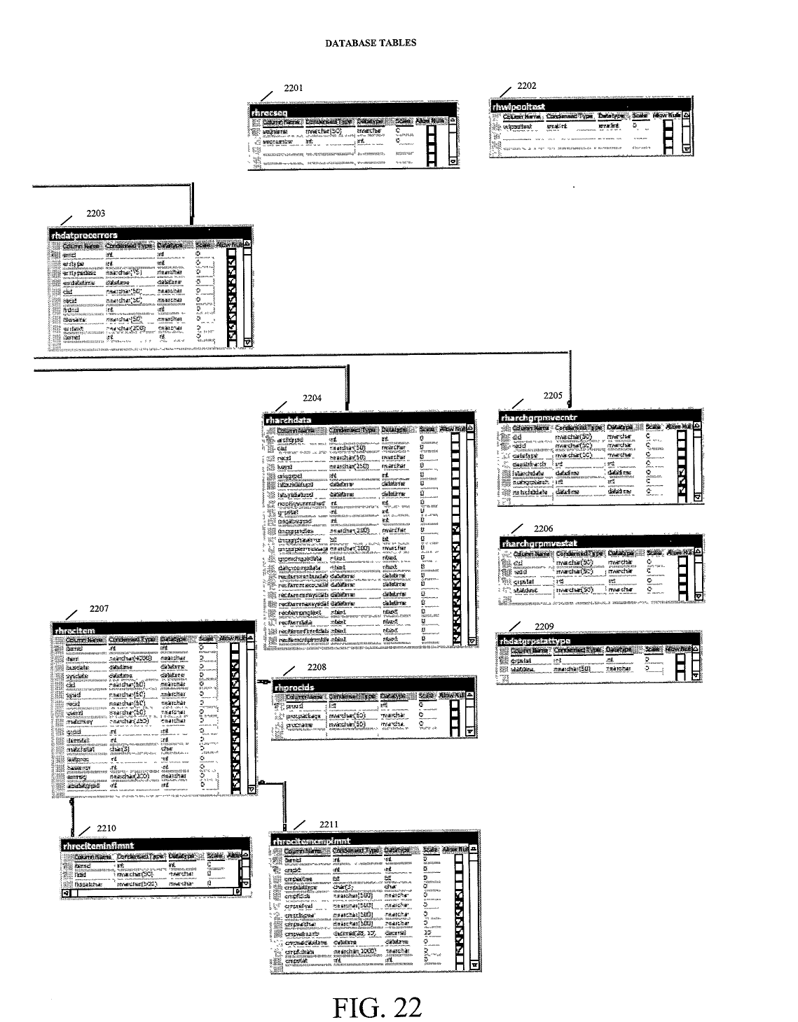

FIGS. 6a-6b describe an operational view of the architecture's reconciliation embodiment referred to as Reconciliation Manager. These figures illustrate the application's configuration and operation processes that are initially disclosed in FIGS. 7-9, and subsequently expanded upon in FIGS. 10-56.

FIG. 6a illustrates the business view of the steps required to configure and operate the Reconciliation Manager. The figure outlines first the key step of analysis, where an organization's data and system structures are examined to determine the duplicate business data that may exist, the reconciliation controls required, and the precise details of the individual controls. Second, the application configuration steps are outlined where data sources and data fields are defined, integrity controls/reconciliation are created combining these data sources and data fields as required by the analysis, and data flow to and from the Reconciliation Manager is integrated with the required source systems. Third, the operational steps are outlined where, data is regularly received, processed, and reconciled from the various source systems and subsequently acted on by users through the Reconciliation Manager's user interface to generate details such as corrections, reports, and status updates back to individual source systems and users.

FIG. 6b represents the logical flow of data related to the Reconciliation Manager during its operational phase. As shown here, data requiring reconciliation regularly flows into the Reconciliation Manager from the various client source systems as depicted by the sales system, inventory system, accounting system, and billing system. Once received/extracted this data is processed by the Reconciliation Manager for performing related tasks such as data decomposition, validation, matching, and reconciliation. Once processed data is available, users and system processes may use the applications facilities to generate information such as status reports, data extracts, and data correction related to individual reconciliations and source systems. As depicted in the diagram, this correction or status information can flow back to the various source systems either automatically or through user interaction.

FIG. 7 shows the process of configuring and using a given application, utilizing the reconciliation manager as an exemplary embodiment. After the user connects to the system through the application's web based interface in 701, the user may use the application reference library configuration screen as well as the architecture's automated data dictionary facilities to define the identifiers for each of the different source systems of the organization in step 702. Then, using the same set of screens and potentially the architectures automated data dictionary facilities, the user may define the field identifier of the individual data elements available from each of the systems and for each of these specify a related data type and data format in 703.

Once the source systems and system fields are available, the various reconciliation definitions can be created. For a reconciliation, a user specifies the source systems that contribute data to the reconciliation, the data elements used in matching records between the reconciliation's systems, the individual data comparison points of the reconciliation, the data fields from each system used to construct the values for given points and the method in which the related fields are combined, the information element tied to the records from each of the systems, how and where the correction information is applied to the individual source systems, and finally the archiving strategy used to transfer data from the live tables to the applications online archive. These selections and specifications involve selecting information from the previously constructed data abstraction layer details and these steps complete the process of tying configuration objects, data abstraction layer objects, and system processes together, thereby enabling the application to perform its reconciliation functions on the related data in 704.

Once the overall configuration step is complete, the data flow integration process can begin in 705. In the reconciliation application, data record transmission is organized by the reconciliation and source system pair. Each of the different source systems of a given reconciliation is expected to provide independent sets of data records for the given reconciliation source system pair. The data records can be submitted for processing using any of the related data integration facilities. In constructing the integration templates in step 705, the system utilizes fixed header definition information for the client and combines the reconciliation and systems definition information for producing a complete set of XML based field and field format descriptors for the information required in each data record. The field format description may include a unique list of key, data, and information field identifiers.

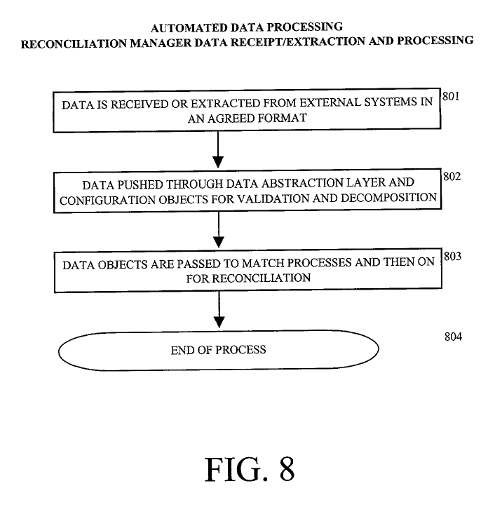

FIG. 8 details the reconciliation manager's operational steps, supporting the ongoing receipt and/or extraction of data and its submission for initial processing, and parallels the steps initially discussed with regards to FIG. 4. This process begins with data receipt and extraction in 801. In this embodiment, the schedule of the information flow may be driven by the characteristics of the individual reconciliation. As before, any of the architectures integration facilities can be utilized. After the data receipt, the decomposition process begins with the validation of header information, such as client identifier, reconciliation identifier, and system identifier of the individual record. Once the validation of header information is complete, the match key string is created based on key field objects defined for the underlying reconciliation system. Next, the data comparison structure is interpreted and the individual data comparison values are computed and stored in related data storage objects in step 802. The next step in decomposition is the processing of the information field objects against the data provided, and creating the related information data storage objects in step 802. Next, this new item is passed on for matching the processes, which groups the item with existing data in the system and subsequently. Then, if the resulting data group is completely matched and the reconciliation is structured to reconcile data real time, the data group is passed to the reconciliation process in step 803.

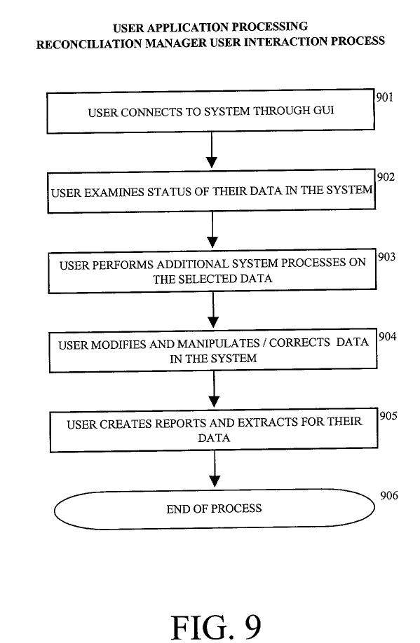

FIG. 9 details the reconciliation manager's user interaction steps and parallels the steps initially detailed in FIG. 5. These facilities are provided to users through the application's web based interface in 901. The system includes screens for retrieving and working with the processed data in the system. The data in this set of screens is grouped, organized, and filtered by the data group object 1661 in addition to the status information available on that object. Other facilities here may include the ability to apply business date, system date, and comparison level filters in 902.

From the data review screens, the user can select individual data groups and perform tasks such as manually closing the group or re-reconciling the group. In addition, the user may manually start the reconciliation process for a reconciliation currently being viewed in 903. The screen provides functionality for users to specify correction values for individual data breaks and, to use this information for further processing in the reporting process in 904. Once the data review and adjustment process is complete, the user may use application facilities to either manually or automatically communicate the results or correction information back to individual data sources or source systems, organized by reconciliation, system, and information status type 905.

FIG. 10 depicts one embodiment of the object model for the primary in-memory objects of the Reconciliation Manager system. The figure shows the hierarchical nature of these objects, and the manner in which the objects are accessed and used for processing. The objects are segmented into four different groups to represent ownership and the parent-child relationships. In this object model, a parent object such as client 1211 can have many child objects such as users 1231, which can again have many child objects such as user security role 1241. In order to preserve these parent-child relationships throughout the system, primary details of a parent object are included in the related child objects. For example, the field of client identifier will be replicated on all user objects 1231, because the user objects 1231 are children of the given client object 1211. These reproduced fields may have values that originate directly from the immediate parent object. In managing the child objects, the system provides a set of methods for creating, deleting, retrieving, listing and/or the like for each type of the object. These methods are located in a child object's immediate parent object. In most cases, access to a particular type of child object is allowed through its parent object and its related methods. These objects will be further discussed below.

FIG. 11 lists the application's user interface adapter programs. These adapter programs are used to deliver the system's advanced web based user interface comprising the set of display and report objects.

Adapter programs are organized on the related list in sets with each set generally having the following components. First, a main control window adapter program, which manages the format of the main window for the given area of functionality, provides the menu structure for the area of functionality, contains any required sub windows linked to related adapter programs, and provides access to any related functions. Second, sub-window adapter programs, which provide access to a subset of the given function's related objects, which contain the logic for initiating business functions on these objects and contain the logic for extracting and displaying the information displayed in the objects. In the present embodiment, the names of these adapter programs begin with “rh”, followed by the common name of the control adapter and then a further descriptor. Third, related object addition/modification forms that are used to gather user input to add or modify related objects. The object addition/modification forms may be called from the control window, gather the related information, validate the existence of user inputs, then call back to the related sub form or forms with the information and an indicator as to which function to perform. In the present embodiment, these object addition/modification forms use names which are the same as the related sub windows except that they end in “addform.jsp”. Fourth, related processing forms, which are used to start and monitor the execution of a variety of system processes initiated from the user interface. These processing form adapter programs may not contain sophisticated display logic and can be associated with either a control window or a sub window. These adapters generally have names ending in “procjsp”.

Item 1101, rhdisclaimform.jsp, provides the legal disclaimers. Item 1102, rhlogin.jsp, provides the display logic, validation logic, and session initiation logic for managing the user login process. Item 1103, rhmain.jsp, contains the main window control logic, and provides a menu structure allowing access to the system's other functionality. Item 1104, rhmainprocform.jsp, supports the main windows exit process.

Items 1105 through 1111 provide a set of functionality related to the application's client information object. Item 1105 provides the main control window for accessing this functionality. Item 1106 provides a sub windows interface for displaying and applying updates to primary details such as client name and header details. Item 1107 provides a sub window interface for displaying and applying updates to secondary client information such as input directories and output directories. Item 1108 provides an addition/modification interface for changing the client name. Item 1109 provides an addition/modification interface for changing the client header details. Item 1110 provides an addition/modification interface for changing the client input directories. Item 1111 provides an addition/modification interface for changing the client output directories.

Items 1112 through 1116 provide the set of functionality related to the application's user and user security information. Item 1112 provides the main control window for accessing this functionality. Item 1113 provides a sub windows interface for displaying and applying updates to primary user information such as user identifier and password. Item 1114 provides a sub window interface for displaying and applying updates to user preferences such as date format. Item 1115 provides an addition/modification interface for adding users and changing existing users passwords. Item 1116 provides a sub window interface for displaying and capturing/applying updates to the users security role configuration.

Items 1117 through 1121 provide the set of functionality related to the application's source system and system field information. Item 1117 provides the main control window for accessing this functionality. Item 1118 provides a sub windows interface for displaying and applying updates to system definition information such as system identifier and system name. Item 1119 provides an addition/modification interface for adding system definitions. Item 1120 provides a sub windows interface for displaying and applying updates to system field information such as field identifier and field type. Item 1121 provides an addition/modification interface for adding system fields.

Items 1122 through 1138 provide the set of functionality related to the application's reconciliation definition information. Item 1122 provides the main control window for accessing this functionality. Item 1123 provides support for the reconciliation definition extract process. Item 1124 provides a sub windows interface for displaying and applying updates to primary reconciliation information such as reconciliation identifier and reconciliation description. Item 1125 provides an addition/modification interface for adding reconciliation objects. Item 1126 provides a sub windows interface for displaying and applying updates to reconciliation system information. Item 1127 provides an addition/modification interface for adding reconciliation system objects. Item 1128 provides a sub windows interface for displaying and applying updates to reconciliation key field information. Item 1129 provides an addition/modification interface for adding reconciliation key field objects. Item 1130 provides a sub windows interface for displaying and applying updates to reconciliation, data compare, and data field, information. Item 1131 provides an addition/modification interface for adding or modifying data compare information such as description, ignore case, and ignore space settings. Item 1132 provides an addition/modification interface for adding reconciliation data field objects. Item 1133 provides a sub windows interface for displaying and applying updates to reconciliation information field information. Item 1134 provides an addition/modification interface for adding reconciliation information field objects. Item 1135 provides a sub windows interface for displaying and applying updates to archive move control and archive move status information. Item 1136 provides an addition/modification interface for adding archive move control objects. Item 1137 provides an addition/modification interface for adding archive move status objects. Item 1138 provides a sub windows interface for displaying, capturing, and applying updates to secondary reconciliation information such as ignore space, ignore case, and reconcile real-time settings.

Items 1139 through 1145 provide the set of functionality related to the application's reconciliation data and data manipulation functionality. Item 1139 provides the main control window for accessing this functionality. Item 1140 provides support for the batch reconciliation process. Item 1141 provides a sub windows interface for displaying and applying updates to data group and related information such as reconciliation items. Item 1142 provides a processing interface for supporting manually initiated data group processes such as close group and reset group. Item 1143 provides a popup window interface for display further data group details and related information such as item compare element details. Item 1144 provides a popup window interface for selecting and then applying field level filters to the active sub window 1141. Item 1145 provides a sub windows interface for displaying status information related to the active sub window 1141.

Items 1146 through 1150 provide the set of functionality related to the application's reconciliation data and data reporting functionality. Item 1146 provides the main control window for accessing this functionality. Item 1147 a display template for the report extraction process. Item 1148 provides a sub windows interface for displaying report information for data groups and their related information such as reconciliation items. Item 1149 provides a popup window interface for selecting and then applying field level filters to the active sub window provided by item 1148. Item 1150 provides a sub windows interface for displaying status information related to the active sub window provided by item 1148.

Items 1151 through 1155 provide the set of functionality related to the application's archived data. Item 1151 provides the main control window for accessing this functionality. Item 1152 provides a sub windows interface for displaying archive data information. Item 1153 provides support for the archive group's restore process. Item 1154 provides a popup window interface for display further archive data group details. Item 1155 provides a sub windows interface for displaying status information related to the active sub window of item 1152. Items 1156 and 1157 provide utility level functionality for working with data processing errors. Item 1156 provides the main control window for accessing this functionality. Item 1157 provides a sub windows interface for displaying and modifying the related error information.

Items 1158 through 1161 provide the set of functionality related to the application's file reader objects. Item 1158 provides the main control window for accessing this functionality. Item 1159 provides a processing interface for starting and stopping individual file readers as well as uploading data files for a specific reader. Item 1160 provides a sub window interface for displaying and updating file reader information. Item 1161 provides an addition/modification interface for adding file reader objects.

Items 1162 through 1164 provide the set of functionality related to the managing the application's archive processing. Item 1162 provides the main control window for accessing this functionality. Item 1163 provides a processing interface for starting an archive process. Item 1164 provides a sub window interface for displaying information related to the archive move controls.

Items 1165 through 1170 provide the set of miscellaneous and shared functionality. Item 1165 provides a popup windows interface for displaying information related to the application's version. Item 1166 provides a popup windows interface for displaying system documentation information. Item 1167 provides a shared popup windows interface for displaying and modifying context sensitive help information. Item 1168 provides a set of shared java routines used by the adapter programs. Item 1169 provides a set of shared java script routines used by the adapter programs. Item 1170 provides a set of shared user interface formats used by the adapter programs.

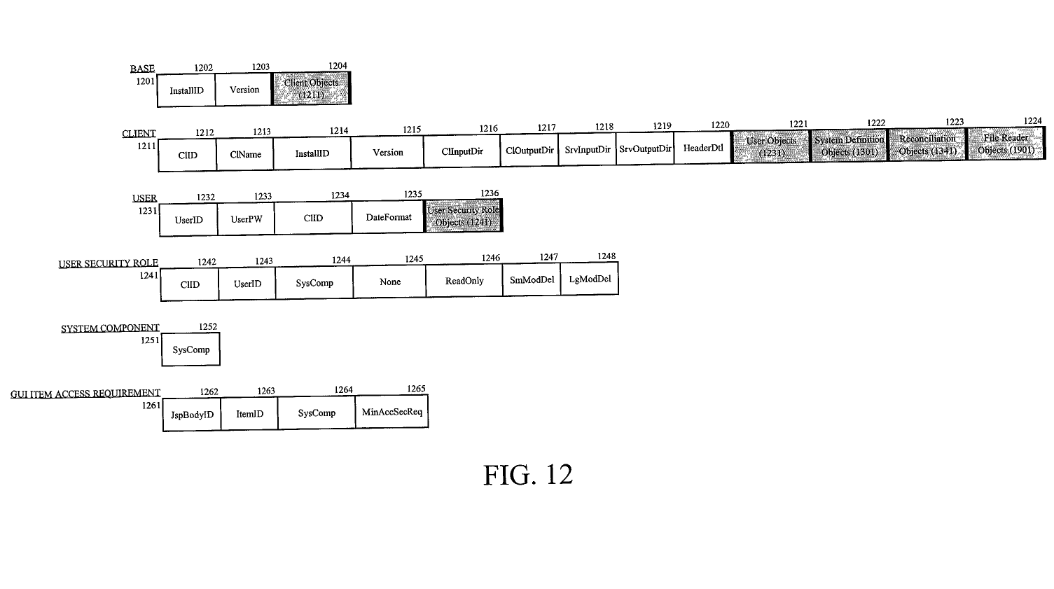

FIG. 12 shows a series of in-memory objects responsible for a set of basic functionality within the system of the present invention. Object 1201 is the system's base object for tracking software installation identifier (installid) 1202 and version (version) 1203 of a particular installation of the Reconciliation Manager. The base object is the parent of all client objects (client) 1211 and contains the access methods for these objects as referenced by field 1204. The client 1211 represents the set of client detail objects, which are used to manage information such as client identifier (client identifier) 1212 for the client object, client name (clname) 1213, installation identifier (installid) 1214 that is repeated from its parent object, version number 1215 that is repeated from its parent object, client input directory (clinputdir) 1216 and client output directory (cloutputdir) 1217 for receiving data from and transferring data to a client's machine, server input directory (srvinputdir) 1218 and server output directory (srvoutputdir) 1219 used for reading data files from and sending data files to a specific server location for the client, and header details (headerdtl) 1220 which contains header information (in the form of a fixed string) required on all messages received by the Reconciliation Manager from all source systems belonging to the particular client. It should be noted that the source systems provide the data that is reconciled using the present invention.

The client object is the parent object of, and contains the access methods for the following set of user objects (user) 1221, system definitions (system definition) 1222, reconciliation definitions (reconciliation) 1223, file readers (file reader) 1224 and/or the like. The user object 1231 contains the basic information on users of the system. The system can have a number of user objects, which are uniquely identified across all clients 1211 in the system by the user identifier (userid) 1232. The user object contains fields for the user's password (userpw) 1233, client identifier 1234 that is inherited from its parent object, date format (dateformat) 1235 for identifying the preferred data format of the user.

The user object is the parent object of, and contains the access methods for, the user's individual set of security role objects 1236. The user security role objects 1241 are used to specify the level of access a particular user has been given for each of the system's different components or business functions. The user security role objects 1241 contain client identifier 1242 and user identifier 1243 which each inherit directly from the parent object, system component (syscomp) 1244 to identify the component which the access specification applies to, and a no access indicator (none) 1245, a read only indicator (readonly) 1246, a small modification deletion indicator (smmoddel) 1247, and a large modification indicator (lgmoddel) 1248. Each of the indicators 1245-1248 indicate a specific type of access. According to one embodiment, only one of these access types is specified for each of the user's system components and, the objects are unique with a given user having only one object for each component. The system component object (system component) 1251 contains a complete set of system components (syscomp) 1252. The system component object 1251 acts as a constraint on the syscomp identifiers 1252 used in both user security role 1241, and the GUI item access requirements object 1261. The GUI item access requirement objects defines the different business methods in the system which use security controls and for each of these methods the type of access required to execute the method. These objects are uniquely identified by the program body identifier (jspbodyid) 1262 and the action identifier (itemid) 1263. Each object also contains a system component (syscomp) 1264 identifier which determines which component of system's functionality the action belong to and a minimum access required (minaccsecreq) 1265 identifier which defines the minimum access required to perform the related action.

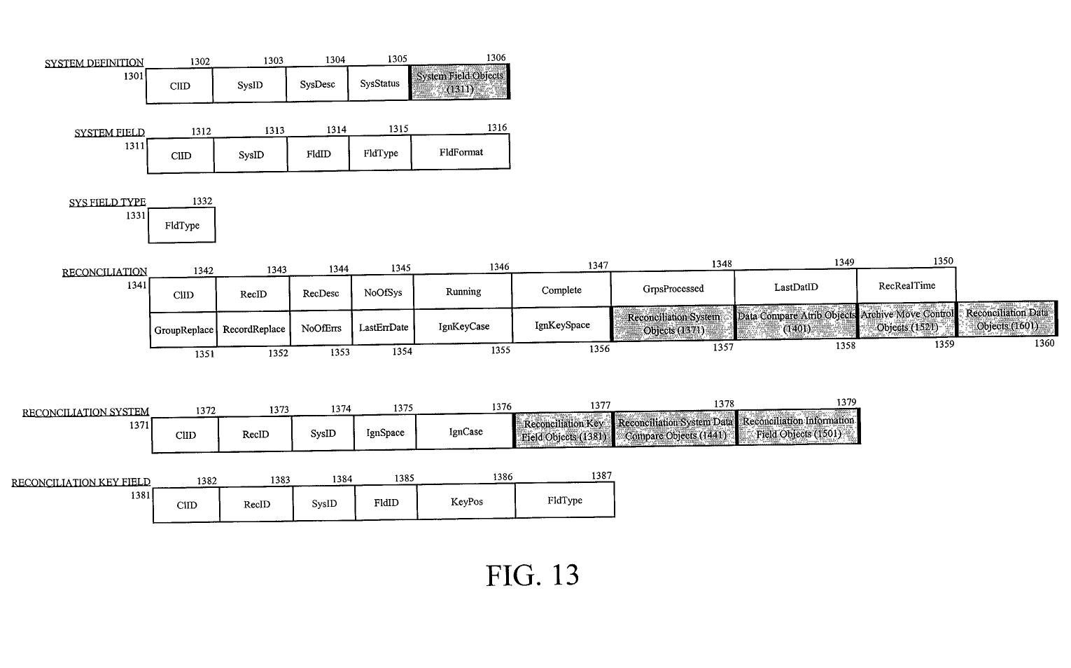

FIG. 13 represents some of the objects used to support Reconciliation Manager's reference library functionality. This complete set of reference library objects, as represented in FIGS. 13-15, provide the core of flexibility which enables the reconciliation application to adapt its user interface, data storage, and processing structures to meet the goal of facilitating reconciliation for any possible business information.

Object 1301 represents the system definition information (system definition) for the various source systems of a particular client. A client may have any number of system definition objects which are uniquely identified within the application by client identifier 1302 that is inherited from the parent object, and a system identifier (system identifier) 1303 that is either entered by the user or taken from the organization data dictionaries. The object also contains system description (sysdesc) 1304 of the given system, and a status indicator (sysstatus) 1305 to specify whether the given system is currently active or suspended. Each system object manages, and contains access methods for, its own set of system field object 1311 as represented by system field objects (system field) 1306.

The system field object 1311 is used to define the individual data elements available for reconciliation from a given system. The system field object 1311 is uniquely identified in the system by client identifier 1312 that is inherited from its parent object, system identifier 1313 that is inherited from its parent object, and the field identifier (field identifier) 1314 that is entered by a user or derived from an organization's data dictionary information. The object also comprises a field type (fldtype) 1315 to identify the type of data expect in the field (i.e. date, string, number and/or the like), and field format (fldformat) 1316 to specify formatting characteristics of a given field, such as field date of format mm/dd/yyyy, and/or the like. The typing and formatting of individual fields allows the Reconciliation Manager to perform intelligent translation of data into the common system supported formats for matching and comparison. The set of system field type objects 1331 provides the set of available field types supported by the system. Each of these objects contains a field type 1332 value, the complete set of which controls the field type values which can be entered into filed type 1315.

According to one embodiment, the system also supports a wide set of different field formats that the system can accept, organized by data type. Also, a mapping tool is provided which can map the different data types that may be encountered in the organization's data dictionary into their related Reconciliation Manager format and type.

Object 1341 represents the definition and characteristics of a reconciliation (reconciliation). The system can contain any number of reconciliation objects 1341, which are identified uniquely in the application by client identifier 1342 that is inherited from its parent object, and reconciliation identifier (recid) 1343, a string value entered by a user. Reconciliation objects 1341 and their related child objects are used to bring together the information defined in a client's system definition objects 1301 and system field objects 1311. These set of reconciliation and related reconciliation configuration objects define precisely how the application will receive, match, reconcile, and report on the data originating from a clients various processing environments/source systems.

The reconciliation object 1341 contains a user entered description of the reconciliation (recdesc) 1344, a system managed indicator which tracks the number of systems participating in the individual reconciliation (noofsys) 1345, a system managed field which indicates if the batch driven reconciliation process is currently running for the given reconciliation (running) 1346, a system managed field which indicates if the last batch driven reconciliation process has completed successfully (complete) 1347, a system managed field which indicates the number of reconciliations performed during the last batch driven reconciliation process (grpsprocessed) 1348, a system managed field which indicates the last data identifier sequence number used by the reconciliation's set of reconciliation data child objects 1601 (lastdatid) 1349. The reconciliation object 1341 also comprises a user specified setting which tells the system if it should reconcile data real-time as the matching process is completed for individual data group or whether it should leave matched groups un-reconciled pending batch driven reconciliation (recrealtime) 1350, a user indicated setting which determine if new data items should be placed into existing reconciliation data group or if these items should cause the system to create new groups as existing groups become complete (groupreplace) 1351, a user indicated setting which determines how the system treats the addition of data item to existing groups when using group replace (recordreplace) 1352. If this record replace 1352 setting is true, then any new data items will be added to data groups using the group replace methodology and if a data item exists in the group for the given source system, this data item will be replaced by the new data item. However, if the record replace 1352 setting is false, the new data will be placed in the data group either new or existing along with any existing data items of the same group. There exists a system managed field, nooferrs 1353, that indicates the number of active processing errors that exist for the reconciliation, a system managed field indicating the last date an error occurred for the reconciliation (lasterrdate) 1354, a user specified setting which determines how the system treats character case in constructing match key values for data records of the reconciliation (ignkeycase) 1355, a user specified setting which determines how the system treats white space in constructing match key values for data records of the reconciliation (ignkeyspace) 1356.

The reconciliation object manages, and contains access methods for sets of child objects reconciliation system objects 1357, data comparison attribute objects 1358, archive move control objects 1359, and reconciliation data objects 1360. The reconciliation system objects 1371 are used to indicate to the application which system definition objects are part of a given reconciliation. These objects are uniquely identified in the system using client identifier 1372, inherited from the parent object, reconciliation identifier 1373 inherited from the parent object, and system identifier 1374 which is selected by the user from the clients set of available system definition objects 1301.

According to one embodiment, reconciliation system object 1371 also comprises ignore space field (ignspace) 1375 and ignore case field (igncase) 1376 which are user indicated settings for determining how the application manages character case and white space for data originating from the particular system. The reconciliation system object 1371 manages, and contains access methods for reconciliation key fields 1377, reconciliation system data compare objects 1378, and reconciliation information field objects 1379. The reconciliation key field objects (reconciliation key field) 1381 allow users to configure, for each system of a reconciliation, how the application combines the information provided on individual data items into character based match strings which, are later used to match related data items from the different system's of a reconciliation into data groups for reconciliation. Reconciliation key field objects 1381 are identified uniquely in the system by client identifier 1382 that is inherited from the parent object, reconciliation identifier 1383 that is inherited from the parent object, system identifier 1384 that is inherited from the parent object, field identifier 1385 that is selected by the user from the set of available field identifiers for the clients given system. The object also includes a system managed field used to control the order in which an individual set of key field objects is processed (keypos) 1386 and, a system managed field inherited from the related system field object 1311 (fldtype) to indicate the data type expected for information received for the given field identifier 1387.

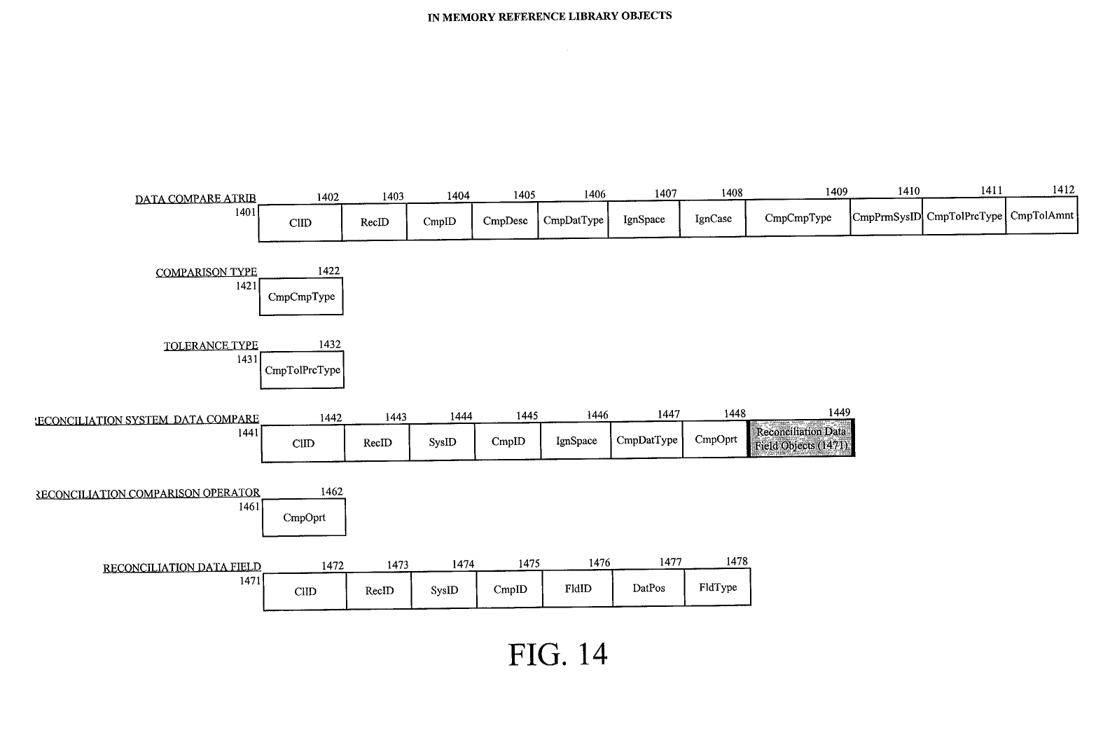

FIG. 14 contains additional objects which are part of the set of objects supporting Reconciliation Manager's reference library functionality. The data compare attribute (data compare attrib) objects 1401 is a set of objects that control the individual processing characteristics of each of the different data comparisons for an individual reconciliation. According to one embodiment, a given reconciliation can have any number of comparisons with each comparison utilizing exactly one data compare attribute object 1601. These data compare attribute objects 1401 are core to providing the intelligence/processing characteristics of a reconciliation's individual data comparisons and, control precisely how the application determines which data elements, from matched data items of each of the different systems of a reconciliation, can be considered equal. The attribute objects 1401 are uniquely identified in the system using a client identifier 1402 that is inherited from the parent object, reconciliation identifier 1403 that is inherited from the parent object, compare identifier (compare identifier) 1404 which is a system generated field that assigns a numeric identifier to the individual comparison as it is created by the user.

The data compare attribute object 1401 also comprises a user entered description of the individual comparison (cmpdesc) 1405, a user selected data type for the comparison originating in the applications set of system field type objects 1331 (cmpdattype) 1406, a user indicated setting which determines if white space characters are significant in the individual data comparison (ignspace) 1407, a user indicated setting which determines if character case is significant for the individual comparison (igncase) 1408, a user selected value which determines the type of comparison (i.e. strictly equal, absolute value) (cmpcmptype) 1409, a user selected value originating from the set of reconciliation system objects 1371 for the given reconciliation and determining which of the comparisons system's to use in generating auto correction values (cmpprmsysid) 1410, a user selected value indicating which type of tolerance processing should apply to the comparison (cmptolprctype) 1411, a user provided value indicating a numeric amount to apply to individual tolerance calculations (cmptolamnt) 1412. Using this group of tolerance settings, the Reconciliation Manager allows a user to differentiate types and levels of tolerance by user provided tolerance key values tied to the different system field of a given reconciliation. This feature may enable a user to provide a tolerance specification coupled to an individual field such as payment currency designator (such as U.S. Dollars, Italian Lira) and then specify different tolerance types and levels based on the value of the specified field. If, for instance, the payment is in U.S. Dollars the tolerance could be 0.05 and if the payment where in Italian Lira, the tolerance could be 2,000.00. These tolerance amounts are used to determine whether values that are not exactly the same can be considered equal for reconciliation purposes. The system also provides a variety features for tracking and reporting on individual and cumulative amounts written off due to tolerance processing.

The set of comparison type objects (comparison type) 1421 contains the different comparison types supported by the system. This object/field controls the values which can be entered into the comparison field (cmpcmptype) 1409. The set of available tolerance processing types objects (tolerance type) 1431 provides the available tolerance processing options a user can select within the system. These values are stored in field (cmptolprctype) 1432. The reconciliation system data compare (reconciliation system data compare) 1441 objects define additional characteristics of the data comparison process for each system and data comparison of a reconciliation. The reconciliation system data compare objects are uniquely identified within the system using client identifier 1442, inherited from parent object reconciliation system 1371, reconciliation identifier 1443, inherited from parent object reconciliation system 1371, system identifier 1444, inherited from parent object reconciliation system 1371, compare identifier 1445 that is inherited from the related data compare attribute object 1401, ignore space 1446 that is inherited from the related data compare attribute object 1401, compare data type 1447 that is inherited from the related data compare attribute object 1401. In addition, according to one embodiment, a user selected field that determines how the system will combine multiple values from the given system and comparison into an ultimate value for reconciliation (cmpoprt) 1448 may be part of the reconciliation system data compare objects. This cmpoprt value 1448 in conjunction with data type 1447 will determine how the ultimate comparison value is derived. For example, a numeric data type could use the average setting to compute an average value for all the fields which are part of the particular comparison from the given system not clear return.

The reconciliation system data compare object 1441 manages and contains access method for a set of related reconciliation data field objects 1449. The reconciliation data field objects (reconciliation data field) 1471 are used to indicate to the application which individual data fields are used to extract and derive comparison values from data records which are sent to reconciliation manager from a given system for a given reconciliation. Similar to other objects described above, these object 1471 are uniquely identified in the application using client identifier 1472, reconciliation identifier 1473, system identifier 1474, compare identifier 1475, and a field identifier 1476.

This object 1471 also contains a system managed field used to control the order in which individual set of data field objects is processed (datpos) 1477, and a system managed field inherited from the related system field object 1311 (fldtype) indicating the data type expected for information received for the given field identifier 1478.

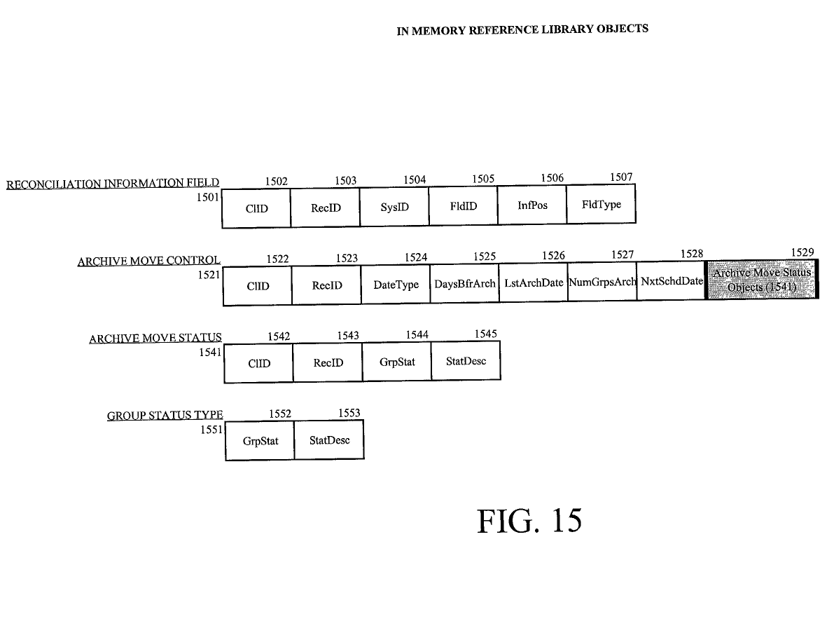

FIG. 15 describes the third and final set of objects used in Reconciliaion Manager's reference library. The figure begins with the reconciliation information field object (reconciliation information field) 1501, which is used to define information data for the given reconciliation system 1371 which, once extracted from data records using the specified field identifiers, is then used to tie the reconciliation correction and status information back to related data records in the individual source systems, either manually or automatically. These objects 1501 are uniquely identified within the application using client identifier 1502 that is inherited from parent object 1371, reconciliation identifier 1503 that is inherited from parent object 1371, system identifier 1504 that is inherited from parent object 1371, and a field identifier 1505 that is selected by the user from the set of available field identifiers for the client's given system. This object also comprises a system managed field used to control the order in which individual set of data field objects are processed (infpos) 1506, and a system managed field inherited from the related system field object 1311 (fldtype) indicating the data type expected for information received for the given field identifier 1507.

The archive move control object (archive move control) 1521 is used by the system to manage the process of moving old or unused reconciliation data from the processing environment into the system's online archive. Using this object 1521, a user can define how long a reconciliation's data groups should remain in the system before being archived. The object is uniquely defined in the system by client identifier 1522 that is inherited from parent object 1341, and a reconciliation identifier 1523 that is inherited from parent object 1341. The object also contains a user selected setting which determine if data groups are selected for archive based on the business date or the system date (datetype) 1524, a user specified number which indicates the total number of days records will remain in the system before they are archived (daysbfrarch) 1525, a system managed field which indicates the last date the archive process was run for the given reconciliation (lstarchdate) 1526, a system managed field 5 indicating the number of data groups archived during the last completed archive process run (numgrpsarch) 1527, a date which indicates the next date the system's auto archive process is scheduled to run (nxtschddate) 1528.

The archived move control 1521 also manages and contains access methods for the related set of archive move status objects 1529. The archive move status object (archive move status) 1541 controls which data groups are eligible for archive by preventing the system from archiving groups which do not have a status type in the related set of archive move status objects. These objects are uniquely identified in the system by client identifier 1542 that is inherited from the parent object, a reconciliation identifier 1543 that is inherited from the parent object, and a value selected by the user from the set of available system group status options (grpstat) 1544. The object also contains a description of the given status inherited from the related group status type object (statdesc) 1545. The group status type object (group status type) 1551 defines the set of available group status options for the application. These object are uniquely identified by a fixed numeric status identifier (grpstat) 1552. The object also contains a fixed description of the status (statdesc) 1553. This object provides the set of available options for selecting values for group status 1544 and status description 1545.

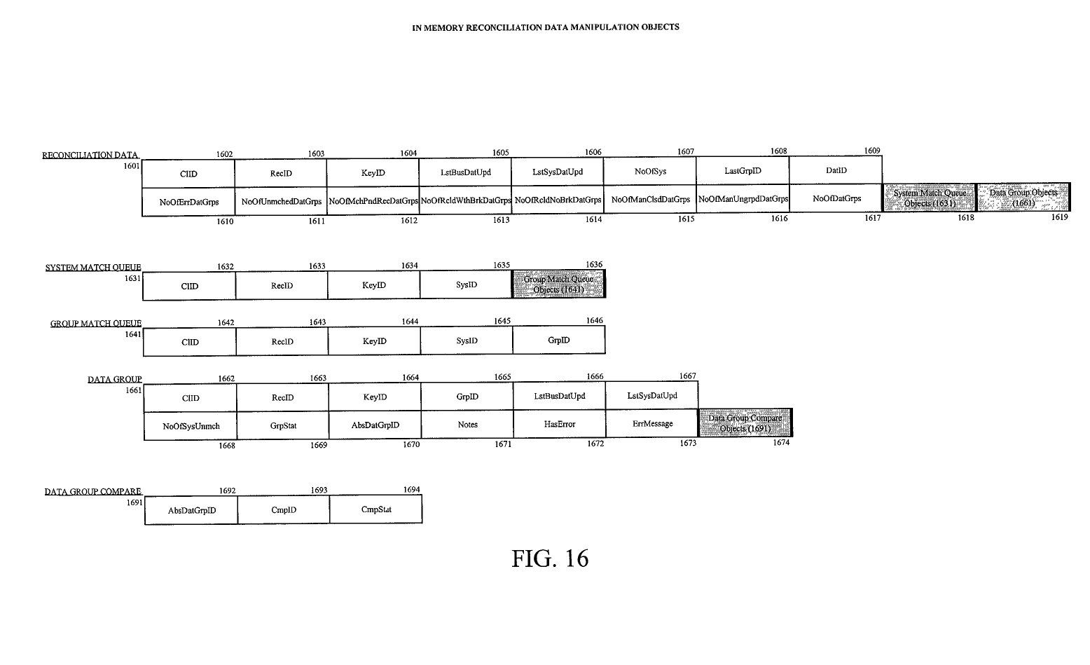

FIG. 16 contains a portion of the overall set of objects used to manage the storage and processing of reconciliation data within the Reconciliation Manager. Objects in this segment of the application are generally created as data items arrive into the Reconciliation Manager for processing from the individual source systems for designated reconciliations. System processes are used to receive this data then use the related reference library information to interpret and process the data and produces new sets of related reconciliation data objects. The first object in this set is the reconciliation data object (reconciliation data) 1601, which is used to segment and manage data for a given client and reconciliation by match key string. For example, a reconciliation could have data organized by a match key of account identifier and if one particular account identifier was “1234567” then any non archived data for this client, reconciliation, and account identifier would be accessible through the related reconciliation data object 1601 and its related child objects. These reconciliation data objects 1601 are uniquely identified within the system using client identifier 1602, inherited from the parent object, reconciliation identifier 1603, inherited from the parent object, and a key identifier 1604 which is computed for the related data item during the decomposition process and then inherited from the reconciliation item's match key field 1710.

Other fields of this object are system managed fields indicating the latest business date of data contained in the object's child objects (lstbusdatupd) 1605 that is used to control object selection for retrieval, a system managed field indicating the latest system date of data contained in the object's child objects (lstsysdatupd) 1606 that is used to control object selection for retrieval. A system managed field indicating the number of systems which participate in the given reconciliation (noofsys) 1607, a system managed field which is used to generate sequence numbers for related data group child objects (lastgrpid) 1608, a system managed field derived from the parent object as a sequence number for the reconciliation data object of the reconciliation (datid) 1609. According to another embodiment, the reconciliation data object 1601 also comprises a system managed field indicating the number of child data group objects having a status of error (nooferrdatgrps) 1610, system managed field indicating the number of child data group objects having a status of unmatched (noofunmcheddatgrps) 1611, a system managed field indicating the number of child data group objects having a status matched pending reconciliation (noofmchpndrecdatgrps) 1612, a system managed field indicating the number of child data group objects having a status reconciled with data breaks (noofrcldwthbrkdatgrps) 1613, a system managed field indicating the number of child data group objects having a status reconciled with no breaks (noofrcldnobrkdatgrps) 1614, system managed field indicating the number of child data group objects having a status of manually closed (noofmanclsddatgrps) 1615, a system managed field indicating the number of child data group objects having a status manually ungrouped (noofmanungrpddatgrps) 1616. According to another embodiment, the reconciliation data object 1601 also comprises a system managed field indicating the total number of child data group objects (noofdatgrps) 1617.

The reconciliation data object 1601 also manages, and contains access method for the following set of child objects, system match queue objects 1618, and data group objects 1619. System match queue object (system match queue) 1631 are used by the Reconciliation Manager to segment the un-matched data groups of a clients reconciliation which are awaiting data records from individual source system for a particular match key to complete their individual match process. These system match queue objects 1631 and are identified uniquely in the application using client identifier 1632 that is inherited from parent object, reconciliation identifier 1633 that is inherited from parent object, key identifier 1634 that is inherited from parent object, and system identifier 1635 that is inherited from a related reconciliation system object 1371. A given system match queue object 1631 manages, and provided access methods for its related group match queue objects 1636. Group match queue objects (group match queue) 1641 are used to indicate and provide an ordered list of data group objects which are awaiting information from a particular system to complete their matching process. These group match queue objects 1641 are uniquely identified in the application using client identifier 1642 that is inherited from parent object, a reconciliation identifier 1643 that is inherited from parent object, key identifier 1644 that is inherited from parent object, system identifier 1645 that is inherited from the parent object, and a group identifier 1646 that is inherited from the related data group object 1661. The data group objects (data group object) 1661 are used by the application to combine data records from the different systems for a given client, reconciliation, and key identifier combination into grouped sets of information which are then used as a group for reconciliation, reporting and various other system processes. These data group objects are uniquely identified in the system using client identifier 1662 that is inherited from the parent object, reconciliation identifier 1663 that is inherited from the parent object, key identifier 1664 that is inherited from the parent object, and group identifier 1665 which is a unique sequence identifier derived from the parent object's last group identifier (LastGrpID) 1608, last business data update (lstbusdatupd) 1666 that is inherited from the parent object, last system date update (lstsysdatupd) 1667 that is inherited from the parent object, number of system's unmatched (noofsysunmch) 1668 which is a system managed field that indicates the number of systems that remain to contribute data to the group before its match process is complete, group status (grpstat) 1669 that is a system managed field indicating the status of the individual group, absolute data group id (absdatgrpid) 1670 that is a system managed field which identifies the data group absolutely with in the application's set of data groups. This absolute data group identifier is generated using the sequence generation object 1951, data group notes (notes) 1671 is provided as a field for capturing and reporting on user generated notes for the given data group, data group has error (haserror) 1672 is a system managed field indicating if the data group has a processing error, error message (errmessage) 1673, is a system managed field which indicated a group's any related processing error message if they exist. The data group object 1661 manages and contains access methods for related data group compare child objects 1674. Data group compare objects (data group compare object) 1691, are used by reconciliation manager to store and report on the status on an individual data comparison for the related data group parent object. The data group compare objects are identified uniquely with in the application using an absolute data group identifier (absdatgrpid) 1692 that is inherited from the parent object, and a compare identifier 1693 that is inherited from the related data compare attribute object 1401. The object also contains compare status (cmpstat) 1694 that is derived through the application's reconciliation process and, related to, limited by, the application's set of group status types 1551.

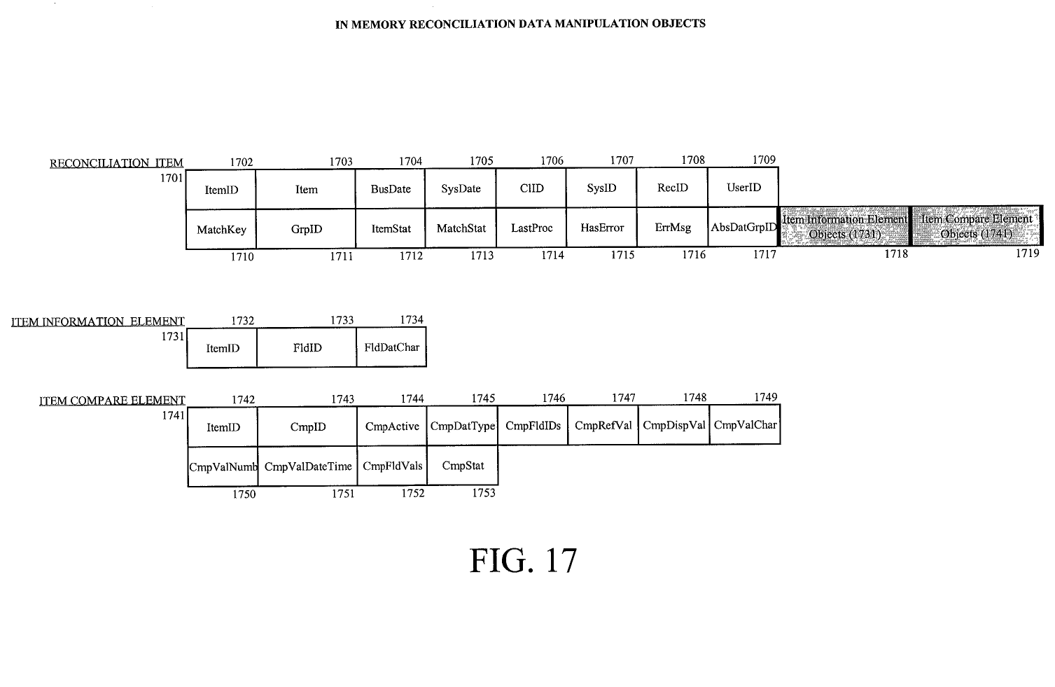

FIG. 17 contains additional objects which support Reconciliation Manager's data storage and processing capabilities. The reconciliation item objects (reconciliation item) 1701 are used by the application to store and manage the details of individual data records originating from the different source systems. These objects are uniquely identified in the application using the item identifier (itemid), 1702 an application wide sequence number generated by the sequence generation object 1951. These reconciliation item objects also comprise a system managed field containing the actual text of the data record message received 1703, a business date extracted by the application from the individual messages header information (busdate) 1704, a system generated date indicating the date on the server at the time the message is processed (sysdate) 1705. These reconciliation item objects also comprise a client identifier 1706 which is a value contained in the message header that is validated then inherited from the related client object 1211, a system identifier 1707 which is a value contained in the message header that is validated then inherited from the related reconciliation system object 1371, a reconciliation identifier 1708 which is a value contained in the message header that is validated and then inherited from the related reconciliation object 1341, a user identifier 1709 which is a value contained in the message header that is validated then inherited from the related user object 1231, match key string (matchkey) 1710, a value which is derived using the contents of the message and the set of reconciliation key filed objects 1381 for the given reconciliation system.

This match key string 1710 is related to the key identifier as that value appears throughout other objects in the system, group identifier 1711, a value which in conjunction with client identifier, reconciliation identifier, and match key string indicates which data group object 1661 the related reconciliation item 1701 belongs to, a system managed field containing a numeric value indicating the status of the item (itemstat) 1712, a system managed field indicating a textual abbreviation of the items status (matchstat) 1713, a system managed field indicating the last successful process run against the item (lastproc) 1714, a system managed indicator specifying if the item is in an error state (haserror) 1715, a system managed field indicate a related error message for the item (errmsg) 1716, a system managed field inherited from the related data group object 1661 and also indicating which data group the item belongs to (absdatgrpid) 1717.

The reconciliation item object manages, and contains the access method for the related item information element objects 1718, and related item compare element objects 1719. Item information element objects (item information element) 1731 are used to store the individual information reference values for a reconciliation item parent object 1701. These item information element objects are uniquely identified in the system using item identifier 1732 that is inherited from the parent object, and field identifier 1733 which is a value that is contained in the related message data that is validated then inherited from the related reconciliation information field objects 1501.

The item information element also contains a field which holds the data for its associated field identifier (fiddatchar) 1734. This data is extracted from the related message and placed in fiddatchar 1734 as part of the message decomposition process. Item compare element objects (item compare element) 1741 are used by Reconciliation Manager to store and manage the derived comparison values for the related reconciliation item parent object 1701. These item compare elements are uniquely identified in the system using item identifier 1742 that is inherited from the parent object, and a compare identifier 1743 that is inherited from its related reconciliation system data compare object 1741. The object 1741 also contains a system derived value which indicates if a comparison value is expected for the related reconciliation system data compare objects 1741 and reconciliation data field objects 1471 (cmpactive) 1744, the comparison's data type (cmpdattype) 1745 that is inherited from the related reconciliation system data compare objects 1441, a list of list of field identifiers obtained from the related set of reconciliation data field objects 1471 used in computing the value (cmpfldids) 1746, a field which stores a user generated correction value or note for the individual comparison element value (cmprefval) 1747, a system generated string based display version of individual compare value (cmpdispval) 1748, the system generated derived character value for the comparison element (cmpvalchar) 1749 which is used only if cmpdattype is “string”, the system generated derived numeric value for the comparison element (cmpvalnumb) 1750 that is used only if cmpdattype is “number”, the system generated derived date time value for the comparison element (cmpvaldatetime) 1751 that is used only if cmpdattype is “date”, a system generated string containing the data values which went into computing the related derived value for the element (cmpfldvals) 1752, and a system managed field containing a numeric status indicator for the individual status element (cmpstat) 1753.

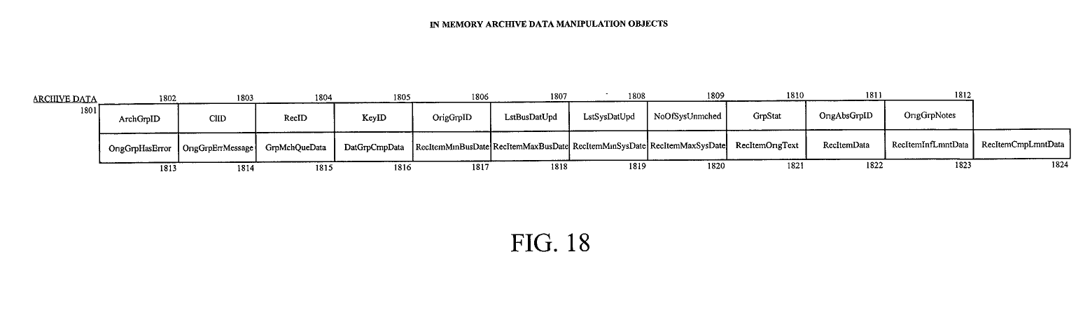

FIG. 18 contains the archive data object (archive data) 1801, which is used to store the archived version of individual data groups objects and the complete set of related data objects. These objects 1801 are condensed into a system managed XML format for object or set of object with, the complete set of related data for a particular data group being stored in the archive data object as one individual object or record. These archive data group objects are identified uniquely in the application by a unique system wide sequence number generated by the sequence generation object 1951 (archgrpid) 1802.

The archive data object also contains a client identifier 1803, reconciliation identifier 1804, key identifier 1805 each inherited from the related data group object 1661, original group identifier (origgrpid) 1806 that is inherited from group identifier 1665, last business date update (lstbusdatupd) 1807, lasts system date update (lstsysdatupd) 1808, number of system's unmatched (noofsysunmched) 1809, group status (grpstat) 1810, wherein of these fields is inherited from the related data group object 1661. The archive data object also contains original absolute data group identifier (origabsgrpid) 1811 that is inherited from absolute data group identifier (absdatgrpid) 1670, original data group notes (origgrpnotes) 1812 that is inherited from notes 1671, original data group has error (origgrphaserror) 1813 that is inherited from has error field (haserror) 1672, original data group error message (origgrperrmessage) 1814 that is inherited from error message 1673, data group match queue data (grpmchquedata) 1815 which is a system generated value containing a condensed version of all of the data group objects related group match queue objects 1841, data group comparison data (datgrpcmpdata) 1816 which is a system generated value containing a condensed version of all of the data group objects related data group compare objects 1691, reconciliation minimum business date (recitemminbusdate) 1817 which is a system generated value containing the minimum business date of all related reconciliation items 1901, reconciliation item maximum business date (recitemmaxbusdate) 2818 which is a system generated value containing the maximum business date of all related reconciliation items 1901, reconciliation item minimum system date (recitemminsysdate) 1819 which is a system generated value containing the minimum system date of all related reconciliation items 1901, reconciliation item maximum system date (recitemmaxsysdate) 1820 which is a system generated value containing the maximum system date of all related reconciliation items 1701, reconciliation item original text (recitemorigtext) 1821 which is a system generated value containing a condensed version of all of the data group objects related reconciliation item objects 1701 related item fields 1703, reconciliation item data (recitemdata) 1822 which is a system generated value containing a condensed version of all of the data group objects related reconciliation item objects 1701, reconciliation item information element data (reciteminflmntdata) 1823 which is a system generated value containing a condensed version of all of the data group objects related reconciliation item objects 1701 related item information element objects 1731, reconciliation item compare element data (recitemcmplmntdata) 1824 which is a system generated value containing a condensed version of all of the data group objects related reconciliation item objects 1901 related item compare element objects 1741.

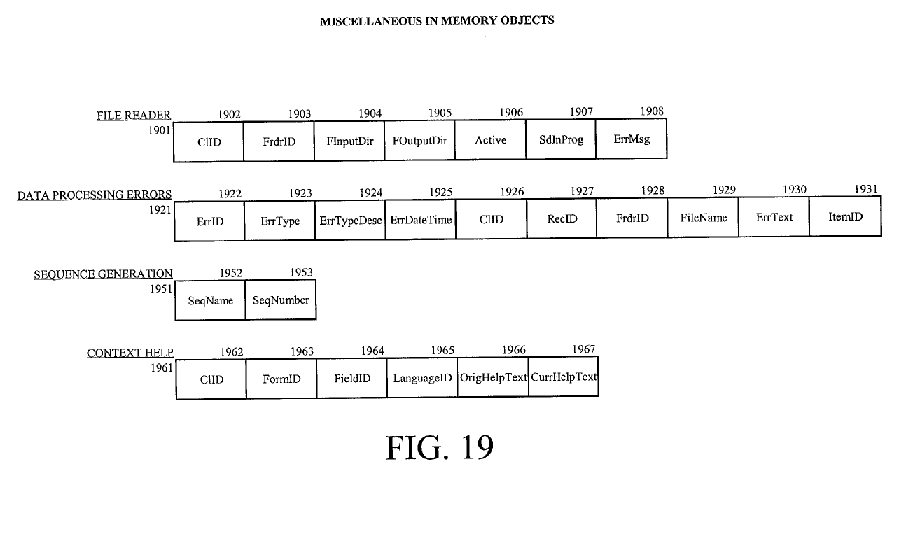

FIG. 19 shows a file reader object (file reader) 1901 that is used by the application to manage the reader processes for a given client. These reader processes are used to retrieve data record files for the client from server and submit the reconciliation text massages contained in these files to Reconciliation Manager for processing. The file reader objects are uniquely identified in the system using client identifier 1902 that is inherited from the parent object 1211, and the file reader identifier (frdrid) 1903 which is a system generated sequence number for the individual file reader object. The object also contains a user enter value specifying the directory location where a related reader process will look for files on the application server (finputdir) 1904, a user enter value specifying the directory location where a related reader process will generate output files on the application server (foutputdir) 1905, a system managed field indicating if the associated reader process is currently active for the file reader object (active) 1906, a system managed field indicating if the associated reader process is currently in the process of shutting down for the file reader object (sdinprog) 1907, and a system managed field indicating any error messages generated by an associated reader process (errmsg) 1908.

The data processing errors objects (data processing error) 1921 are used by Reconciliation Manager to report on, and manage related objects for, any processing errors that occur in the application. Data processing error object are uniquely identified in the system using error identifier (errid) 1922 which is a unique system wide sequence number generated by the sequence generation object 1951. The data processing error objects also contains error type identifier (errtype) 1923 which is a system generated numeric type indicator for the error, error description field (errtypedesc) 1924 that is a system generated description of the error, error date time (errdatetime) 1925 that is the system date time when the error occurred, client identifier 1926 that is inherited from the object originating the error, a reconciliation identifier 1927 that is inherited from the object originating the error, file reader 1928 that is inherited from the file reader object 1901 on which the error occurred, the name of the input message file containing the data record which caused the error (filename) 1929, a system generated description of the error (errtext) 1930, item identifier (itemid) 1931 that is inherited from the reconciliation item object 1701 which caused the error.

The sequence generation object (sequence generation) 1951 is an application wide object which is used to produce incremental and unique sequence numbers for various type of objects and object fields. These objects are identified uniquely by sequence name (seqname) 1952, where the system contains a predefined set of these objects and has related sequence name (seqname) codes hard coded as part of the object creation process. The object also contains (seqnumber) 1953 which hold the last sequence use for any of the given sequence generation objects.

A context help object (context help) 1961 may be used by Reconciliation Manager to provide a GUI item's specific help information which is accessible and modifiable directly though the application's user interface. These objects are uniquely identified in the application using client identifier 1962 inherited from a related client object 1211, form identifier (formid) 1963 that is derived from the form identifier for an associated adapter program 1100, field identifier (fielded) 1964 which is a GUI item or function identifier for the related adapter program, language identifier (languageid) 1965 which identifies the language used for the help text. The object also contains original help text (orighelptext) 1966 that is the original system provided help text for the object, current help text (currhelptext) 1967, which is the user modified version of help text for the object.

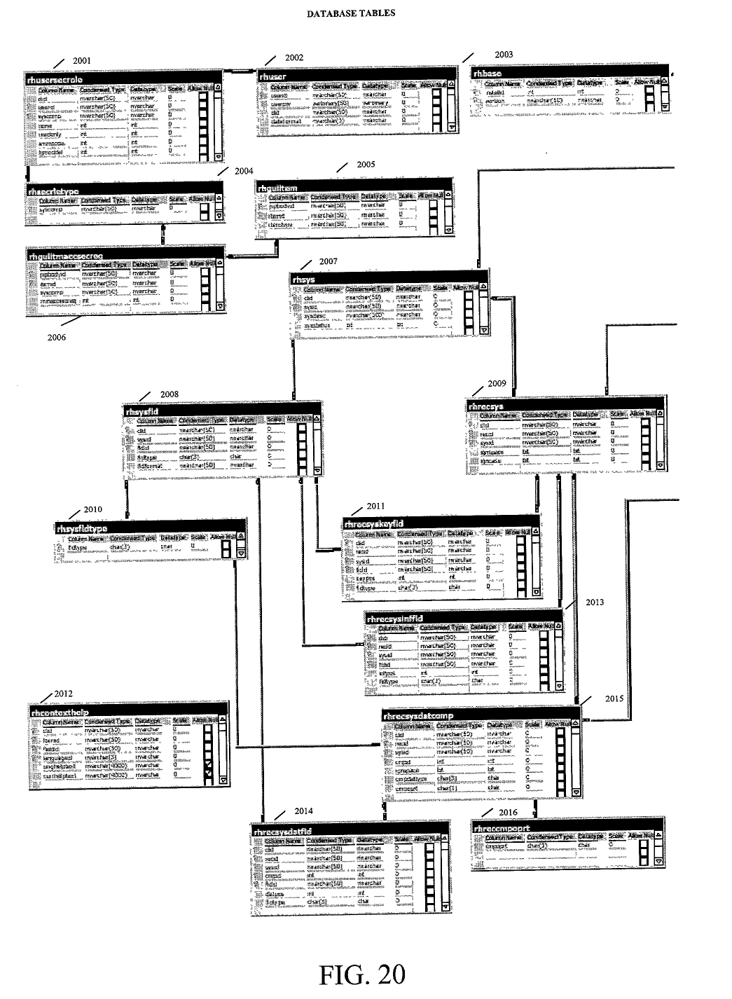

FIGS. 20-22 illustrate the application's database tables, their primary index structure, and their defined relation constraints. These database tables are used to store the data for their related in memory object counterparts. In these database tables, the system creates one individual record for each of the related in memory objects. Primary key structures for the individual tables map exactly to the primary key structures for the individual in memory objects. The mapping of individual tables to related in memory objects will be apparent from the table and object names where the table name is the same or, an abbreviation of, the object name except for the related table's prefix “rh”. For example, table reconciliation manager base (rhbase) 2003 maps to in-memory object base 1201 and table reconciliation manager client (rhcl) 2101 maps to in-memory object client 1211.

Other points of interest in relation to the above mentioned figures includes the use of relational table constraints and the method of persisting data between the objects and the tables. Table constraints are used between the tables to ensure the continuous integrity of the tables and related objects data. For example there exists a constraint between client table (rhcl) 2101, and the file reader table (rhfilereader) 2103. This constrains the each record in the file reader table 2103 contains a did values which exists in the client table 2101. In terms of persisting data between objects and tables this is achieved using industry standard techniques supported by the EJB standard and the web server's infrastructure.

FIG. 23 provides a flow diagram of the Reconciliation Manager's processes for enabling the user to create definitions of source systems that exist in their company through the application's user interface. These systems may be used to construct individual reconciliations and process the company's related data. This feature supports a link directly to an organization's data dictionaries for automated loading and selection of system information. The create system process of FIG. 23 begins with a user selecting the “Reference Library” menu option then selecting “Source Systems” menu option from the main window interface 1103. This option calls adapter program rhclsysform 1117. Then, selecting the “Add System” option provided by rhclsysform 1117 will call rhsysaddform 1119. Adapter program rhsysaddform 1119 presents the user with a screen for entering a system identifier, a system description, and an optional data source identifier. After this information is entered by the user and submitted we begin our processing with step 2301. Adapter program rhsysaddform 1119 begins by checking the existence and length of the system identifier and system description fields in 2302. If the information provided is valid, in 2303, the adapter program rhsysaddform 1119 calls rhsysform 1118, retrieves the client object 1211 from the existing user session in 2305. If the information entered is not complete or correct, the caller is alerted and asked to fix the data provided in 2304. With the obtained client object 1211, the adapter program calls the client object's 1211 add system (addsys) method, passing as parameters the system identifier and the system description. Using the client identifier 1212 from client object 1211 and the information provided, the add system (addsys) method attempts to create a new system definition object 1301, in 2306. If the system identifier provided is unique for the given client identifier then the system definition object is created in 2307. However, if the system identifier is not unique or some other unforeseen error occurs, the addition process is abandoned and the caller is notified in 2308. If the object creation is successful then client identifier 1302 will be set to client identifier 1212 as part of the normal system process for creating the related child objects of a given object though managed inheritance of values, system identifier 1303 will be set to the system identifier provided as part of the process for user configuration of the system/processing environment, sysdesc 1304 will be set to the description provided, the data source identifier will be stored in related field of the object, and sysstatus 1305 will be set to true indicating that the field is available for use in reconciliation. During this creation process, all leading and trailing spaces are removed from the system identifier and system description in 2309. Once the object creation process is complete the system creates a record for the object in table rhsys 2007 and returns the object to the calling adapter program rhsysform 1118, in 2310. The adapter program then refreshes the user's screen and display the information entered in 2311.

FIG. 24 illustrates the feature that allows a user to define through the

application's interface the field identifiers/data elements of each of their organization's systems. The feature supports type specific data, such as dates, numbers, and strings. The typing of individual fields enables Reconciliation Manager to perform intelligent comparisons of data elements in different systems. Also provided is support for a range of field formats as well as links directly to an organization's data dictionaries for automated loading and selection of system field information.

The create system field process of FIG. 24 begins with a user selecting the “Reference Library” menu option and then selecting “Source Systems” menu option in the main window interface 1103. This option calls adapter program rhclsysform 1117. Then, highlighting a system on the screen and selecting the “Add System Field” option provided by rhclsysform 1117 will call rhsysfldaddform 1121. Adapter program rhsysfldaddform 1121 presents the user with a screen for entering a filed identifier, selecting a field type, and selecting a field format. The list of field type options is retrieved by obtaining all field type objects 1331 from the application. The field format options are retrieved in the same manner.

After this information is entered by the user and submitted, we begin our processing with step in 2401. Adapter program rhsysfldaddform 1121 checks the existence and length of the field identifier in 2402. If the provided field identifier is valid and the other information is set properly, in 2403, adapter program rhsysfldaddform 1121 calls rhsysfldform 1120. Receiving this call rhsysfldform 1120 retrieves the client object 1211 from the existing user session and using the client object's get system (getsys) method retrieves the system definition object 1301 for the selected system in 2405. If the information entered is not complete or correct, the caller is alerted and asked to fix the data provided in 2404. With the system definition object 1301, the adapter program calls the addsysfld method passing as parameters the field identifier, type, and format and other related information. Using the client identifier 1302 from system definition object 1301, the system identifier 1303 from system definition object 1301, and the information provided, the addsysfld method attempts to create a new system field object 1311, in 2406. If the provided field identifier is unique within the given system definition object's set of system field objects 1311 the system field object 1311 is created in 2407. If the field identifier is not unique or some other unforeseen error occurs the addition process is abandoned and the caller is notified in 2408. If the object creation is successful then client identifier 1312 will be set to client identifier 1302, system identifier 1313 will be set to system identifier 1303, field identifier 1314 will be set to the field identifier provided, field type 1315 will be set to the field type selected, and field format 1316 will be set to the selected field format.

During the creation process, all leading and trailing spaces are removed from the system identifier and field identifier in 2409. Once the object creation process is complete, the system creates a record for the object in table rhsysfld 2008 and returns the object to the calling adapter program rhsysfldform 1120. The adapter program then refreshes the user's screen and display the information entered in 2411.

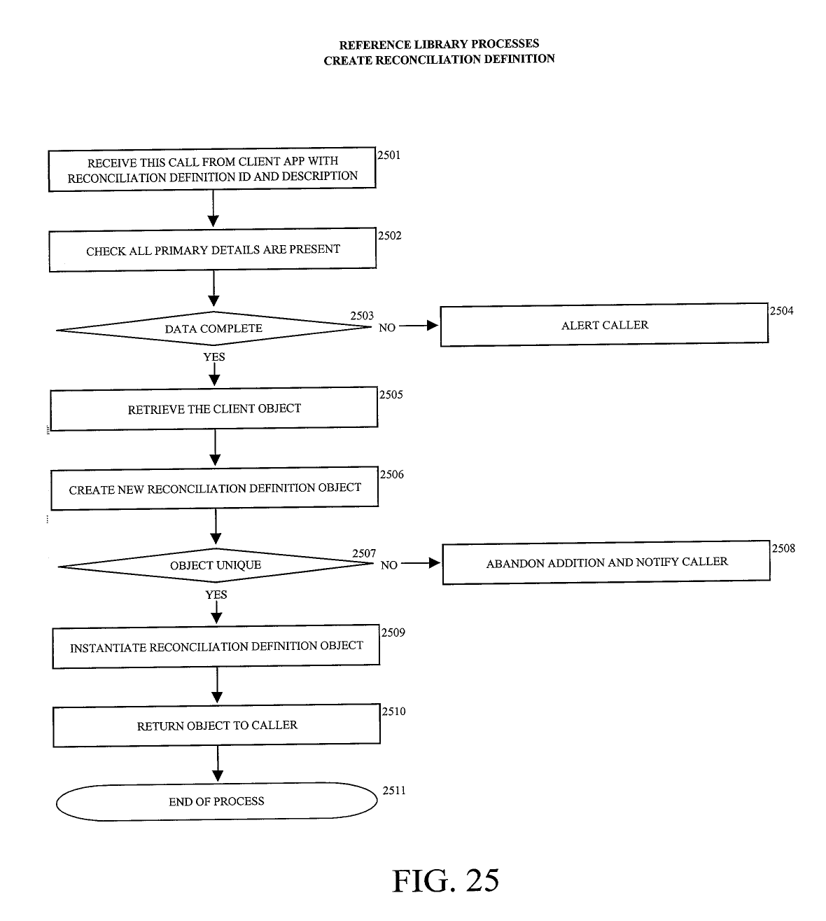

FIG. 25 shows the process to allow the user to create the individual reconciliation control objects for their organization. This is the first step in the process of structuring data controls that utilize the system and system filed information previously added to Reconciliation Manager.

The create reconciliation definition process in FIG. 25 begins with a user selecting the “Reference Library” menu option then selecting the “Reconciliations” menu option presented by the main window interface 1103. Making these selections will call adapter program rhclrecform 1122 and presents the user with an additional “Add Rec” menu option. On making this selection, rhclrecform 1122 calls rhrecaddform 1125 and the add reconciliation process begins. Adapter program rhrecaddform 1125 presents the user with a screen for entering a reconciliation identifier and a reconciliation description. After this information is entered by the user and submitted we begin our processing with step 2501. Adapter program rhrecaddform 1125 checks the existence and length of the reconciliation identifier and reconciliation description fields in 2502. If the information provided is valid, in 2503, adapter program rhaddrecform 1125 calls rhrecform 1124, which retrieves the client object 1211 from the existing user session in 2505. If the information entered is not complete or correct, the caller is alerted and asked to fix the data provided in 2504. With client object the adapter program then calls the client object's 1211 addrec method passing as parameters the reconciliation identifier and the reconciliation description. Using the client identifier 1212 from client object 1211 and the information provided, the addrec method attempts to create a new reconciliation definition object 1341, in 2506. If the provided reconciliation identifier is unique within the given client objects' existing set of reconciliation objects 1341, then the reconciliation definition object is created in 2507. However, if the reconciliation identifier is not unique or some other unforeseen error occurs, the addition process is abandoned and the caller is notified in 2508. If the object creation is successful, then client identifier 1342 will be set to client identifier 1212, reconciliation identifier 1343 will be set to the reconciliation identifier provided, reconciliation description 1343 will be set to the description provided. All other variables 1345 through 1356 will be set to either “0”, “null”, or “false”, depending on the data type of the individual fields. The setting provided on object creation for variables 1345 through 1356 are only temporary as the related values will be set/modify during later system processes. During this creation process, all leading and trailing spaces are removed from both the reconciliation identifier and reconciliation description in 2509.

Once the object creation process is complete, the system creates a record for the object in table rhrec 2102 and returns the object to the calling adapter program rhrecform 1124, in 2510. The adapter program then refreshes the user's screen and display the information entered in 2511.

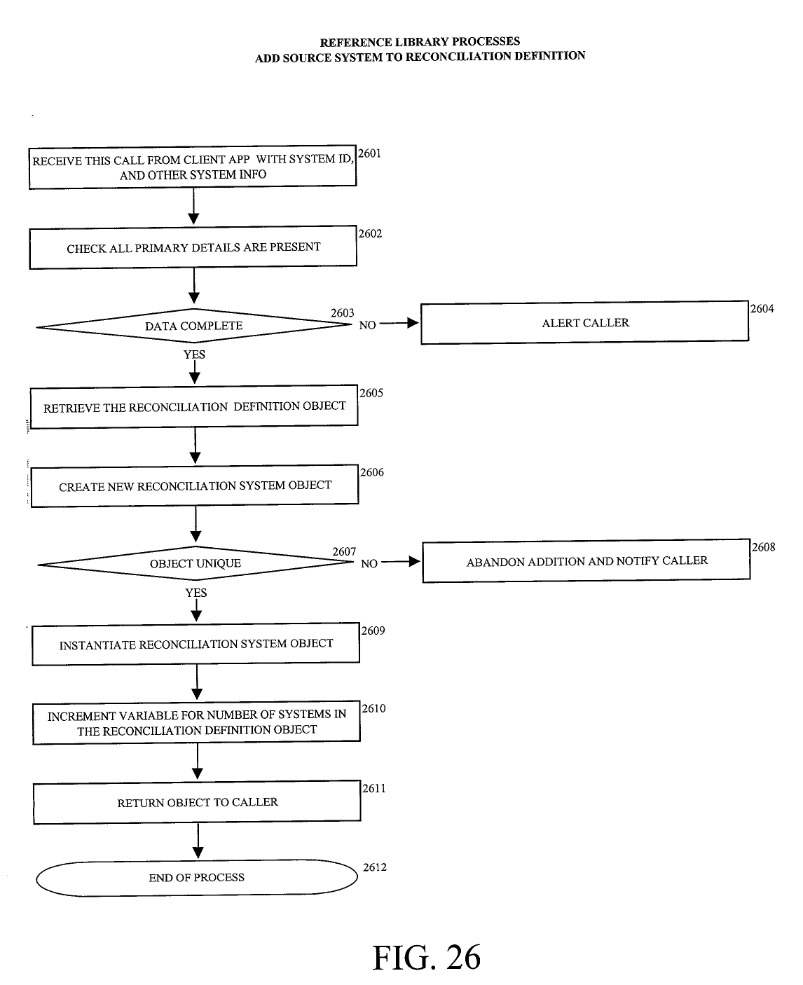

FIG. 26 illustrates the process where a user indicates which systems from their organization will participate and submit data for an individual reconciliation. The reconciliation manager supports many way (i.e., n-way) matching, allowing any number of systems to participate in a given reconciliation. A given system can also participate in any number of reconciliations. Also available is the option to specify if source data is retrieved and updated in the related data sources and corresponding tables and views directly.

The process begins with a user selecting the “Reference Library” menu option, then selecting the “Reconciliations” menu option, presented by the main window interface 1303. Making this selection calls adapter program rhclrecform 1122 which present the user with a second screen. On this second screen the user can highlight a reconciliation and select the “Add System” option, which calls rhrecsysaddform 1127 and begins the process.

Adapter program rhrecsysaddform 1127 presents the user with a screen for selecting a system identifier. The list of available systems is obtained by retrieving the client object 1211 from the existing user session and using the client object's list related systems (listsyss) method which returns all related system definition objects 1301 for the client object 1211. Some other options which determine how the application manages data integration and updating include (a) the ability to specify if data retrieval is done via a linked data source and if so an option to chose from among the set of data source identifiers for the system and specify a related table or view, and (b) the ability to indicate if data updates are done via a linked data source and if so an option to chose from among the set of data source identifiers for the system and specify a related table or view. After this information is provided and submitted by the user, the Reconciliation Manager begins processing the related information with step 2601. Adapter program rhrecsysaddform 1127 begins by checking that a system selection was made in 2602.

If the system identifier is selected and the other information is set properly, adapter program rhrecsysaddform 1127 calls rhrecsysform 1126 which retrieves the client object 1211 from the existing user session and using the client object's get reconciliation (getrec) method retrieves the reconciliation definition object 1341 for the selected reconciliation in 2605. If a system selection is not made, the caller is alerted and asked to correct the problem 2604.

Once the reconciliation definition object 1341 is obtained the adapter program begins by deriving the ignore case and ignore space setting from the information provided. The adapter program then calls reconciliation definition object's 1341 add reconciliation system (addrecsys) method passing as parameters the system identifier, ignore case, ignore space settings, and other related table and view information. Using the client identifier 1342 from reconciliation object 1341, the reconciliation identifier 1343 from reconciliation object 1341, and the system, ignore case, ignore space information, retrieval direct data link, retrieval direct source, retrieval direct data table, update direct data link, update direct source, update direct data table, this method attempts to create a new reconciliation system object 1371, in 2606.

If the provided system identifier is unique for the given reconciliation, then the reconciliation system object is created in 2607. If the system identifier is not unique or some other unforeseen error occurs, the addition process is abandoned and the caller is notified in 2608.

If the object creation is successful then client identifier 1372 will be set to client identifier 1342, reconciliation identifier 1373 will be set to reconciliation identifier 1343, system identifier 1374 will be set to the system identifier selected originating from the system definition object's system identifier field 1303, ignore character space (ignspace) 1375 will be set to the related derived value, and ignore character case (igncase) 1376 will be set the related derived value derived from user entered setting for the process. During this creation process, all leading and trailing spaces are removed from the client identifier, reconciliation identifier, system identifier and the data retrieval and update information will be set as indicated by the user in 2809.

Once the creation process is complete, the add reconciliation system (addrecsys) routine increments its number of system (noofsys) field 1345 by one. Then using the reconciliation data object's 1601 find by client identifier, reconciliation identifier (findbyclidrecid) routine, the process retrieves all reconciliation data object's 1601 for the client and reconciliation, in blocks of two thousand, and sets each of the objects number of system (noofsys) field 1607 equal to noofsys field 1345, in 2610.

Once this process is complete, the application creates a record for the new reconciliation system object 1371, in table rhrecsys 2009. Then, the object is returned to the calling adapter rhrecsysform 1126 2611, the user's screen is refreshed, display the information entered, and the process ends in 2612.

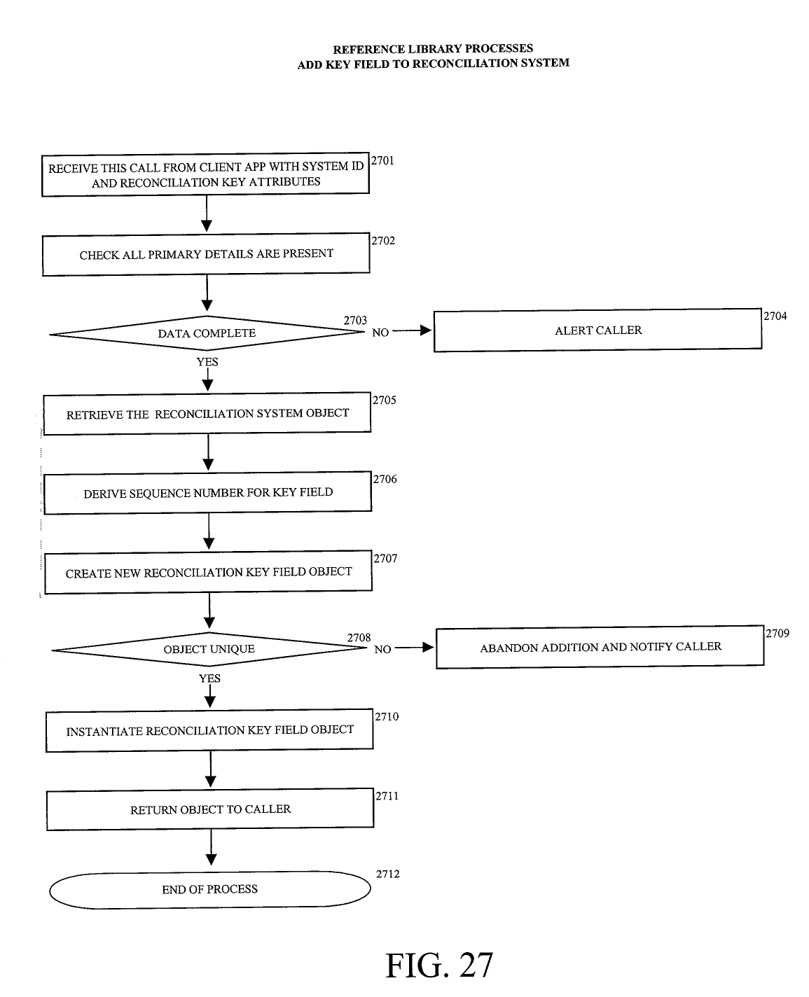

FIG. 27 illustrates the process to define a key structure for each system of a reconciliation. The key structure enables the Reconciliation Manager to create a match key string for data records as they arrive from the individual source systems of a reconciliation. These key strings are used to automatically group records together before they are passed on for reconciliation. A keys structure consists of a set of individual field ids from a particular system. These field identifiers are used to extract data from the systems records and concatenate this data into the match key string.

The add key field to reconciliation system process of FIG. 27 begins with a user selecting the “Reference Library” menu option and then the “Reconciliations” menu option presented by the main window interface 1103. This selection calls adapter program rhclrecform 1122 which presents the reconciliation configuration screen. Using this screen, the user selects the keys tab, a reconciliation, and a system. After making these selections, choosing the “Add Key Field” menu option will call adapter program rhreckeyaddform 1129.

Adapter program rhreckeyaddform 1129 presents the user with a screen for selecting a field identifier from the set of system field objects 1311 belonging to the selected system object 1301. This set of system field objects is obtained by retrieving the client object 1211 from the existing user session, and using the client object's get related systems (getsyss) method which returns the system definition object 1301 for the selected system. Then, using the system definition object's list related system fields (listsysflds) method, a list of system field objects 1311 is retrieved for the selected system. After a system field identifier is selected from this list and submitted we begin our process with step 2701. Adapter program rhreckeyaddform 1129 checks that a selection was made in 2702.

If the system field identifier is selected and the other information of the form is set properly adapter program rhreckeyaddform 1129 calls rhreckeyform 1128 which retrieves the client object 1211 from the existing user session, and using the client object's get reconciliation (getrec) method retrieves the reconciliation object 1341 for the selected reconciliation 2705. Then using the reconciliation object's get reconciliation system (getrecsys) method, the routine retrieves the reconciliation system object 3571 for the selected system 2705. If a system field identifier selection is not made, the caller is alerted and asked to correct the problem in 2704.

Using the reconciliation system object's 1371 add reconciliation system key field (addrecsyskeyfld) method, the rhreckeyform adapter program 1128 begins the reconciliation key field creation process. In calling this method, the field identifier and field type are passed as parameters. This method begins by deriving the next available key position value from the set of existing reconciliation key field objects 1381 belonging to the selected reconciliation system object 1371, in 2706. This value will be set as one more than the highest existing value.

Using the derived key position, client identifier 1372, reconciliation identifier 1373, system identifier 1374, and the selected field identifier and field type, which originate from a field identifier 1314 and a field type 1315, the method attempts to create a new reconciliation key field object 1381, in 2707.

If the field identifier is unique within the given reconciliation system object's 1371 child reconciliation system key field objects 1381, then the reconciliation key field object 1381 is created, in 2708. If the field identifier is not unique or some other unforeseen error occurs, the addition process is abandoned and the call is notified 2709.

If the object creation is successful, client identifier 1382 will be set to client identifier 1372, reconciliation identifier 1383 will be set to reconciliation identifier 1373, system identifier 1384 will be set to system identifier 1374, field identifier 1385 will be set to the selected field identifier 1314, key position (keypos) 1386 will be set to the derived key position, and field type (fldType) 1387 is set to the field type 1315 of the selected system field object 1311. The key position filed is used during processing to maintain the order of the reconciliation key field objects in the ordered they were entered. The field type is replicated and inherited from a related value in-order to make the data type information readily available during later processing. During this creation process all leading and trailing spaces are removed from the client identifier, reconciliation identifier, and system identifier in 2710.

Once the creation process is complete, the system creates a record for the object in table rhrecsyskeyfld 2011 and returns the object to the calling adapter program rhreckeyform 1128 in 2711. The adapter program then refreshes the user's screen and display the information entered and the process ends in 2712.

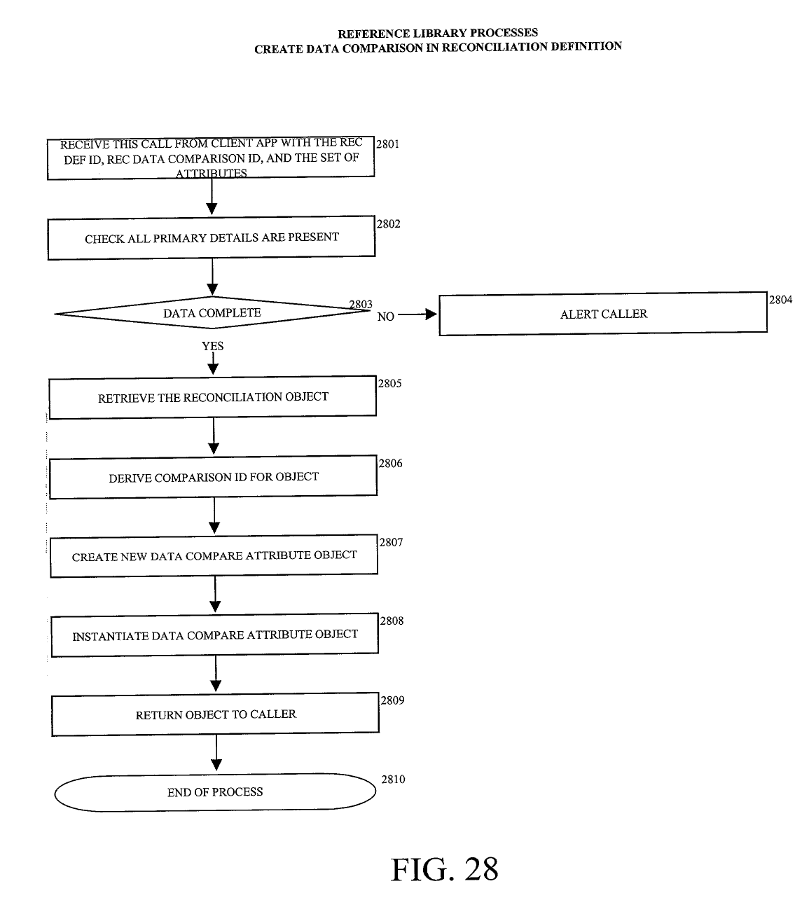

FIG. 28 shows the process to create and configure the individual data comparisons of a given reconciliation. In general, there should be one comparison created for each set of fields the user wants to compare between the different systems of the given reconciliation.

The create data comparison in reconciliation definition process of FIG. 28 begins with a user selecting the “Reference Library” menu option and then the “Reconciliations” menu option presented by the main window interface 1103. This selection calls adapter program rhclrecform 1122, which presents the reconciliation configuration screen. Using this screen the user selects the data tab and a reconciliation. After making these selections and choosing the “Add Compare” menu option adapter program rhrecdatcmpform 1131 is called.

Adapter program rhrecdatcmpform 1131 presents the user with a screen for specifying, and selecting, a range of details which control the operation of the individual data comparison. The screen provides the ability to enter a description, select a data type (such as string, number, or date), and indicate settings that govern the treatment of case and spaces for the comparison. In presenting this interface the adapter program retrieves the client object 1211 from the existing user session and uses the client object's get reconciliation (getrec) method to return the reconciliation object 1341 for the selected reconciliation. Then, using the reconciliation object's list reconciliation system (listrecsyss) method a list of related reconciliation system objects 1371 is retrieved for the reconciliation object 1341. Other objects also retrieved include the full set of system field type objects 1331, the full set of comparison type objects 1421, and the full set of tolerance type objects 1431. Each of these data sets is presented to the user as a list of possible selections. Once the user completes the required information and submits the form for processing, the primary details of description, primary system, data type, comparison type, tolerance type, and tolerance amount are validated in 2802.

If the required information is set properly in 2803, the adapter program rhrecdatcmpform 1131 calls rhrecdatform 1130 which retrieves the client object 1211 from the existing user session and uses client object's get reconciliation (getrec) method to retrieve the reconciliation object 1341 for the selected reconciliation in 2805. The adapter program then converts the type of the ignore space and ignore case parameters from strings into related boolean values.

After obtaining the reconciliation object 1341, the program then uses the addreccmpatrib method to begin the processes of creating a data compare attribute object 1401. This method call takes description, comparison type, primary system, tolerance type, tolerance amount, ignore space, and ignore case variables as parameters. The method begins the comparison creation process by deriving the next available comparison identifier value from the set of existing data compare attribute objects 1401 belonging to the reconciliation object 1341. This value is set at one more than the highest existing comparison identifier value in 2806.

Using the client identifier 1342, the reconciliation identifier 1343, the derived comparison identifier, the description, the comparison type, the primary system, the tolerance type, the tolerance amount, the data type and the ignore case and space settings, the addreccmpatrib method attempts to create a new data compare attribute object 1401, in 2807. On creation, the object is instantiated in 2808 and the client identifier 1402 is set to client identifier 1342, reconciliation identifier 1403 is set to reconciliation identifier 1343, compare identifier 1404 is set to the derived comparison identifier, and the comparison description (cmpdesc) 1405, comparison data type (cmpdattype) 1406, the comparison's ignore character space setting (ignspace) 1407, the comparison's ignore character case setting (igncase) 1408, comparison type (cmpcmptype) 1409, the primary system identified (cmpprmsysid) 1410, tolerance processing type (cmptolprctype) 1411, tolerance amount (cmptolamnt) 1412 is each set to their related selected values.

Once the creation process is complete, the system creates a record for the object in table rhreccmpatrib 2104 and returns the object to the calling adapter program rhrecdatform 1130, in 2809. The adapter program ends the process in 2810 and refreshes the user's screen and display the information entered.

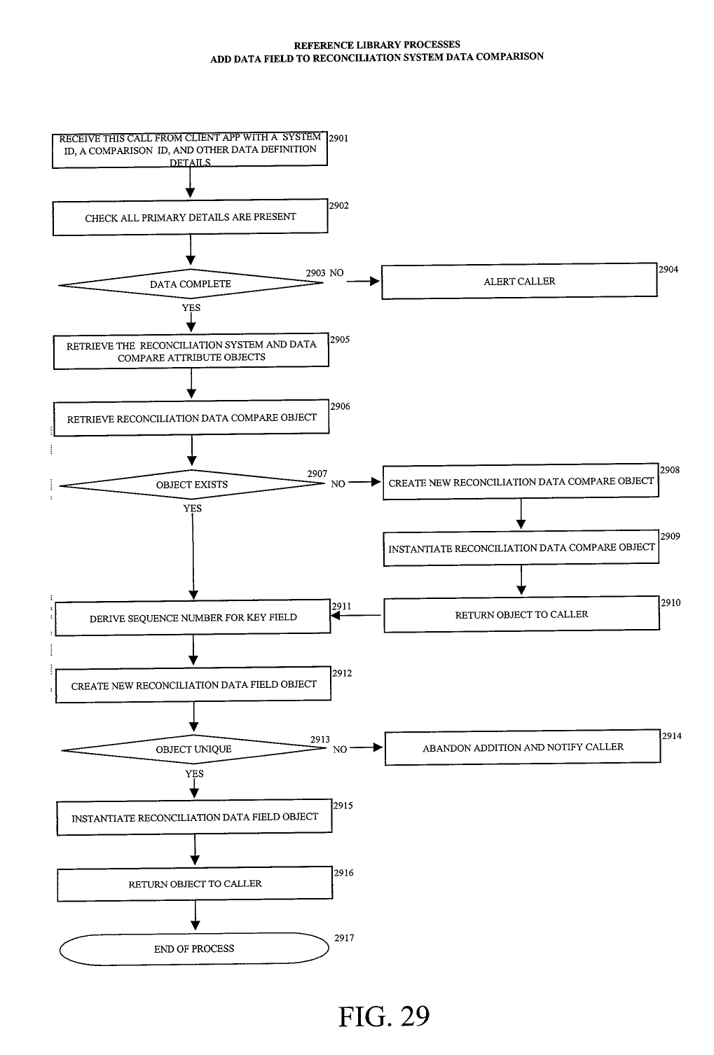

FIG. 29 shows the process for specifying the individual data fields from each system definition object 1301 which are used to create an individual comparison value for each of the individual system's of a particular comparison and reconciliation.

The add data field to reconciliation system data comparison process of FIG. 29 begins with a user selecting the “Reference Library” menu option and then selecting the “Reconciliations” menu option presented by adapter program the main window interface 1103. Making this selection calls adapter program rhclrecform 1122 and presents the reconciliation configuration screen. If the user selects the data tab, highlights a reconciliation, a comparison identifier, and a system, then, selects the “Add Data Field” option, the rhrecdatfldaddform 1132 is called.

Adapter program rhrecdatfldaddform 1132 presents the user with a screen for selecting a field identifier from the set of system field objects 1311 belonging to the selected system definition 1301. This list of fields is obtained by retrieving client object 1211 from the existing user session and using the client object's get system (getsys) method to return the system definition object 1301 for the selected system identifier. Then, using the client object's get reconconciliation (getrec) method the reconciliation object 1341 is obtained and, using the reconciliation object's get reconciliation comparison attribute (getreccmpatrib) method the data compare attribute object 1401 is retrieved. Then, using the selected system definition object's 1301 list system fields by field type (listsysfldsbyfldtype) method and the data compare attribute object's comparison data type (cmpdattype) field 1406, as a parameter, a list of system field objects 1311 of the appropriate data type is retrieved. Other options included on this screen include the ability to specify how fields from the same system of a comparison should be combined. By select a field for addition and submitting the information, the user beginning process in 2901. Adapter program rhrecdatfldaddform 1132 then checks the selection.

If the information is not set properly in 2903 the caller is alerted in 2904. Otherwise the information is set correctly in 2903 and rhrecdatfldaddform 1132 calls the rhrecdatform 1130 with the related data. Receiving this call rhrecdatform 1130 retrieves the client object 1211 from the existing user session and uses this object's get reconciliation (getrec) method to retrieve the reconciliation object 1341 for the selected reconciliation. Then, using the reconciliation object's get reconciliation comparison attribute (getreccmpatrib) method and the get reconciliation system (getrecsys) method, the appropriate data compare attribute object 1401 and reconciliation system object 1371 are retrieved in 2905. Then, the reconciliation system object's get reconciliation system data comparison (getrecsysdatcomp) method is used to find the reconciliation system data compare object 1441 for the compare identifier retrieved from compare identifier 1404, in 2906.

If the reconciliation system data compare object does not exist, in step 2907, a new data compare object 1441 is created in 2908 using the reconciliation system's 1371 add reconciliation system data comparison (addrecsysdatcomp) method. The parameters passed to this routine are comparison identifier 1404, the selected comparison operator (cmpoprt) which derives from the set of reconciliation comparison operator objects 1461, the comparison data type (cmpdattype) 1406, and the ignore character space (ignspace) 1407. On creation the client identifier 1442 will be set to client identifier 1372, reconciliation identifier 1443 will be set to reconciliation identifier 1373, system identifier 1444 will be set to system identifier 1374, compare identifier 1445 will be set to compare identifier 1404, ignore character space 1446 will be set to ignore character space 1407, compare data type (CmpDatType) 1447 will be set to compare data type (cmpdattype) 1406, and comparison operator (cmpoprt) 1448 will be set to the selected compare operator (cmpoprt) 1462 in 2909. Then, a record for this object is created in table rhrecsysdatcomp 2015 and the object is returned to process 2911 in 2910. If the reconciliation data compare object existed previously 2906 this set of processes 2908, 2909, and 2910 would be skipped and the application processing goes directly from step 2907 to 2911.

After obtaining or creating the reconciliation system data compare object 1441, the system uses the add reconciliation system data field (addrecsysdatfld) method to begin the reconciliation data field object's 1471 creation process. Field identifier and field type are passed as parameters to this method call. This process begins with the system deriving the next available data position value from the set of existing reconciliation data field objects belonging to the reconciliation system data comparison in 2911. This value will be set as one more than the highest existing data position value.

Using the derived data position, client identifier 1442, reconciliation identifier 1443, system identifier 1444, compare identifier 1445, and the selected field identifier and field type, which originate from a field identifier 1314 and a comparison data type (cmpdattype) 1406, the method attempts to create a new reconciliation data field object 1471, in 2912.

In 2913, if the object is unique and the creation process is successful, the object is instantiated and client identifier 1472 is set to client identifier 1442, reconciliation identifier 1473 is set to reconciliation identifier 1443, system identifier 1474 is set to system identifier 1444, compare identifier 1475 is set to compare identifier 1445, field identifier 1476 is set to the selected field identifier, data position (datpos) 1477 will be set to the derived data position, and field type (fldtype) 1478 will be set to compare data type (cmpdattype) 1406. After setting these variables, a record is created for the object in table rhrecsysdatfld 2014. If the field identifier is not unique or some other unforeseen error occurs, the addition process is abandoned and the caller is notified in 2914.

The system then returns the object to the calling adapter program rhrecdatform 1130, in 2916, which ends the process in 2917 and refreshes the user's screen displaying the information entered.

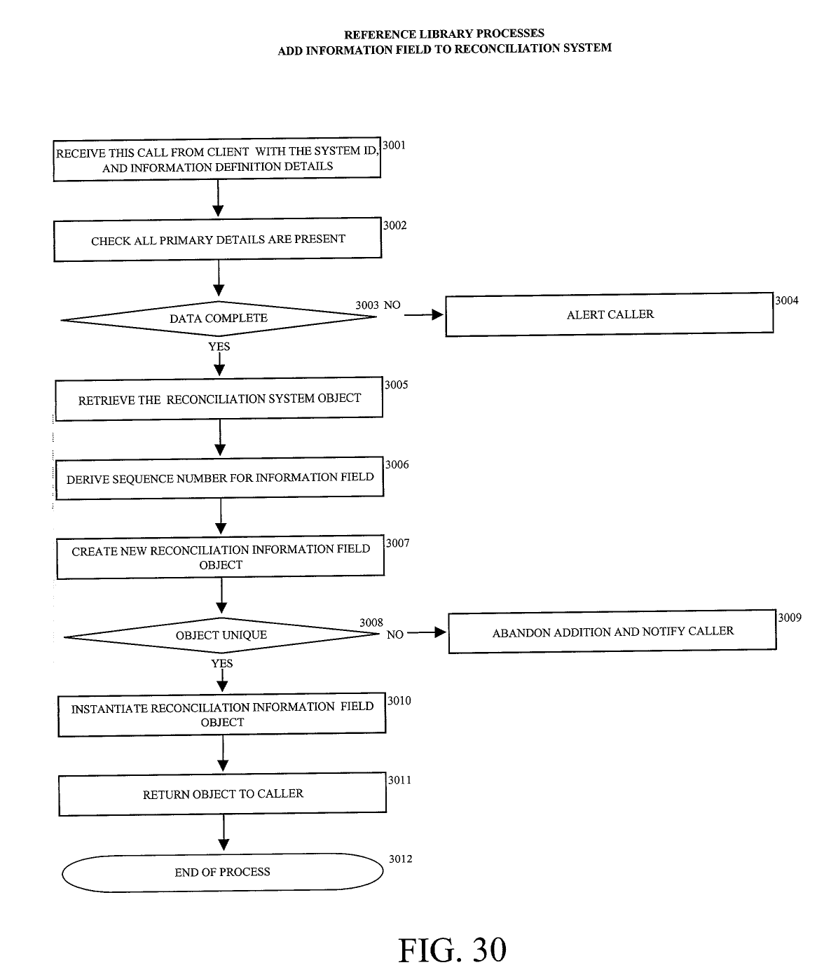

FIG. 30 shows the option to configure the reconciliation manager such that information fields can be attached to the individual data records from each system of a reconciliation. These information fields are used to allow information to flow back to the individual source systems and their related data records by identifying these records within a source system's data set. This option enables the reconciliation manager to automate the process or returning and applying reconciliation correction and status information in related source systems.

The add information field to reconciliation system process of FIG. 30 begins with a user selecting the “Reference Library” menu option and then selecting the “Reconciliations” menu option presented by the main window interface 1103. This selection calls adapter program rhclrecform 1122 presenting the reconciliation configuration screen. By select the information tab, highlighting a reconciliation and a system on the screen, and choosing the “Add Information Field” option, the user causes the system to call rhrecinfaddform 1134.

Adapter program rhrecinfaddform 1134 presents the user with a screen for selecting a field identifier from the set of system filed objects 1311 belonging to the highlighted system definition object 1301. The field list is obtained by retrieving the client object 1211 from the existing user session and using the client object's get system (getsys) method to return the system definition object 1301 for the selected system. Then, using the system object's list system fields (listsysflds) method, a set of system field objects 1311 belonging to the selected system definition object 1301 is retrieved. After a system field identifier is selected from the set and submitted we begin our process with step 3001. Adapter program rhrecinfaddform 1134 checks that the selection was made in 3002.

If the field identifier is selected and the other information of the form is set properly, adapter program rhrecinfaddform 1134 calls rhrecinfform 1133 which retrieves the client object 1211 from the existing user session and uses the client object's get reconciliation (getrec) method to retrieve the reconciliation object 1341 for the selected reconciliation. Then, using the reconciliation object's get reconciliation system (getrecsys) method, the process retrieves the reconciliation system object 1371 for the selected system in 3005. If a field identifier selection is not made the caller is alerted and asked to correct the problem in 3004.

Using the reconciliation system object's 1371 add reconciliation system information filed (addrecsysinffld) method the rhrecinfform adapter program 1133 begins the reconciliation information field creation process. In calling this method, the field identifier and field type are passed as parameters. This method begins by deriving the next available information position value from the set of existing reconciliation information field objects 1501 belonging to the reconciliation system 1371, in 3006. This value will be set as one more than the highest existing information position value 1506.

Using the derived information position, client identifier 1372, reconciliation identifier 1373, system identifier 1374, and the selected field identifier and field type, which originate from a field identifier 1314 and a field type (fldtype) 1315, the method attempts to create a new reconciliation information field object 1501, in 3007.

If the field identifier does not exist in the given reconciliation system object's 1371 reconciliation information field objects 1501 then the reconciliation information field object 1501 is created, in 3008. If the field identifier is not unique or some other unforeseen error occurs, the addition process is abandoned and the caller is notified in 3009.

If the object creation is successful the object is instantiated and client identifier 1502 is set to client identifier 1372, reconciliation identifier 1503 is set to reconciliation identifier 1373, system identifier 1504 is set to system identifier 1374, field identifier 1505 is set to the selected field identifier, information position (infpos) 1506 is set to the derived information position, and field type (fldtype) 1507 is set to the field type of the selected system field object 1311. During this creation process all leading and trailing spaces are removed from each of the applicable string fields in 3010.

Once the creation process is complete, the application creates a record for the object in table rhrecsysinffld 2013 and return the object to the calling adapter program rhrecinfform 1133, in 3011. The adapter program then ends the process in 3012 and refreshes the users screen displaying the information entered.

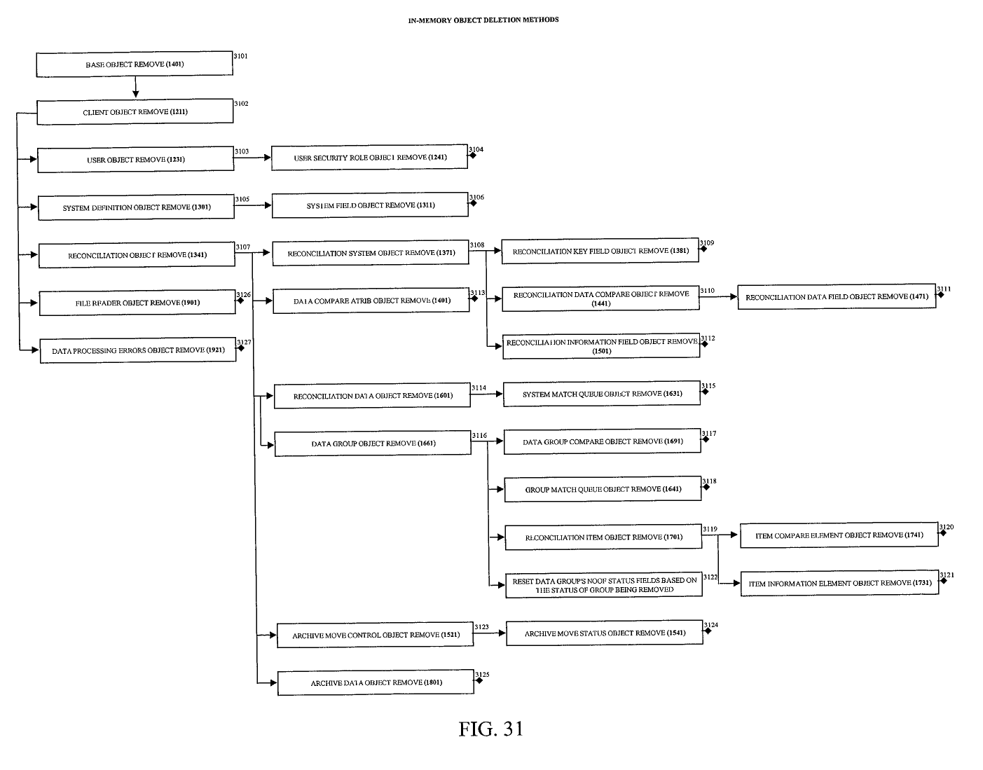

The reconciliation manager supports a series of automated object deletion and cleanup routines as depicted in FIG. 31. In general, these routines are structured to preserve the parent-child relations of the objects. For example, according to one embodiment, if a user were to attempt the deletion of a user object 1231, in 3103, the application would first retrieve and delete all related user security role objects 1241, in 3104, and then, delete itself.

All reference library objects support deletion through the user interface. Access to these deletion facilities is provided through object deletion menus, which are located with, and work in the same way as, their object's corresponding addition menus described earlier. In the application's deletion process of the system definition object 1301 and the system field object 1311 in 3105-3106, the application can potentially prevent the deletion of related objects, which will cause an alert to be generated back to the application's user interface notifying the user of the failed deletion. The deletion will fail in the case where the object being deleted is currently used in any of the application's reconciliation objects 1341. In the case of the system definition object 1301 this would occur if the client identifier 1302 and system identifier 1303 values are used in any of the application's reconciliation system object's 1371 client identifier 1372 and system identifier 1374. In the case of the system field object 1311 an error would occur if the system field object 1311 being deleted has its client identifier 1312, system identifier 1313, and field identifier 1314 used in any of the reconciliation's key field objects 1381, client identifier 1382, system identifier 1384, and field identifier 1385, or reconciliation data field objects 1471, client identifier 1472, system identifier 1474, and field identifier 1476, or reconciliation information field objects 1501, client identifier 1502, system identifier 1504, and field identifier 1505.

These deletion routines are accessed from a variety of other processes in the application, which are described below. In most cases, the routines work similar to the prior example in which the deletion of a parent object causes the deletion of its related child objects. However, the reset data group's set number of status fields process 3122 is unique and is of particular interest. This process 3122 is used to update the data group counter fields 1610-1617 of the parent reconciliation data object 1601. These updates are made as each data group object 1661 is removed from the system. The update process 3122 will decrement the appropriate status fields in the appropriate reconciliation data object 1601 based on the value of data group status (grpstat) 1669 in the data group object 1661 being removed. As part of this process, the reconciliation data object 1601 is retrieved using its primary key and the client identifier 1662, reconciliation identifier 1663, and key identifier 1664 values of the data group object 1661.

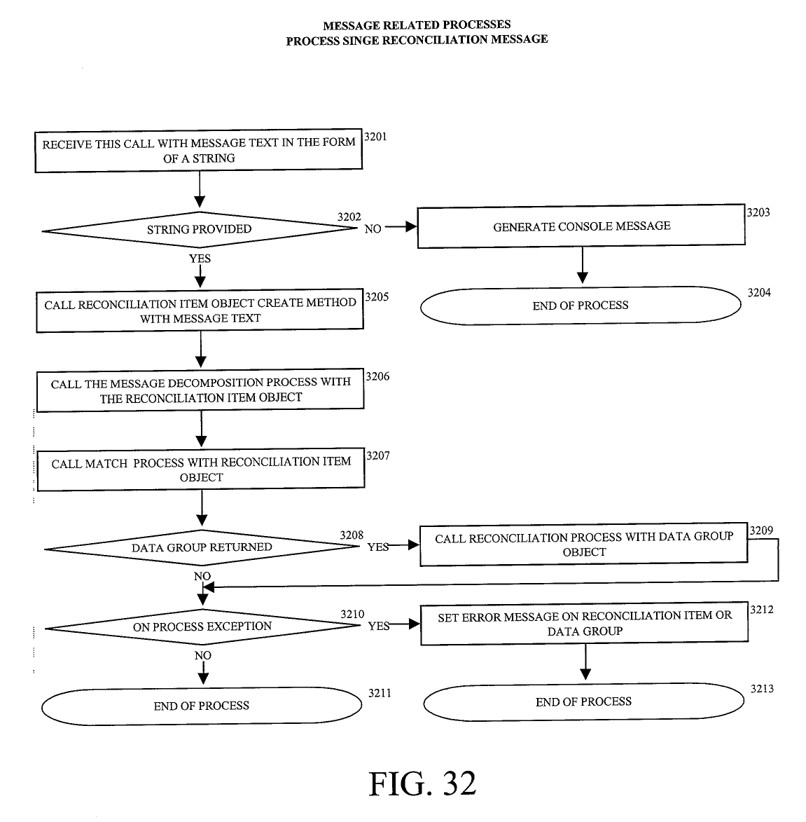

FIG. 32 describes the main control program for processing a reconciliation message. A reconciliation message is a text string containing a record of data from a particular source system which requires processing in the application. The application accepts these reconciliation messages from defined source system's on a per-reconciliation basis. These messages must be in the agreed format and must contain header fields identifying the source system and the reconciliation of the particular reconciliation message. The application provides a variety of options for interfacing with the message processor of FIG. 32, which are described below.

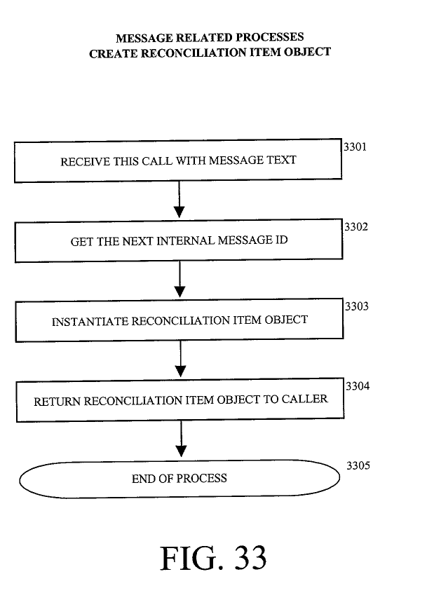

The single reconciliation message process of FIG. 32 begins with one of the calling methods initiating this process with a reconciliation message as a parameter in the form of a string in 3201. On receiving this call, the process checks that the message string is not empty in 3202. If the reconciliation message is empty, an alert message is printed on the server console in 3203 and the process ends in 3204, otherwise the processing continues with a call to create a new reconciliation item object in 3205 described in FIG. 33. The create reconciliation item process either returns a valid reconciliation item object 1701 or throws an exception. In the case of an exception being generated, this is handled in step 3210 which is described later and is used to manage all exceptions received by the single reconciliation message process.

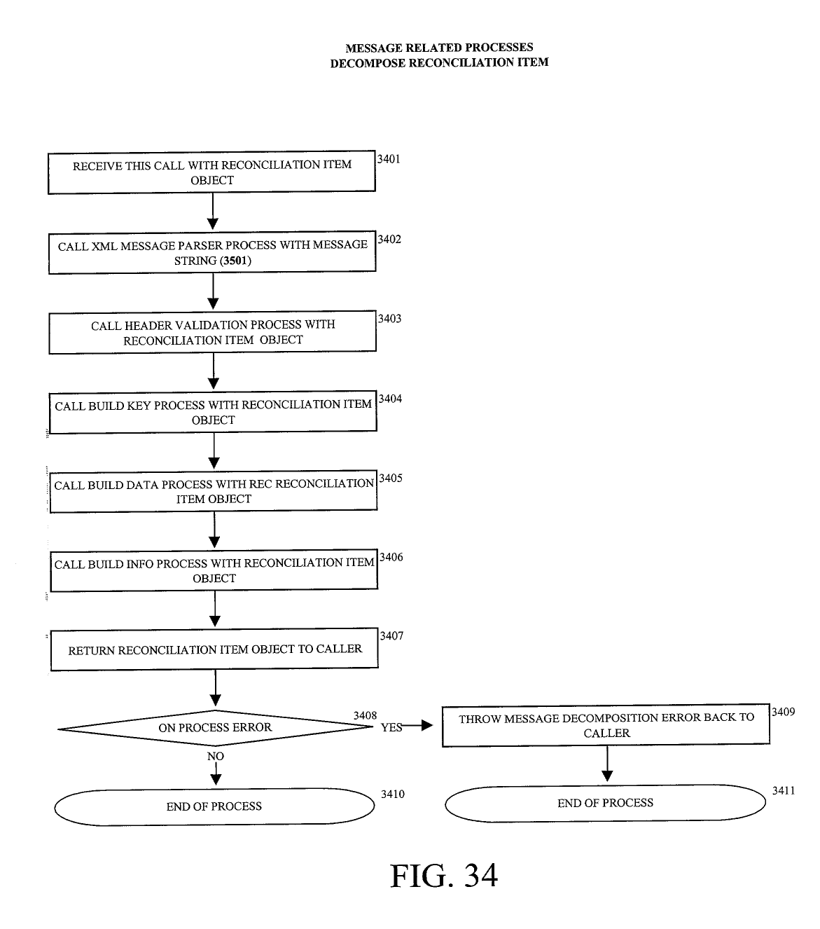

If the processes of step 3205 is successful, the program then passes the returned reconciliation item object 1701 on for decomposition in 3206. The decomposition process breaks down the text based XML message structure and generates a set of data related objects which are utilized in further processes. The decomposition process and these data related objects are described along with FIG. 34. If the decomposition process generates an exception, we move to step 3210; else, we continue with our processing.

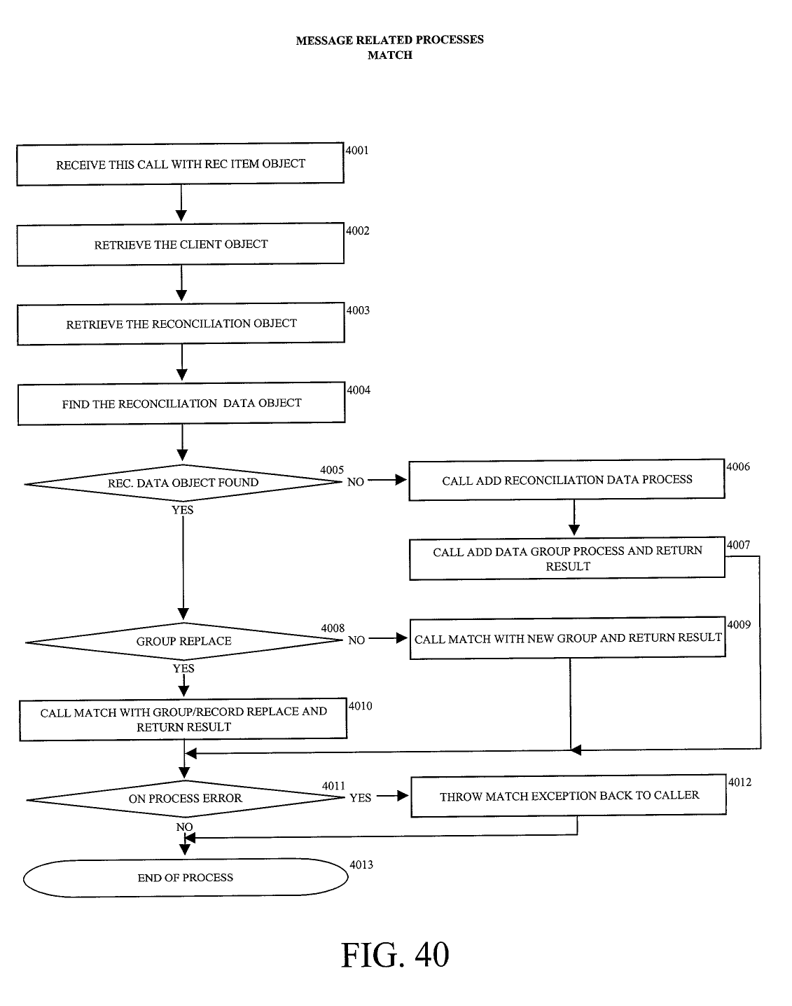

After receiving a decomposed reconciliation item 1701 back from process of FIG. 34, the program calls the match process with the reconciliation item 3207. The match process will place the reconciliation item in the appropriate data group 1661 based on the combination of match key value 1710, system identifier 1707, and reconciliation identifier 1708. This process is detailed and described beginning in FIG. 40. If this match process 3207 completes and returns a data group object 1661 then two events have occured. First, the reconciliation item must be part of a data group that is completely matched (i.e., contains one reconciliation item 1701 from each of the systems contained in the reconciliation), and is ready to have its data elements reconciled. Second, the particular reconciliation object 1341 for this reconciliation item 1701 must have is reconcile data group real time flag (recrealtime) 1350 set to true. This option for supporting the real-time reconciliation of data groups is a critical feature and allows Reconciliation Manager to generate real-time notification messages back to individual users or systems as data breaks are found between the data records submitted for processing.

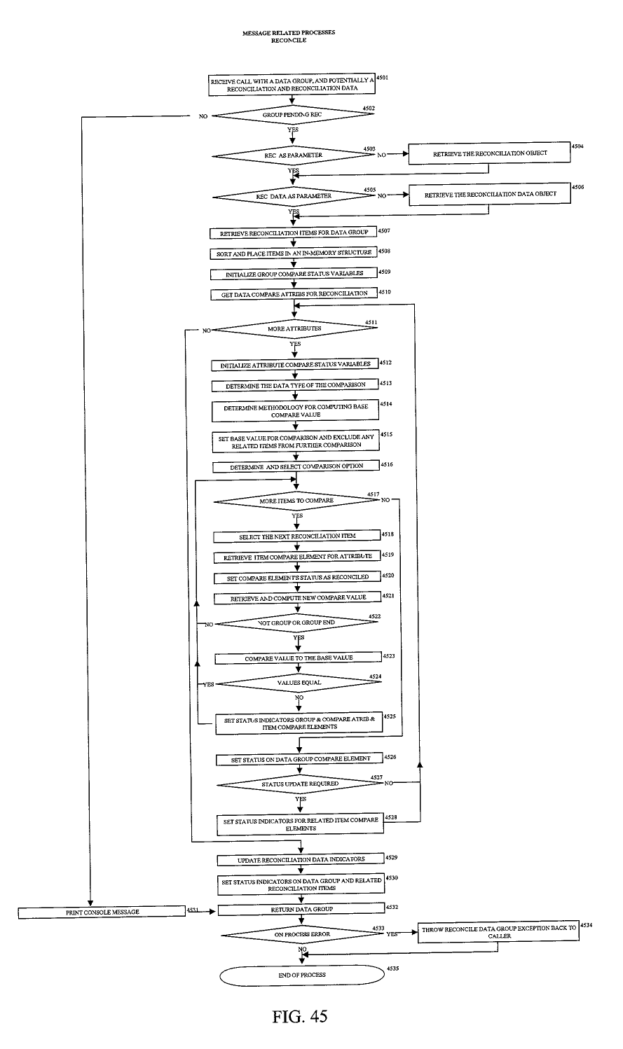

On receiving a data group 1661 back from the match process, the application will make a call to the reconciliation process described in FIG. 45. This reconciliation process of FIG. 45 goes through each of individual comparisons constructed for the reconciliation and compares the data elements from each of the individual system. This process of FIG. 45 results in a detailed analysis and understanding of which of the data elements provided from each system in the particular data group is potentially in error. If no data group 1661 is returned then the process ends in 3211.

The error management process for this routine is exception based and will respond to exceptions generated by any of the routines which the process calls in steps 3210, 3212. During the process if any errors are generated, they are handled by the error management process. Any exceptions in the reconciliation process may result in the data group 1661 having its error field 1672 set to true and its error message field 1673 set to the text of the individual message. Any errors generated from the other related processes results in the reconciliation item 1701 having its group identifier 1711, absolute data group identifier 1717, item status 1712 set to a negative one. Its has error indicator 1715 will be set to true and its error message 1716 will be set to the text of the individual message. In certain cases, this error process returns an exception to the process that initiated this process single reconciliation message process of FIG. 32.

FIG. 33 details the create reconciliation item object process. This process will set the primary details of the reconciliation item based on the text message it receives as a parameter to the call 3301. The first step in the process is to determine the sequence number for the new reconciliation item object 1701 in 3302. This is done using the sequence generation object 1951 with a key value of “itemid”. Using this key value and calling the object's get sequence number (getseqnumber) routine increments the sequence number in the object by one and then returns the starting sequence number which is used on the new reconciliation item. The process of FIG. 33 sets item identifier 1702 to the returned sequence number, item 1703 to the message text, system date 1705 to the current date of the application's server, and the absolute data group identifier 1717 to −1 (i.e., negative one). All other field values for the object are set to either zero or null and will be set and utilized by other processes in 3303. The new reconciliation item object 1701 is returned in 3304 and the process ends in 3305.

FIG. 34 details the message decomposition process. This process is an overall control process which prepares the individual reconciliation item 1701 for matching and reconciliation. This process uses a number of sub processes to extract header details, create a match key string, create the items data elements, and create the item's information elements.

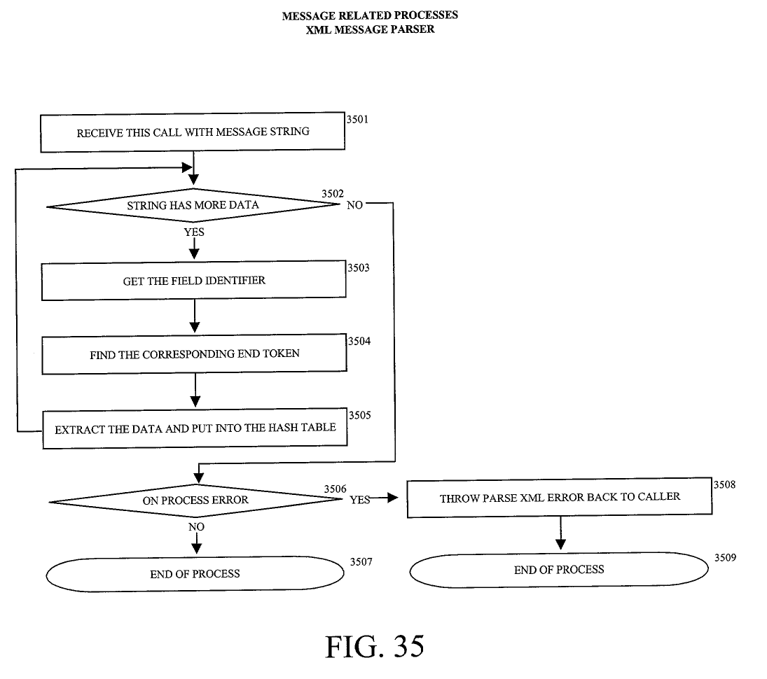

After receiving a call with the reconciliation item 1701 as the parameter, in 3401, the process calls the XML message parser process, in step 3402, which is described in FIG. 35. On completion of the message parsing process, there resides in the control processes local memory a hash table containing all of the messages fields and individual vales obtained from the original text message of field 1703. The in-memory message field identifiers and values are used to support the subsequent decomposition processes.

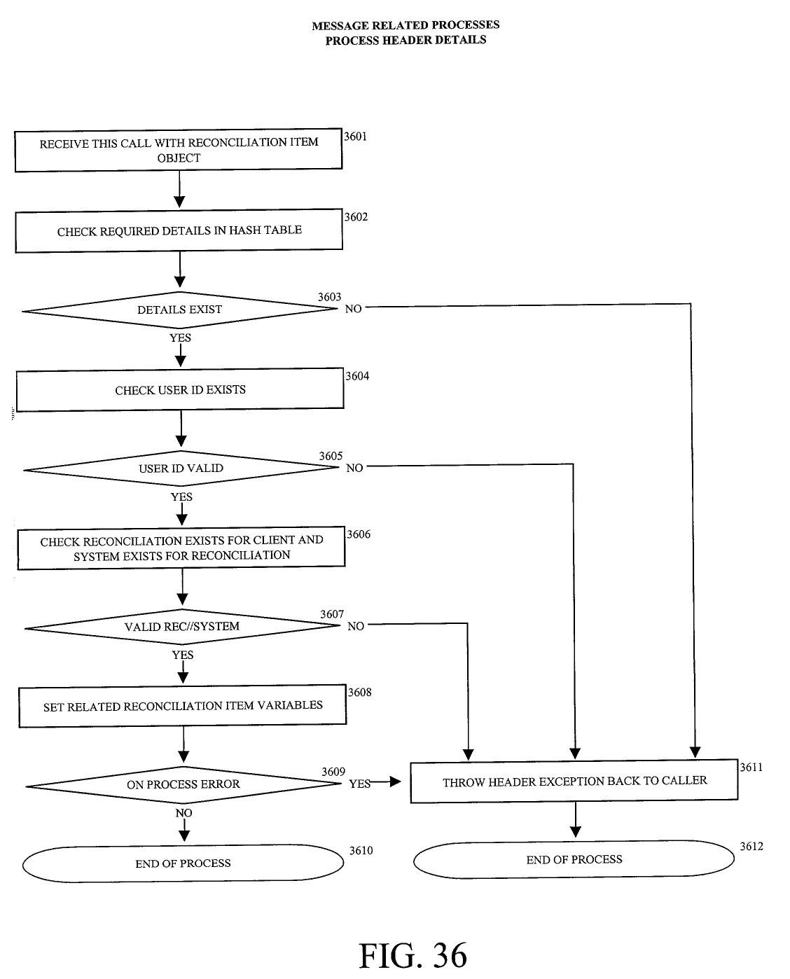

Then the header validation process is called in step 3403. This process identifier detailed in FIG. 36. The processes primary task is to extract and check the primary details of user identifier, system identifier, and reconciliation identifier from the message string provided. These details are then used to map the reconciliation item 1701 back to the individual components of the applications reference library, which guide the remaining decomposition processes.

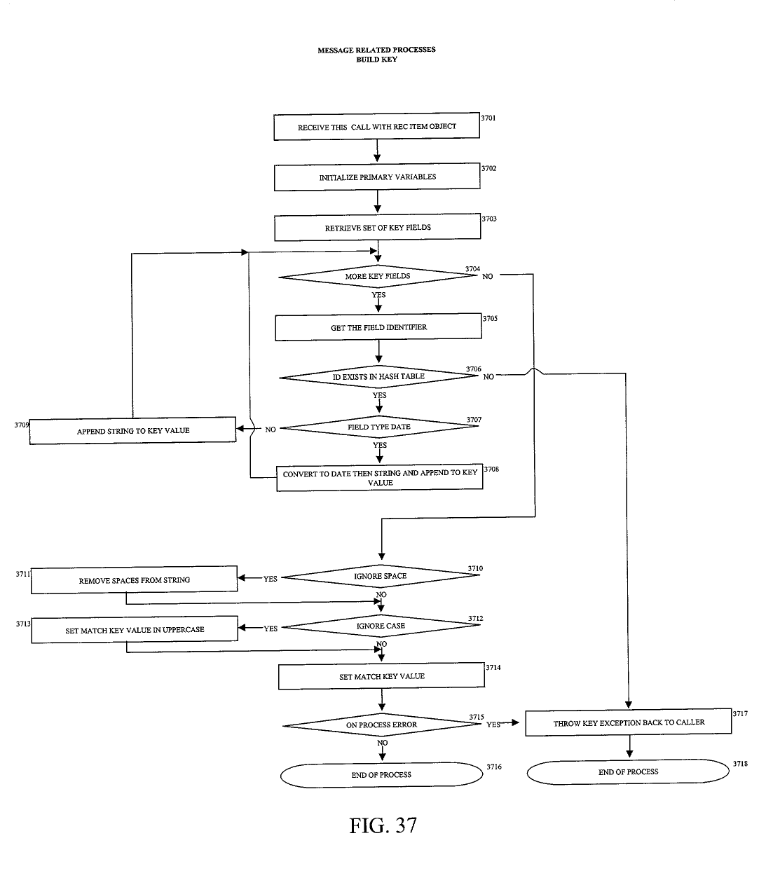

Then, the build key process is used to construct a match key value 1710 for the reconciliation item object 1701 in 3604. The build key process is described in FIG. 37. The resulting match key value is used in later processes to determine which data group object 1661 this item belongs to.

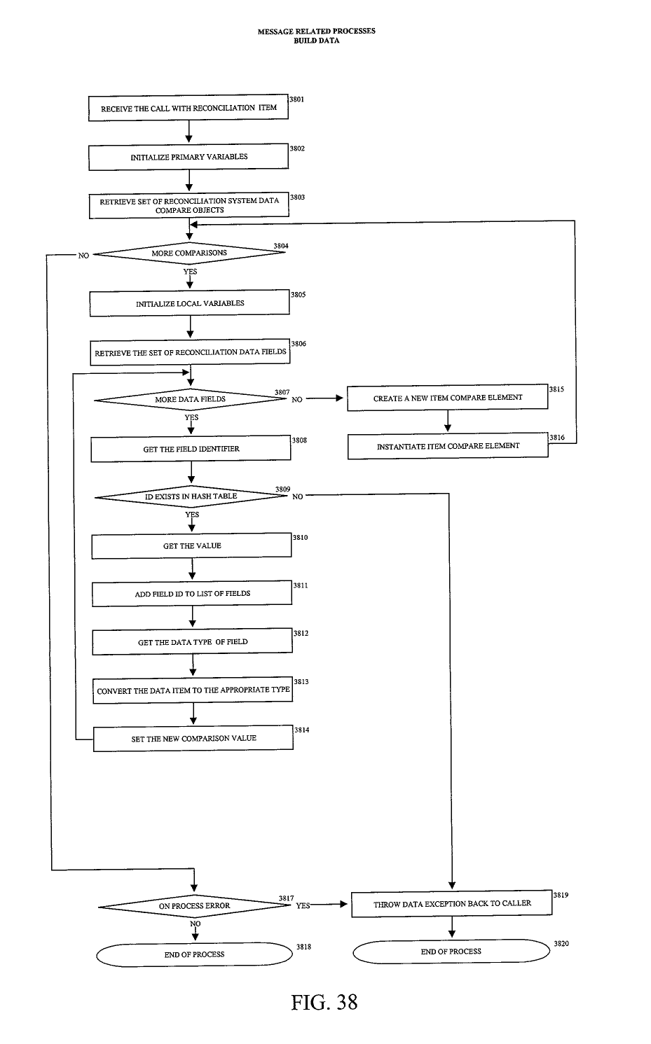

After the match key creation, the message decomposition process calls the build data process in 3405. This build data process is detailed in FIG. 38. The overall purpose of the build data process is to use the comparison information defined in the reconciliation for the particular system to create a set of individual item compare elements 1741. These item compare elements will then be used in the message reconciliation and reporting process.

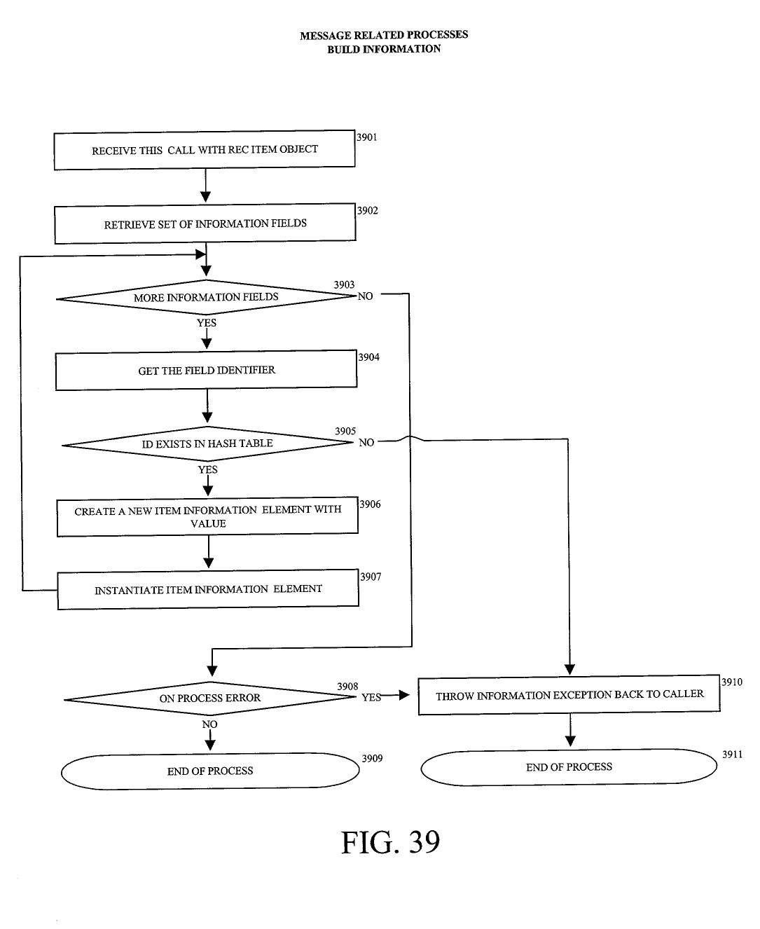

Then, the build information process is called in 3406. This build information process is detailed in FIG. 39. The purpose of the build information process is to create the individual item information element objects 1731 for the reconciliation item and the defined reconciliation, reconciliation system pair of the reference library.

Once the set of processes is complete, the reconciliation item 1701 is returned to the calling process in 3407 and the decomposition process ends in 3410. If, however, any processing error is generated during this decomposition process the routine jumps to step 3408 and then 3409. In this error case, any subsequent process after the process that generated the error is not called, and a reconciliation item object is not returned to the caller. Regardless of the error type, the application will return a detailed decomposition exception back to the calling process in 3609 and end the process in 3611.

FIG. 35 describes the XML message parsing process. This process takes as input an XML based message string and decomposes the string putting the results into a shared in memory hash table which is used by the other decomposition processes to retrieve and process individual message's data elements.

The process begins on receipt of the call in 3501 and continues to iterate through steps 3503 through 3505 until the entire message has been processed in 3502. The process works by searching the given string sequentially for the start of a field token i.e. “<” followed by “>”, in 3503, in this process any text between these symbols is taken as the token identifier such that a sample of a complete starting token could look like “<System identifier>”. Then, the process continues searching sequentially for the corresponding end token, such as “</System identifier>” in 3504. The process then extracts the portion of the string stored between the start and end tokens and places this in the hash table with a key value equal to the token identifier-field identifier such as “</System identifier>” in 3505.

The process checks for several types of processing errors as represented in 3506. For each error that occurs, a detailed parse XML exception will be sent back to the calling routine in 3508 and the process will be terminated in 3509. Duplicate token identifier are considered an error as well as and missing end of token identifiers i.e. “>”, and end token identifiers. Once complete, if no errors have occurred, the process ends normally in 3507 and the hash table is available for use.

FIG. 36 details the header detail extraction and validation process. This process is used to extract a predefined set of header details from the shared in memory hash table constructed in process shown in FIG. 35. For each of these predefined values, the system retrieves and validates the data, then, sets the corresponding value on the reconciliation item object 1701 which was passed as a parameter to the process in 3601. The process begins by extracting and checking the existence of the following values from the hash table, user identifier, client identifier, reconciliation identifier, and system identifier in 3602. If any of these primary details do not exist in the hash table than a header processing exception is generated back to the caller and the process is terminated in steps 3603, 3611, 3612.

Then, if all of the above values are present, the header extraction process attempts to validate the user identifier by retrieving the related user object 1231 with the primary key equal to the respective user identifier in 3604. If the given user object 1231 cannot be found then a header processing exception is generated back to the caller and the process is terminated in steps 3605,3611,3612.

Then, if no errors have occurred, the header extraction process attempts to validate the client identifier, the reconciliation identifier, and the system identifier in 3606. This is done by retrieving first a base object 1201 then using the base object's get client (getcl) method retrieving the client object 1211 for the extracted client identifier. Next, the system uses the client object's 1211 get reconciliation (getrec) method to retrieve the reconciliation object 1341 for the extracted reconciliation identifier, and then, using the reconciliation object's get reconciliation system (getrecsys) method, the application retrieves the reconciliation system object 1371. This header extraction process ensures that the client exists, the reconciliation exists for the client, and the system exists for the reconciliation. If this is not the case then an exception is generated back to the caller and the process is terminated in steps 3607, 3611, and 3612.

After completing the header extraction's validation processes, the related values on the reconciliation item are set in 3608. Setting these values entails user identifier 1709 being set to the extracted user identifier, client identifier 1706 being to the extracted client identifier, reconciliation identifier 1708 being set to the extracted reconciliation identifier, and system identifier 1707 being set to the extracted system identifier. In extracting and setting these values the reconciliation item 1701 is now made available for further system processing.

The header extraction process contains a general exception management routine for handling any unexpected processing errors in 3609. In the event an error occurs the application jumps to step 3609 and then step 3611 which generates a header processing exception, and ends the extraction process in 3612. If no errors have occurred, the process ends normally with step 3610.

FIG. 37 details the build key process, which is used too create a match key string for the reconciliation item 1701 from the data provided and the reference library information for the particular reconciliation identifier 1708 and system identifier combination 1707.

The build key process begins with receipt of the call containing an item object 1701 as the parameter. The build key process first initializes several local key value variables to represent a new and empty match key strings in 3702. Then using the reconciliation system object 1371, as set in the header extraction process of FIG. 36, the application calls the reconciliation systems (listrecsyskeyflds) method, retrieving a set of reconciliation key field objects 1381 for the reconciliation system 1371 in 3703.

For each key field object 1381 in the set, the application performs the following steps 3704. First, the field identifier 1385 is obtained from the reconciliation key field object 3705. Then the hash table is checked to ensure it has a value for this field identifier; if no value exists in 3706, the process jumps to step 3717, generates a build key exception and terminates at step 3718. If the value exists, the value's expected type is checked in 3707 using the field type value from (fldtype) 1387. If the type is a string, the value is appended to the existing local key value variable 3709 and the process returns to step 3704.

If, however, the value is a date then the system will determine which date format the system is expecting. Then using that date format, the system will convert the string retrieved from the hash table into a date value. This date value will then be converted into a string using a common system date format (i.e. “YYMMDDDD”), and then appended to the derived string value to the existing local key value variable, and then the process returns to steps 3704, in 3708. This date formatting feature allows the system to take information from different geographical regions and process the related data converting it into a uniform system date format which can be intelligently matched. For example, dates in different formats such as 12/28/2000 and 28/12/2000 could be fed through the system and matched as a system string of 20001228.

Once all key fields objects 1381 have been processed, the application moves from step 3704 to step 3710. The build key process then uses the ignore space setting retrieved from the reconciliation object 1341 field (ignkeyspace) 1356, determining how to treat any white space which may exist in the derived local key string value that was created in 3710. If ignore space setting is true, then the application goes through the string sequentially and removes any white space characters in 3711. Then using the ignore case setting retrieved from the field identifier (ignkeycase) 1355 of the reconciliation object 1341, the application determines how to manage the character case of the key string in 3712. If the value of the retrieved setting is true the application converts the derived local key string value to all uppercase characters in 3713 and sets match key field value 1710 to the upper case derived key value in 3714. If this setting is false, the system set field value 1710 to the unaltered derived key value in 3714.

The build key process contains general exception management as represented in step 3715. This allows the process to respond to any unexpected errors such as date conversion problems. If any error occurs during the build key process, the application jumps to step 3715, throws a build key exception 3717, and terminates with step 3718. If step 3414 is completed successfully, the flow move through step 3715 and end the process normally at step 3716.

FIG. 38 represents the build data elements process. This build data element process is the essential task of constructing the individual data elements from the text message provided and the reference library information added to the system during the reconciliation configuration process. The result of this process will be a set of item compare elements 1741 for the individual reconciliation item 1701. These elements will be used in the subsequent reconciliation and reporting processes.

The process begins with the receipt of a method call containing the reconciliation item object 1701 as a parameter in 3801. The next step in the process is to initialize primary variables to hold the comparison type information and a list of field identifiers processed in 3802. Then using the reconciliation system object's 1571 list reconciliation system data compare objects (listrecsysdatcomps) method, a list of the reconciliation system data compare objects 1441 for the given reconciliation system as set in the header extraction process of FIG. 36, is obtained in 3803.

Then starting with the first data compare object 1441, representing an individual data comparison point, and processing all compare objects 1441 in the set, the application performs each of the following step in 3804. The application resets the local variables which will be used to hold, the computed value for the current comparison, the field identifiers used in creating the value, the type of the value, and the format of the value 3805. Once these variables are reset, the application retrieve the set of reconciliation data field objects 1471 using the data compare object's 1441 list reconciliation system data fields (listrecsysdatflds) method. The application then performs the following set of processes for each of the data fields objects 1471 in the set in order to derive a single comparison value for the reconciliation comparison and the system. Next, the application retrieves the field identifier using field 1476 of the current reconciliation data field object 1471. Then the application checks that the shared decomposition hash table contains a value for the field identifier in 1809. If no value exists, the process jumps to step 3919, generates a build data exception back to the caller and terminates with step 3820. If the value exists the application retrieves the value from the hash table for processing in 3810. The application then appends the field identifier value to the local variable containing list of field identifier used to compute our final value 3811.

The application then gets the data type of the value from field 1478 in 3812. Then, based on the type of the value the application determines if any value conversion is required, which variable type to use in storing the value, and how to combine the value with the existing derived comparison value for the current comparison loop. For example, if the field value is a string, the system simply appends the value to the local variable containing the existing string value. For strings multiple field values participating in a single comparison will produce a concatenated string value for the comparison containing each of the fields related values. If the value type is a number, however, then the system converts the fields related string value from the hash table to a number and adds this converted number to the existing derived local number value for the comparison loop. If the value type is a date, the system will determine which date format is being used for the field and it will convert this date format to the common system date format and then will set the date value for the comparison in steps 3813, 3814.

Once the application has completed traversing the set of data field objects 1471 for the comparison, an item compare element 1741 is created for the derived value, and the build data process moves from step 3807 to step 3815. The application attempts this creation process using the reconciliation item's add reconciliation item compare element (addrecitemcmplmnt) method passing as parameters a comparison identifier from field 1445, an active indicator which is false only if no fields exists for the comparison and system, the comparison data type 1447, the derived list of field identifiers used in computing the value, a string based display representation of the derived value, a string, number, and date value, only one of which will actually have a value and will be identified by value type information provided, and the list of individual field values used in computing the final value and represented as a string in 3815.

If this process is successful the item compare element 1741 is instantiated with the following details. Item identifier 1742 is set to item identifier 1702, compare identifier 1743 is set to compare identifier 1445, compare active 1744 is set to the true or false indicator provided, compare data type 1745 is set to comparison data type 1447, compare field ids 1746 is set to the derive list provided, compare reference value 1747 is set to null, compare display value 1748 is set to the derived display value, one of compare value char 1749, number 1750, date 1751 will be set to their related value provided. Note, only one of these fields will actually be used and this will depend on the value of the data type information. Compare field values 1753 will be set to the derived vale provided, and the compare element status field 1753 is set to zero representing a new element. On successful completion of the instantiation process a record for the object is created in table rhrecitemcmplmnt 2211 and the process moves back to step 3804 to derive data for the next comparison.

On completion of this process for all compare objects, the application jumps from 3804 to step 3817 and if no errors have occurred, the process terminates with step 3818. If during this process any errors did occur, the program jumps to step 3817 then to step 3819. At step 3819, a build data exception is generated back to the caller and the process then terminates with step 3820.

FIG. 39 describes the build information process. This build information process is used to construct a set of information data elements 1731 for the related reconciliation configuration information in the application's reference library, and the text message provided by the reconciliation item 1701.

The process begins with the receipt of a method call containing the reconciliation item 1701 as a parameter in 3901. The process then retrieves the set of reconciliation information field objects 1501 for the given reconciliation system object 1371 as set in the header extraction process of FIG. 36. This is achieved using the related reconciliation system object's 1371 list reconciliation system information fields (listrecsysinfflds) method in 3902. Then the application goes through this set of information field objects 1381, and as long as there are more objects 1381 to look at, the application performs the following set of actions in 3903. The process gets the information field objects field identifier 1505, in 3904. Then, the build information process checks the field identifier has a corresponding value in the in memory hash table in 3905. If no value exists, a build information exception is returned to the caller and the process terminates in steps 3905, 3910, 3911; otherwise, the process attempts to create a new item information element object 1731 using the reconciliation item's 1701 add reconciliation item information element (reciteminflmnt) method passing as parameters the field identifier 1505, and the value retrieved from the hash table in 3906. On creation, the item information element is instantiated and item identifier 1732 is set to item identifier 1702, field identifier 1733 is set to field identifier 1505, and the field data string 1734 is set to the value from the hash table in 3907. Once complete, a record is created for the new object in table rhreciteminflmnt 2210.

If no error occurs during the process, in 3908, the process will end normally with step 3909. Otherwise, if any errors occur during the process they are caught at step 3908 which then uses process 3910 to throw a build information exception back to the caller and terminate at step 3911.

FIG. 40 describes the main control program for Reconciliation Manager's matching process. This matching process takes the reconciliation item objects 1701 and determines which data group objects 1661 these items should be allocated to, and thereby which of the reconciliation items from the other source systems in their reconciliation they will be compared to.

This matching process begins on receipt of a method call with the related reconciliation item 1701 as a parameter in 4001. The matching process then retrieves the system's base object 1201 and using the base objects get client (getcl) method retrieves the client object 1211 for the client identifier 1706 on reconciliation item 1701, in 4002. The matching process then retrieves the reconciliation object 1341 using the client objects get reconciliation (getrec) method and the reconciliation identifier 1708 from reconciliation item 1701, in 4003. Then the matching process retrieves the reconciliation data object 1601 using the reconciliation object's 1701 get reconciliation data (getrecdat) method and match key 1710, in step 4004.

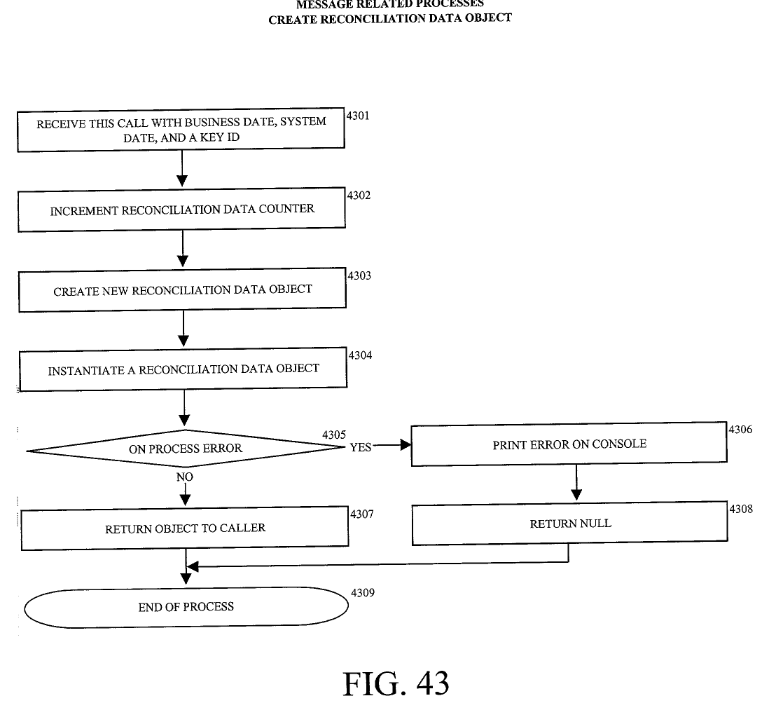

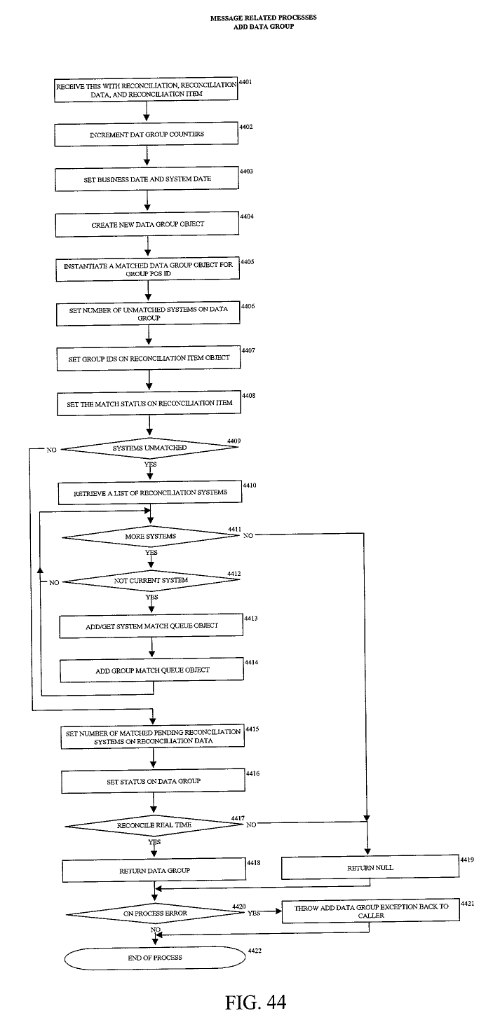

If no reconciliation data object 1601 is found in 4005 for the combination of reconciliation identifier and match key, then the application calls the create reconciliation data process detailed in FIG. 43, to create a new reconciliation data object 1601 in 4006. This create reconciliation data process returns a new reconciliation data object 1601 which is then used as a parameter for the add data group process called in step 4007. The add data group process is detailed in FIG. 44. From the call to the add data group process, a data group object 1661 or null is returned and this value is returned directly to the caller in 4007. If during match process no errors have occurred 4011, then the process ends at step 4013. If an error has occurred then a match exception is thrown back to the caller in 4012 and the process ends in 4013.

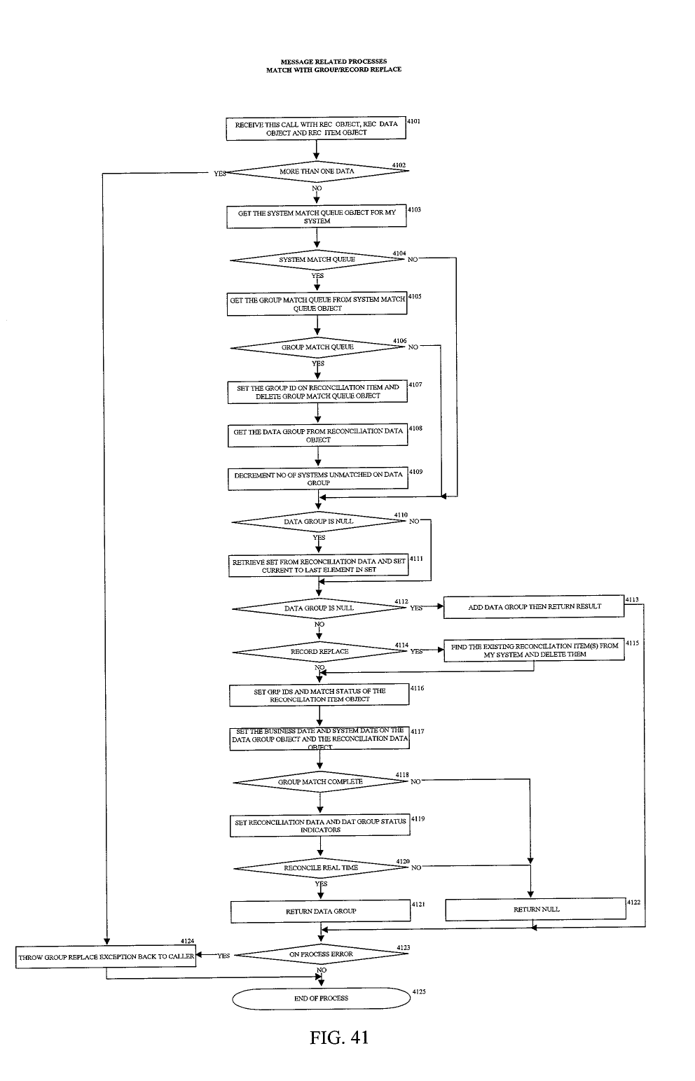

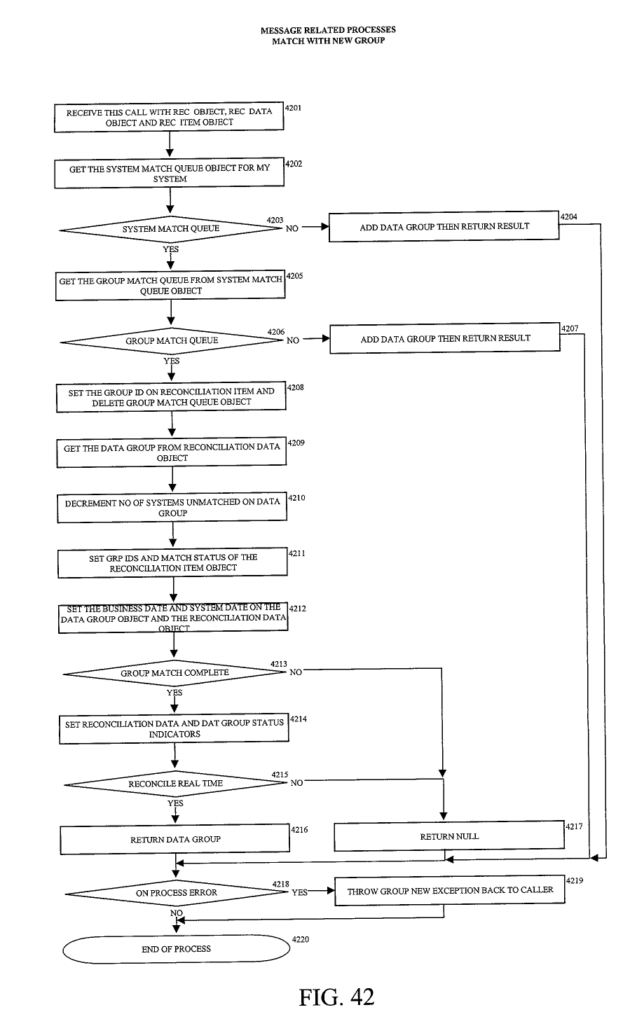

If the reconciliation data object 1601 is found, the match process will use the reconciliation object's 1341 group replace field 1351 to determine which sub match process to call. If group replace is false then the application will call the match with new group process, detailed in FIG. 42, in step 4009. If group replace is true then the system calls the sub match with group/record replace process, detailed in FIG. 41, in step 4010. In either case, these sub match processes will return null or a data group object 1661 which is returned directly to the routine's caller. If during this match process no errors have occurred in 4011, then the match process terminates at step 4013. If, however, an error does occur then a match exception is thrown back to the caller in step 4012 and the match process ends in 4013.

FIG. 41 describes the match with group and record replace process. This is a sub match process used to complete the matching function for reconciliations 1341, which have their related group replace flag set to true 1351. In completing the matching function, this process will allocate reconciliation items 1701 to their related data group objects 1661 based on the items match key 1710 regardless of the status of the corresponding data group 1661. Also, if the reconciliation's record replace flag is set to true 1352 then a reconciliation item 1701 will replace any reconciliation items from the same source system in the existing data group. Otherwise, reconciliation items 1701will simply be added to the data group 1661 and a data group will potentially contain multiple reconciliation items from the same source system in the data group.

This sub match process begins with receipt of a method call containing the reconciliation object 1341, reconciliation data object 1601, and the reconciliation item object 1701 in 4101. The sub match process first checks that there is not more than one active data group object 1661 for the given reconciliation data object 1601 in 4102. This is achieved by summing the data group counters on the reconciliation data object 1611 through 1614. If more one data group 1661 exists, this is considered an application error, and an exception is returned to the caller in 4124 and the process terminates in 4125. If no error has occurred, the sub match process continues by retrieving the system match queue object 1631 for the system identifier 1707. This is done using the get system match queue (getsysmchque) method of the reconciliation data object 1601 in 4103.

If a system match queue object 1631 is not found then the process jumps to step 4110 which is described below, in 4104. If the system match queue object 1631 is found, the sub match process then uses the system match queues get group match queue (getgrpmchque) method to retrieve the group match queue object 1641, in 4105. If a group match queue object is not found, the process jumps to step 4110 which is described below, in step 4106. If the group match queue object 1641 is found then the process sets group identifier 1711 to group identifier 1646 and deletes the group match queue object 1641 from the application in 4107. The process then uses the reconciliation data object's 1601 get data group (getdatgrp) method to retrieve the data group object 1661 in 4108 using the group identifier of field 1711 and then reduces the number of unmatched systems on the group 1668 by one in 4109.

In step 4110, the process ensures that the data group object being used is not null and if it is the process retrieves the set of active data group objects using the reconciliation data object's list data groups by client identifier, reconciliation identifier, match key, and status method. In this case there should be no more than one data group in the set and this then set to be the current data group object in 4111.

In the case where this set is empty and there is still no current data group object, in 4112, the process calls the add data group process in 4113 and returns the resulting data group object 1661 of this process to the caller and proceeds to step 4123.

If the active data group is now set then the process examines the reconciliation object record replace option 1352, and if this true in 4114, the process retrieves all reconciliation item objects which belong to the data group object using the data group object's list reconciliation items (listrecitems) method and then deletes any of these object which have the same system identifier 1707 as the reconciliation item 1701 the process is current trying to match 4115.

The process then continues by setting the group identifier 1711 and absolute group identifier 1717, to the group identifier 1665 and absolute group identifier 1670 respectively. Then the process sets match status 1713 to “MCCH” and completes step in 4116.

The process then examines the business date field 1704 on the reconciliation item and if this is later than the last business date field 1605 on the reconciliation data object the field 1605 and the last business date filed 1666 of the data group object is set to the date value 1704. After completing this, the last system date update fields 1606 and 1667 of the reconciliation data object data group object are both set to the value of reconciliation's system date field 1705, in 4117.

The system then checks if the data group is completely matched by looking at the value of the number of systems unmatched 1668 stored on the group object. If this value is not zero, then the process moves to step 4122 returning null to the caller. If the value is zero then the process will set the reconciliation data objects data group counters 1611 through 1612 to reflect that one data group is pending reconciliation. Then the status of the data group held in field 1669 is set to “1”, indicating the group is fully matched pending reconciliation 4119.

After completing this step, the application checks the reconciliation's real-time setting 1350, and if this is true then the data group object is returned to the calling process which will pass this object on for reconciliation in 4121. Otherwise, the process returns null to the call and leaves the user to complete the data group's reconciliation process in 4122. If any errors occur during this process, they are trapped at step 4123 will proceed to step 4124 generating a group replace exception back to the caller and terminating the process 4125. If no errors have occurred the process will simply terminate normally at step 4125.

FIG. 42 describes the match to new group process. This process is similar to the process described in FIG. 41 except that it will only allocate a given reconciliation item object to its related data group object if the data group is unmatched and still expecting a reconciliation item from the source system of the reconciliation item object 1701. In the case where no data group is waiting for the given reconciliation item from the source system 1701, a new data group object 1661 will be created.

This match new group process begins with receipt of a method call containing reconciliation object 1341, reconciliation data object 1601, and the reconciliation item object 1701, in 4201. The process first retrieves the system match queue objects 1631 for the system identifier 1707, using the get system match queue (getsysmchque) method of the reconciliation data object 1601 in 4202.

If a system match queue object is not found in 4203, the process jumps to step 4204 that calls the add data group process and returns the data group object 1661, which was returned from the add process, then proceeding to step 4218 for process completion. If a system match queue object 1661 is found, the process then uses the system match queue's get group match queue (getgrpmchque) method to retrieve the group match queue object 1641, in 4205.

If a group match queue object 1641 is not found in 4206 then the process jumps to step 4207 which calls the add data group process and returns data group object 1661 returned from the add process back to the caller, then proceeding to step 4218 for process completion. If the group match queue object 1641 is found then the process sets group identifier 1711 to group identifier 1646 and deletes the group match queue object 1641 from the application in 4208. The process then uses the reconciliation data object's get data group (getdatgrp) method to retrieve the data group object 1661, in 4209, and then reduces the number of unmatched systems on the data group 1668 by one in 4210.

The process then continues by setting the group identifier and absolute group identifier, 1711, 1717 respectively, to the group identifier and absolute group identifier, 1665 and 1670 respectively. Then the process sets match status 1713 to “MCH” in step 4211. The process then examines the business date field 1704 on the reconciliation item and if this is later than the last business date field 1605 on the reconciliation data object the field 1605 and the last business date filed 1666 of the data group object is set to the date value 1704. After completing this, the last system date update fields 1606 and 1667 of the reconciliation data object data group object are both set to the value of reconciliation's system date field 1705, in 4212.

The system then checks if the data group is completely matched in 4213 by looking at the value of the number of systems unmatched 1668 stored on the group object. If this value is not zero then the process moves to step 4217 returning null to the caller. If the value is zero then the process will set the reconciliation data objects data group counters 1611 through 1612 to reflect that one data group is pending reconciliation. Then the status of the data group held in field 1669 is set to “1” indicating the group is fully matched pending reconciliation in 4214.

After completing this step, the system checks the reconciliation's real-time setting 1350, and if this is true in 4215 then the data group object is returned to the calling process which will pass this object on for reconciliation in 4216. Otherwise the process returns null to the call and leaves the user to complete the data group's reconciliation process in 4217. If any errors occur during this process, they are trapped at step 4218 which will proceed to step 4219, generating a group new exception back to the caller and terminating the process in 4220. If no errors have occurred, the process will simply terminate normally at step 4220.

FIG. 43 depicts the process of creating reconciliation data. This process is used to create a reconciliation data object for a particular reconciliation and match key as required by match process of FIG. 40. Each reconciliation object 1341 will have its own set of reconciliation data objects 1601 which are unique for each match key field meaning, that each unique match key string will have only one reconciliation data object 1601 for a given reconciliation 1341.

This process begins with receipt of a method call containing a business date, system date, and match key identifier. Each of these field identifiers is taken from the individual reconciliation item 1701, which is originating the process in 4301. The process first increments the reconciliation data counter stored in the reconciliation object's (lastdatid) field 1349, in 4302. Then using this data counter information, the date information provided, and details from the related reconciliation object 1341 the application creates a new reconciliation data object 1601 in 4303. On completing the create process, the object is instantiated and client identifier 1602 is set to client identifier 1342, reconciliation identifier 1603 is set to reconciliation identifier 1343, key identifier 1604 is set to the key identifier provided, last business date update 1605 is set to the business date provided, last system date 1606 is set to the system date provided, number of systems 1607 is set to the number of systems 1345, last group identifier 1608 is set to zero, data identifier 1609 is set to the new last data identifier 1349, and all data group counters 1610 through 1617 are each set to zero. Once instantiated a record for the object is created in table rhrecdat 2105, in 4304.

If these processes complete without an error in 4305, the new reconciliation data object 1601 is returned to the caller in 4307 and the process ends with step 4309. If, however, an error occurs during the process then an error message is printed on the servers console 4306, null is returned to the caller in 4308, and the process terminates at step 4309.

FIG. 44 describes the add data group process. This process is used to create new data group objects 1661 for individual reconciliation items 1701 as required by the system matching processes of FIGS. 40-42. The add data group process begins with receipt of a method call containing reconciliation object 1341, reconciliation data object 1601, and the reconciliation item object 1701, in 4401. The process then calls the reconciliation data object's 1601 add data group (adddatagrp) method passing the business date 1704 and system date 1705 of the reconciliation item 1701. This call increments the last data group counter 1608, and the number of data groups counter 1617 of the reconciliation data object 1601, in 4402. The process then set the last business date 1605 to the business date provided if that date is later than the current date in field 1605. On completing this the last system date field 1606 is set to the system date provided.

Using values from the parent object and the business date value provided the new data group object 1661 is created in 4204. After creation the object instantiation process begins by retrieving the related sequence generation object 1951 for the key value of “absdatgrpid”. Then calling the object's get sequence number (getseqnumber) routine which increments the sequence number in the object by one and then returns the starting sequence number. This value is then used to set the data group's absolute data group identifier 1670. In this process, client identifier 1662 is set to client identifier 1602, reconciliation identifier 1663 is set to reconciliation identifier 1603, key identifier 1664 is set to key identifier 1604, group identifier 1665 is set to last group identifier 1608, last business date 1666 is set to the business date provided, last system date 1667 is set to last system date 1606, the number of systems unmatched 1668 is set to number of systems 1607, group status 1669 is set to zero, the notes field 1671 is set to null, the has error indicator 1672 is set to false, and the error message field 1673 is set to null. Once instantiation is complete a record is created for the object in table rhdatgrp 2109 and the record is returned ready for use in the initial process in 4405.

Using the newly created data group object, the number of system unmatched field 1668 is decremented by one in 4406. The process then continues by setting the group identifier and absolute group identifier 1711, 1717 respectively, to the group identifier and absolute group identifier, 1665 and 1670 respectively in 4407. Then the process sets item status 1712 to “1” and match status 1713 to “MCH” and completes step 4408.

The system then checks if the data group 1661 is completely matched by looking at the value of the number of systems unmatched 1668 stored on the group object. If this value is not zero in 4409 then the process moves to step 4410 in which it retrieves a list of all reconciliation systems 1371 participating in the given reconciliation, using the reconciliation object's 1341 list reconciliation systems (listrecsyss) method in 4410.

Then as long the derived reconciliation system's 1371 set is not empty, in step 4411, the application gets the next object 1371 and performs the following set of tasks: 1) Checking that the system identifier field 1374 is not equal the system identifier field 1707 and if the values are not equal in 4412, the flow proceeds to step 4413; otherwise the flow returns to step 4411.

Step 4413 uses the add system match queue (addsysmchque) method of the reconciliation data object 1601 to return a system match queue object 1631 for the system identifier 1707 of the current reconciliation system object. This process will simply return the object 1631 if it exists or will create the object, instantiate it using information from its parent object and the system identifier provided, and then return it. Using the system match queue object's 1631 add group match queue (addgrpmchque) method a group match queue object 1641 is created using details of the parent object and the group identifier 1665, in 4414. This process results in a set of group match queue object 1641 being created to instruct the application as to which source system have not yet provided an individual reconciliation item 1701 for the new data group 1661. On completing this process the application proceeds to step 4419 returning null to the caller.

If, however, the data group is completely matched in step 4409, the application proceeds to step 4415, setting the reconciliation data objects data group counters 1611 through 1614 to reflect that one data group is pending reconciliation. Then the status of the data group held in field 1669 is set to “1” indicating the group is fully matched pending reconciliation 4416.

After completing this step, the system checks the reconciliation's real-time setting 1350, and if this is true in 4417 the data group object 1661 is returned to the calling process which will pass this object on for reconciliation in 4418. Otherwise the process returns null to the call and leaves the user to complete the data group's reconciliation process in 4419. If any errors occur during this process they are trapped at step 4420 which will proceed to step 4421 generating a add data group exception back to the caller and terminating the process in 4422. If no errors occur, the process terminates at step 4422.

FIG. 45 describes the reconciliation manager's data reconciliation process. This reconciliation process is used to determine if the individual reconciliation items 1701 and their related item compare elements 1741 may be considered equal based on configuration information provided in the individual reconciliation's 1341 reference library information. This process performs its comparison and sets status indicators on related objects, which are used to support the application's reporting, status update, and other processing and functionality. The reconciliation process is at the core of the application flexibility and supports a wide range of features and steps in performing its data reconciliation function. In summary, these steps may be comprised of the following: first, receiving a call to reconcile the data of a particular group; second, retrieving the data groups reference library objects which determine how the comparison process will be performed; third, retrieving the complete set of data comparison attributes for the data group's reconciliation and iterating through each of the data comparisons performing the following steps; fourth, retrieve the related data elements from the reconciliation items specifically for the comparison; fifth, deriving a base value for comparison from the data elements; sixth, deriving and comparing each derived value against the base value and setting the status of the individual data elements; seventh, setting comparison status information for the comparison; and eighth, once all comparison's have been performed setting the status information for the data group and its related objects. This process is described in detail below along with many of its related features and options.

The process begins with the receipt of a call to this method containing a data group 1661 which the system is attempting to reconcile. The call may also contain the data group's related parent reconciliation data object 1601 and the reconciliation data object's parent reconciliation object 1341, in step 4501. The process checks the status of the data group to ensure it can be reconciled. If this group status field 1669 is not of the appropriate type, in step 4502, the process prints a console message as shown in step 4531, and returns the data group in step 4532.

If the data group is in the proper state for reconciliation, the process retrieves the data groups related reference library objects as follows. First, check that the reconciliation object 1341 exists as a parameter in 4503. If the parameter does not exist, the process retrieves the base object 1201 and uses the base object's get client method to retrieve the client object 1211 for client identifier 1662, then uses the client object's get reconciliation method to retrieve reconciliation object 1341 for reconciliation identifier 1663, in 4504. Then the application checks that the reconciliation data object 1601 parameter exists in 4505 and if it does not the application uses the reconciliation object's 1341 get reconciliation data (getrecdat) method to retrieve the reconciliation data object 1601 for key identifier 1664, in 4506. The process then uses the data group's 1661 list reconciliation items (listrecitems) method to return the set of reconciliation item objects 1701 which belong to the individual data group in 4507. These reconciliation items are placed into an in memory object for retrieval during the remainder of the process and according to one embodiment, these reconciliation items may be sorted into groups based on the individual items grouping key values, in 4508.

The process then sets the initial status for the data group's reconciliation items 1701 to reconciled in 4509 and retrieves the set of data compare attribute objects 1401 using the reconciliation object's (listreccmpatrib's) method in 4510. The application then begins going through the set of defined data compare atribute objects 1401 and for each object performs the following set of actions, in 4511.

As part of the processing loop described in 4511, first, a number of steps are used to set the environment for the comparison (1) set a local variable indicating the comparison reconciled successfully; (2) initialize a set of variables to store the computed comparison values in 4512; (3) determine the data type of the comparison using comparison data type (cmpdattype) 1406 in 4513.

Second, utilize a variety of potential methodologies a base comparison value is computed. According to one embodiment, the base value is taken from the first reconciliation item in the set of reconciliation items 1701. According to another embodiment, the comparison type information and other setting on the data compare attribute object 1401 may be used to determine the methodology for computing the base comparison value. Exemplary methodologies may include, first system, primary system, most common value, average, minimum, maximum, and/or grouping and combining related values based on a group key value. In each of the embodiments and for each of the required reconciliation items, the related item compare elements 1741 are retrieved using the reconciliation item's 1701 get reconciliation item compare elements (getrecitemcmplmnt) method and the compare identifier 1404. Then each of these comparison values is combined appropriately into the required base value for comparison in 4514, 4515.

Third, the comparison type is selected utilizing for example the data type and other option settings on the data compare attribute object 1401. One example could be a data type of string and ignoring all character space 1407 and character case 1408 for the comparison. In this instance, the application will remove all white space from strings before comparison and will not consider character case when performing the string comparison. A second example could be a data type of number and a tolerance type of absolute with a suggested tolerance of “0.05”. In this instance, the system would ensure the given value is not less than the base value minus 0.05 and not greater then the base value plus 0.05, in 4516.

Fourth, in 4517, the process iterates through the reconciliation items 1701 performing the following set of steps performing the following actions for each item which requires comparison: (1) select the individual reconciliation item 1701, in 4518; (2) retrieve the related item compare element 1741 using the reconciliation item's 1701 get reconciliation item compare elements (getrecitemcmplmnt) method and the compare identifier 1404, in 4519; (3) set the element's comparison status (cmpstat) 1753 to indicate reconciled in 4520; (4) retrieve the value from the appropriate compare element field 1749 through 1751, based on the comparison type; (5) combine the value with the existing comparison value for the key group (it should be noted that this can be done through a variety of options including addition, averaging, and concatenation in 4521); (6) if the application is not in key group mode or, this is the last reconciliation item in the set or, the next reconciliation item belongs to a different key group in 4522 then proceed to step 4523 otherwise the application goes back to step 4517.

Five, in 4523, using the appropriate comparison method, the computed value is compared against the base value and, if the values are not equal the process sets the local variable for the group to not reconciled, sets the local variable for the individual comparison to not reconciled, and if the comparison is set to track breaks at item compare element level, sets each of the item compare element's 1741 used to compute the compare value to have a compare status (cmpstat) 1753 indicating not reconciled, in steps 4524, 4525. Then the process resets the computed comparison values and returns to step 4517 to retrieve the next set of items. If the values are equal, the process resets the computed comparison values and proceeds directly to step 4517 and retrieves the next set of items.

After examining all reconciliation items 1701 for the related comparing, the system goes from step 4517 to step 4526. In step 4526, the process adds, or sets, the data group compare object 1691 to have a compare status (cmpstat) 1694 equal to the comparison value derived from the process in 4526. Then, if the individual comparison is not reconciled and the comparison does not track breaks at the element level in 4527 then, the application will retrieve all the related item compare elements 1741 and set their compare status (cmpstat) fields 1753 indicating not reconciled in 4528. Once complete this process jumps to step 4511 to begin processing the next comparison attribute.

Once this process has been performed for each of the related data compare attribute objects 1401, the system moves from step 4511 to step 4529. At this point, the process updates the reconciliation data objects 1601 data group status counters reducing the number of matched pending reconciliation data groups (noofinchpndrecdatgrps) 1612 by one, and incrementing either number of reconciled with data breaks (noofrcldwthbrkdatgrps) or number of reconciled with no data breaks (noofrcldnobrkdatgrps) counters by one based on the derived reconciliation status of the group, in 4529. The process then set the status as required on the data group 1661 in field group status (grpstat) 1669. Then, the process will go through each of the related reconciliation item objects 1701 and set their individual item status (itemstat) fields 1712, and match status (matchstat) fields 1713 to indicate the status of the group either reconciled or data breaks in 4530.

At this point, the process has completed and the application returns the data group 1661 to the caller in 4532. If, however, an error occurred during the processing 4533, the application will throw a reconcile data group exception back to the caller as indicated by step 4534. In either case, the process terminates at step 4535.

FIGS. 46-48 describe the different facilities available in the architecture for feeding data messages from external sources into the given application. For each of these data message feeds utilize the common processes single reconciliation message process of FIG. 32 is used to ultimately transmit the given data message for processing. Specifically, FIG. 46 details the options available for a client or source system application to integrate their processes directly with the application's single reconciliation message process of FIG. 32. In this regard, they would perform the following tasks with their process/system. Their system must maintain a connection to the application web server and have access to the single reconciliation message process of FIG. 32. Once access is achieved their process can instantiate a copy of the single reconciliation message process object in 4601 and as long as their system has data messages to submit, it can continue calling the following set of processes in 4602. The client application calls the message process which will submit the data for processing, running the required processes as indicated in FIG. 32. Upon completion of processing, the message process of FIG. 32 returns a reconciliation item object 1701 to the caller in 4603. The calling application can then use this object and other related objects, such as the item compare elements 1741, and the related data group object 1661 to retrieve and update information or correction data from the application's reconciliation process within their own system in 4604. If during this process any errors occur, the single reconciliation message process will return an exception to the caller and the caller can manage this as indicated in steps 4605-4606. Otherwise, the caller can terminate the connection to the process single reconciliation message process in 4607.

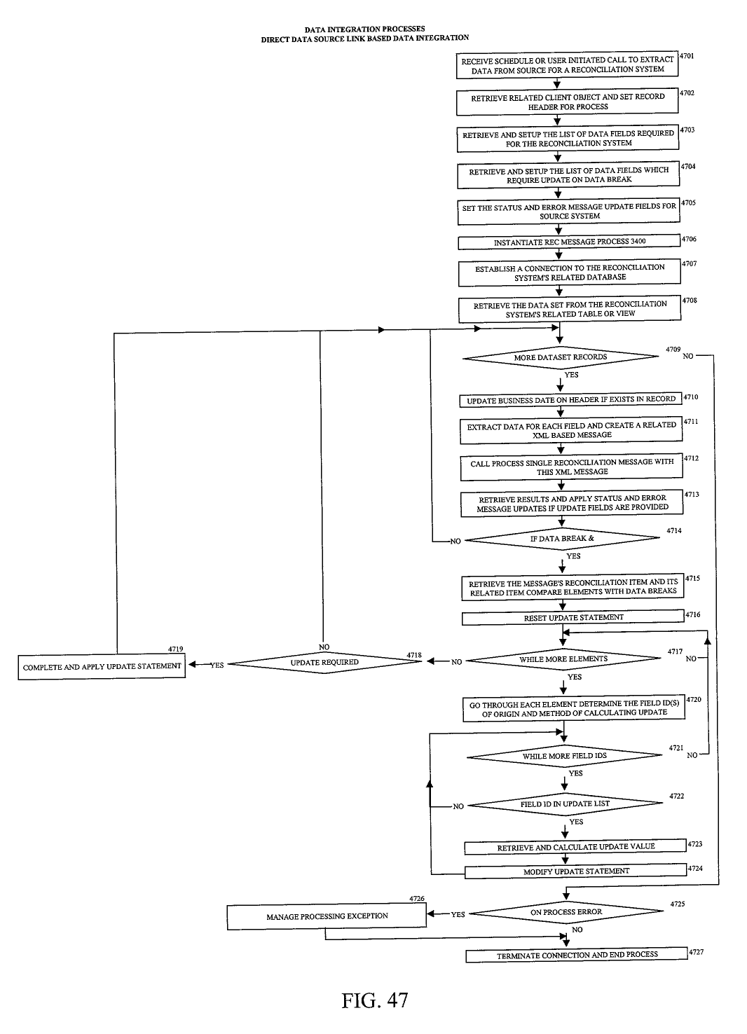

FIG. 47 details the application's facility for retrieving data directly from, and applying updates directly to, the data source tables/views specified by the reconciliation configuration information. This process is initiated by a configuration based timer or alternatively a user request from the application's user interface in 4701. On receiving the request, the process uses base object's 1201 get client method to retrieve the related client object 1211 for the reconciliation system object 1371, passed as a parameter to the call. Using the client object's header detail information 1220, the process constructs a header record for use at the beginning of each data record that is subsequently submitted in 4702. The process uses the reconciliation system object's 1371 get reconciliation system method to return a list of the field identifier required to submit a data record for this reconciliation system 1371. Using this information, an in-memory array of the required field identifiers is created in 4703. Then, information is retrieved and set to indicate the fields that should be updated with related reference value information if a data break occurs during reconciliation in 4704. The process then retrieves the reconciliation system's configuration information specifying the fields to update the related table or view with relevant status and error information in 4705. Then, in a series of steps, the process instantiates a copy of the reconciliation message process of FIG. 32, establishes a database connection (such as JDBC) through the web server to the reconciliation systems' related database, and retrieves the data set of records from the view or table, in 4706, 4707, 4708. The process then goes through each record in the data set and updates the headers business date if the business date is available on the record, extracts the data for each field identifier in the in memory array of field identifiers, and combining this into an XML base string format for submission in 4709, 4710, 4711. Then the process single message process of FIG. 32 is used to submit the record for processing with the result being returned in the form of a reconciliation item 1701, in 4712. The reconciliation item 1701 is then used to retrieve the processes status and error information and use this to update the data sets related status and error fields in 4713. If the returned reconciliation item contains a data break, as indicated by the item status 1712, the process begins a series of steps which calculate and apply updated correction values to the original source record in the data set in 4714. This process uses the reconciliation item object 1701 to obtain the set or related item compare elements 1741 which contain data breaks as indicated by the compare status (cmpstat) field 1753 and then resets a computed update statement variable for creating the related update command in 4715, 4716. For each item compare element, the source field identifiers are derived from compare field identifiers (cmpfldids) 1746 and for each field identifier which requires updating an update value is computed using the compare reference value (cmprefval) 1747 and the compare element's update formula in 4717, 4720, 4721, 4722, 4723, if the update value is computed then the information is appended to the update variable in 4724. Once complete, the process moves to step 4718 where it will either apply the update if it exists 4719 and then return to step 4709 to continue processing any remaining data records in 4709. On completing all records, the process checks for processing errors in 4725. If any processing errors exist, the process moves to step 4726 to report on the error and terminated with step 4727. Alternatively the process simply ends with step 4727.

FIG. 48 describes a combination of processes for managing and working with file reader objects 1901 which are used to process files containing data records submitted for processing on their related application server. These facilities are accessible by user through the application interface and the utilities and file reader menu options in 4801. In selecting this option, a set of related adapter programs 1158 through 1161 are used to retrieve and display a list of file reader objects for the users client object in 4802. At this point, a user may choose to add a new file reader or can select one from the list as indicated in steps 4803, 4804.

On selecting a reader, the user has a number of options including the ability to delete, start, stop, or upload a file for the reader object in steps 4805-4808, respectively. The delete option simply removes the selected reader from the application. The start option creates a system timer to continuously run a process that looks for, and processes, files as they arrive in the reader's input directory 1904, in 4809. After being started, this reader process will execute periodically (based on a predetermined time period), until it is stopped by the user in 4807, 4810, or a terminal reader error occurs in 4818, or the application server is shut down. The reader process checks that the input and output directories exist and can be accessed by the process then obtains a list of the files in the input directory in 4811-4812. For each file in the list, the process checks the process being shut down by a user, renames the active file to indicate it is being processed, and opens the file to begin processing its messages in 4813-4814.

Next, for each message in the file, assuming one message per line, the data is read and submitted for processing, using a call to the process single message process of FIG. 32, in steps 4815-4816. If any errors occur during this process, they are handled by the routines exception management functions in 4817-4818 and potentially tracked on both the file level and the reconciliation item 1701 level. If the errors are terminal for the file reader the process ends with step 4819 otherwise it would continue with either the next message 4815 or file in 4813. If no errors occur, the application processes all messages then moves to step 4813 to get the next file and when all files are complete moves to step 4817 and terminates at step 4819. The upload file process is used by the application to provide a facility for a user to select a file from their local environment via the application interface and submit this for processing on the selected file reader in 4808.

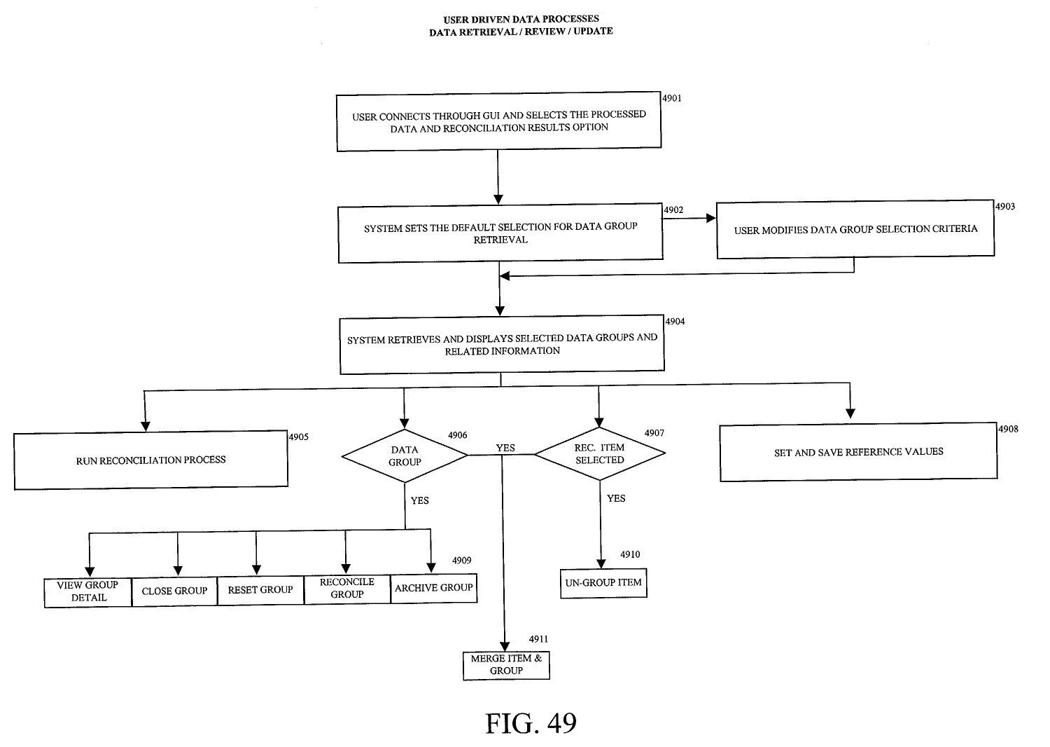

FIG. 49 describes the range of features which exist in the application for users to retrieve, review, and update the data submitted and processed for their related reconciliations. This functionality is accessible to a user of the application via the user interface and the processed data and reconciliation results menu options in 4901. Selecting these options will utilize the interface adapter programs 1139-1145 to provide a number of functions. On initial selection, the user interface is displayed for the first reconciliation in the list of user reconciliation and the default selection criteria of the related adapter program in 4902. At any point, the user can reset the selection option and after making the necessary changes, the screen will be refreshed. Some of the selection options provided include the ability to select a reconciliation and for the reconciliation set which data group types are desired, unmatched, matched pending reconciliation, reconciled with data breaks, reconciled with no data breaks, manually closed, and manually ungrouped. Also included is the ability to filter data groups on date range either by system processing date or by business date. A further option allows a user to specify which data comparisons will be looked at for any of the reconciled data groups in 4903. On completing a selection, data group and related object information is retrieved and presented to the user in 4904. The system then gives a range of options to the user. For example, the user can initiate the reconciliation process for the selected reconciliation object 1341 which will retrieve all data group objects which are pending reconciliation and will go through the set of object, submitting each object for reconciliation using the reconcile process described in FIG. 45, in 4905. The user can select a given data group in 4906 by highlighting the group on the screen at which point the system provides a number of options, such as the ability to double click on a group open a new window displaying information regarding the data group 1661, the data groups related queue information 1641, the group's reconciliation items 1701 and related item compare and information elements 1731, 1741. In addition, the ability to manually close a data group and prevent it from being used in further matching or reconciliation is provided, which is achieved by pre-determined key stroke(s). The process removes all of the group's related queue objects 1641 and data group compare objects 1691, then the appropriate status counter for the parent reconciliation data object is updated 1601, 1610-1616 and the status of the group status (grpstat) 1669 is changed. Another option relates to the ability to reset a data group which will bring it back to either the unmatched state or the matched pending reconciliation state, which is achieved by pre-determined key stroke(s). The process runs the close group process on the data group, resets the business and system dates 1666, 1667, creates any required system match queue and group match queue objects for the related list of reconciliation system object 1371 not represent by reconciliation items 1701 currently allocated to the data group, reset status indicators of the reconciliation data object 1601 and the sets the data group's group status (grpstat) 1669. Furthermore, the ability to submit an individual data group for reconciliation by predetermined key stroke(s) is provided. This process closes the data group, resets the data group, and if the status of the group is then matched pending reconciliation the group is submitted for reconciliation using the reconcile process of figure of FIG. 47.

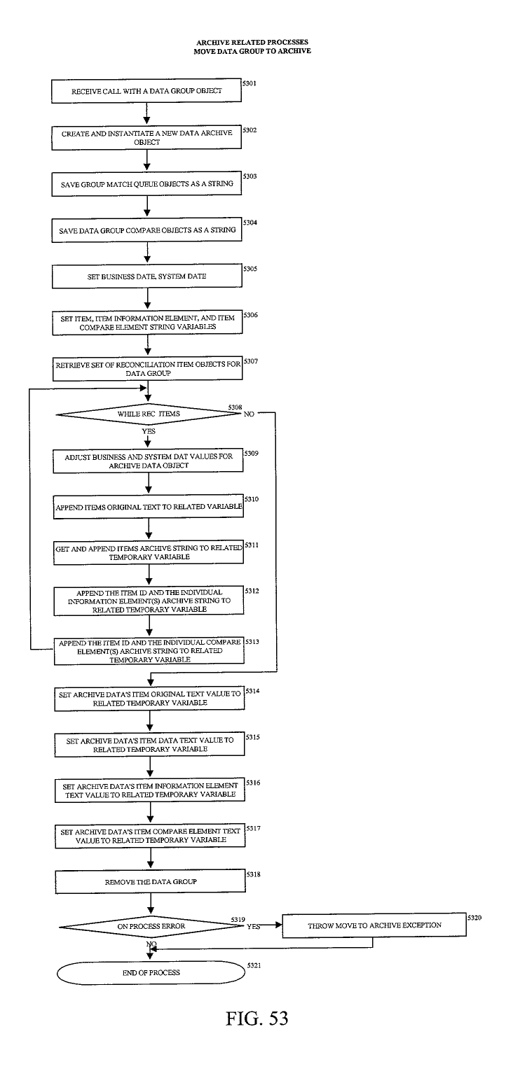

As another feature, the ability to move a data group into the online archive is provided, which is achieved by a predetermined key stroke(s). This process uses the move data group to archive process of FIG. 53 for transfer the selected data group 1601 to the archive. If the user has selected a combination data group in 4906 and a reconciliation item in 4907, then the application provides the ability to remove the selected item from its current data group and place it in the selected data group, which is achieved by predetermined key stroke(s). This move reconciliation item process will close each of the data groups, set the reconciliation items related group identifiers 1711, 1717, to the new data group identifiers 1665, 1670, reset each of the data groups, and delete the data group from which the item was removed if that group contains no other reconciliation items 1701 in 4911. On selecting only a reconciliation item the system provides the ability to move the selected item to a system managed data group called the ungroup data group. This functionality is used to pull individual items out of the application's processing structure, which is achieved by predetermined key stroke(s). The un-group reconciliation item process closes the data group, gets or creates the reconciliation data object 1601 for the reconciliation item's match key value 1710, gets or creates the special un-group data group for the reconciliation data object, set reconciliation items related group identifiers 1711, 1717, to the new data group identifiers 1665, 1670, reset each the original data group, and delete the data group which the item was removed from if that group contains no other reconciliation items 1701 in 4910. Other core functionality provided by this interface is the ability to set reference or correction values for any set of item compare elements 1741 which are part of an individual comparison and are in a state which indicates a data break.

In setting reference values for a given data group comparison, the user can either select from the range of values provided by the related compare elements, achieved by double clicking on the desired data point, or can specify their own value by double clicking on group reference value bar below the related comparison and entering the value. The user can set reference values for the data group retrieved by the interface and then save these modifications by selecting the set reference values menu option. On selecting this set reference values option, the process goes through the list of reference values provided, retrieves the related reconciliation data object 1601, retrieves the related data group object 1661, and calls the data group's set reference values (setrefvals) process. The set reference values (setrefvals) process then retrieves the set of reconciliation items 1701, and for each of these items gets the item compare element 1741, for the comparison identifier provided sets the comparison reference value (cmprefval) 1747 to the value provided; if a data type is provided, the process compares the converted value to the correct value from fields 1749-1751. If the values are equal, then the comparison status (cmpstat) 1753 is set to reconciled. If the values are not equal or are not of a type that can be compared or converted, the status is set as not reconciled in 4908.

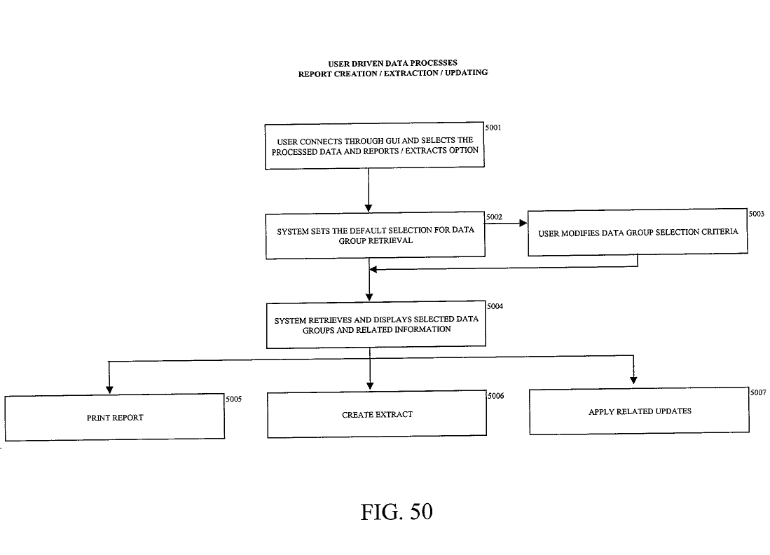

FIG. 50 describes the range of functionality which is available to the user for creating reports, data extractions, and applying correction updates back to the individual source system of a reconciliation. This functionality is accessible to a user of the system via the user interface and the processed data and reconciliation results menu options in 5001. Selecting these options requires utilization of the interface adapter programs 1146-1150. On initial selection, the user interface is display for the first reconciliation in the list of user reconciliation and this first system of the selected reconciliation and the default selection criteria of the related adapter program in 5002. At any point, the user can reset the selection option, and after making changes the screen will be refreshed. Some of the selection options provided include the ability to select a reconciliation and a system, and for this combination set the data group types that are desired, unmatched, matched pending reconciliation, reconciled with data breaks, reconciled with no data breaks, manually closed, and/or manually ungrouped. Also included, is the ability to filter data groups on date range either by system processing date or by a business date. A further option allows a user to specify which data comparisons will be looked at for any of the reconciled data groups in 5003. On completing a selection, data group and related object information is retrieved and presented to the user in 5004. The system then gives a few options to the user: (a) the user can print a report of the data presented by the current selection in 5005; (b) the user can create an extract file for the data presented by the current selection, which allows the data file to be created in HTML or EXCEL format in 5006; and (c) the user can choose to apply the updates for the selected reconciliation system 1371, in 5007. This update process uses the database and table/view information provided in reconciliation system object 1371 to connect to the data source and format and apply a series of status and correction updates to the specified table/view. Here the process of creating and applying status and correction updates is achieved in a similar manner as the related process described in FIG. 47.

FIG. 51 describes a range of features which support the modification of client related details through the application's user interface. These features are accessible to users of the application via the file and client details menu options in 5201. On selecting these options, the system utilizes the interface programs 1105-1111 to retrieve the client object 1211 for the user and display the current primary and secondary information for the related client in 5102. The user is then provided with a plurality of options: (a) the users may modify the name of the client in 5103; (b) the user may change the client header detail string which is used at the beginning of each data input template record to identify the client, specify the user identifier used for data feeds, and provide formatting of other required system information such as business date in 5104; (c) the use may modify the client side directories which are used to determine where on a client's PC data is sent to or retrieved from when interacting with the application server in 5105; and (d) the user may modify the server side directories which are used to determine where on server data is sent to or retrieved from for the client in 5106.

FIG. 52 describes the range of features that are available for the user to manage the creation and deletion of users and the configuration of users individual security profiles and environment preferences. These features are accessible through the application's user interface by selecting the file and users menu options in 5201. On making these selections, the system retrieves the client object for the user's session and uses this client object to obtain and display the set of related user objects 1231, in 5202. The interface provides the ability for the active user of the system to create new application users, assigning a user identifier and a password in 5203. On creating a user, the display will be refreshed and the new user name is displayed along with any of the client object's 1211 other application users.

The interface enables the active user to select a given application user by clicking on it in 5204. On user selection, the security role and user preference information is displayed for the related user. A set of features are made available: a) the active user may delete the selected user in 5205, b) the active user may modify the password of the selected user in 5206, c) the active user may change the security profile for the selected user by first selecting an access level (such as none, read only, small modification deletion, large modification deletion) for each of the different system component. Some system components available include archive, client, data, reference library, and reports. After making all selections the active user must choose the save security profile menu option which uses a method in the user object 1231 to retrieve or create a user security role object 1241 and set the related access type stored in fields 1245-1248 for each of the system components specified. The security role objects are used throughout the system in conjunction with GUJ item access requirement object 1261 to validate the ability of users to perform individual tasks in the system. In cases where a user does not have the required access or better for a given task, the system displays a security access alert message and denies the use of the ability to perform the requested action in 5207. In addition, the active user can set the user preferences for the selected user. Preferences may include the ability to set the default date format for the user in 5208.

FIG. 53 illustrates the process to move an individual data group object 1661 and its related data objects from the production environment to the applications online archive. This process condenses all related objects and their individual state information in sets of XML based string information, which is then stored as object for the entire data group. The process begins on a call with the data group 1661 as a parameter in 5301. The process begins by creating and instantiating a new archive data object 1801 to hold the related information. The process uses the sequence generation object 1951 to assign the new archive data a sequence number and store this value in archive group identifier (archgrpid) 1802. On instantiation the following archive data object values are set to their related data group values which are passed as parameters to the create call, client identifier 1803, reconciliation identifier 1804, key identifier 1805, original group identifier 1806, last business date update 1807, last system date update 1808, number of systems unmatched 1809, group status 1810, original absolute group identifier 1811, original group notes 1812, original group has error 1813, the original group error message 1814.

After instantiation, a record is created for the object in table rharchdata 2204 in 5302. Once complete, the process retrieves the set of group match queue objects 1641 for the data group 1661 and for each of these data groups objects, puts XML based headers around the objects data which is retrieved and represent as a XML based string containing the field identifiers and field values for each required field of the object. This computed string is then appended to a string variable that will be saved after all group match queues are processed. Once this iterative process is complete the archive data object GrpMchQueData 1815 is set to the computed string comprising this entire set of group match queue object data in 5303. This extraction and compression process is then performed on the data group's set of data group compare objects 1691. And, once this iterative process is complete the archive data object DatGrpCmpData 1816 is set to the computed string comprising this entire set of data group compare objects object data in 5304. The process then initializes the minimum and maximum business dates and system dates for the archive data object 1801, recitemminbusdate 1817, recitemmaxbusdate 1818, recitemminsysdate 1819, recitemmaxsysdate 1820 using the data group object's 1661 lstbusdatupd 1666 and lstsysdateupd 1667, in 5305.

Next, a set of temporary string variables is created and each initialized to the empty string. The set includes variables for computing archive strings for the set of, original data record strings, reconciliation item archive strings, item information strings, and item compare element strings in 5306. The data group's reconciliation items 1701 are then retrieved and for each the following processes are completed. First, the archive groups minimum and maximum business dates are adjusted based on the items busdate 1704 and sysdate 1705, in 5309. Second, the item original text string, item 1703 is enclosed in XML headers and appended to the variable for this data in 5310. Third, the reconciliation items archive string is retrieved, using the item's toarchstring method, enclosed in XML headers and appended to the related variable, in 5311. Fourth, the set of related item information element's 1731 is retrieved and each of the objects is converted to an archive string, enclosed in XML headers. When the entire set has been processed the resulting string is enclosed in a further set of XML headers indicating which reconciliation item the data belongs to. Then this entire string is appended to the related variable in 5312. Fifth, the set of related item comparison element's 1741 is retrieved and each of the objects is converted to an archive string, enclosed in XML headers. When the entire set has been processed, the resulting string is enclosed in a further set of XML headers indicating which reconciliation item the data belongs to. Then this entire string is appended to the related variable in 5313. Once all reconciliation items 1701 have been processed the recitemorigtext 1821 is set using the related computed string value in 5314, the recitemdata 1822 is set using the related computed string in 5315, the reciteminflmntdata 1823 is set using the related computed string in 5316, and the recitemcmphnntdata is set using its related computed string in 5317. On completing this process the data group object 1661 is deleted from the system which deletes all related child objects as indicated in figure 3116 as shown in FIG. 31, in 5318. At step 5319, if no errors have occurred then the process ends with step 5321; otherwise, an exception is thrown in step 5320 and the effects of the entire process are reversed.

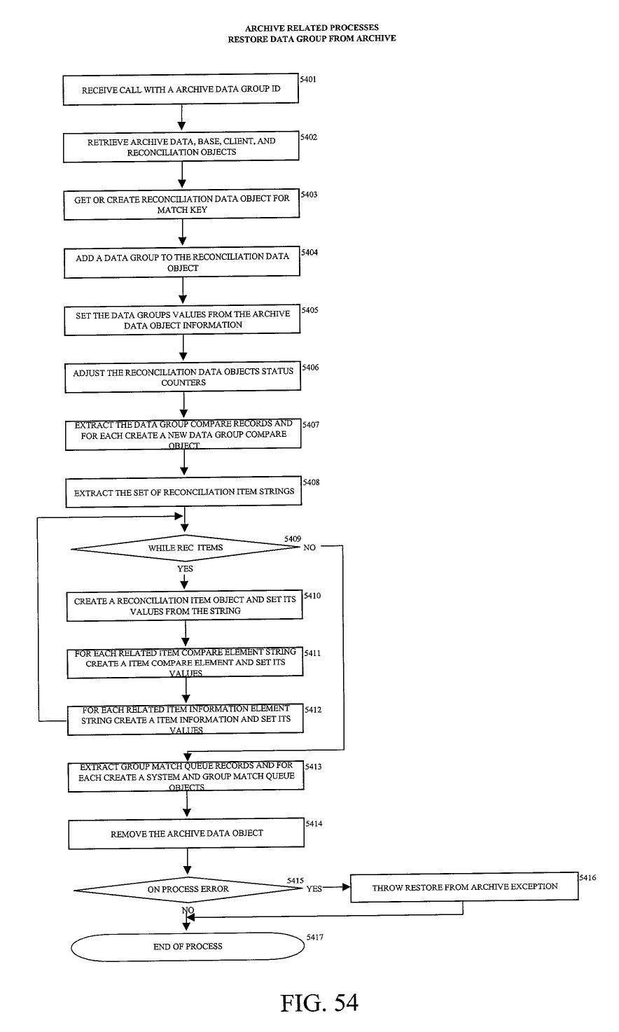

FIG. 54 describes the process for restoring an archive data group 1801 from the application's online archive back to the production environment. This process begins with the receipt of the related call containing the identifier of the archive data group object 1801, in 5401. The process then retrieves the archive data object 1801 for the identifier, the base object 1201 for the application, the client object 1211 for the archive data object's client identifier 1803, the reconciliation object 1341 for reconciliation identifier 1804, in 5402. The reconciliation data object 1801 is retrieved or created using the key identifier 1805 and other related information from the archive data object 1801, in 5403. A new data group object 1661 is added to the reconciliation data object 1601 and in a series of calls the new data group's notes field 1671, has error field 1672, error message field 1673, number of systems unmatched (noossysunmched) 1668, group stat (grpstat) 1669, each have their values set using the related archive data object variables in 5404, 5405.

The restore from archive process increments the correct status counter on the reconciliation data object 1601, one of the fields 1610-1616, the selection of which is based on the group status (grpstat) 1669, in 5406. The process retrieves the data group compare data (datgrpcmpdata) 1816 and for each sub record in this string, a data group compare object 1691 is added to the data group with the appropriate compare identifier 1693 and compare status 1694 in 5407. Then, in a series of calls, the process will retrieve the set of reconciliation item original text stings 1821, reconciliation item data 1822, reconciliation item compare element records 1823, and reconciliation item information records 1824, in 5408. The process then breaks down each of these strings using an internal XML parse routine and for each reconciliation original text string, creates a new reconciliation item 1701 for each string, set the field values of the item using the corresponding reconciliation item data, creates a compare elements 1741 for each of the items corresponding compare data strings, and creates an information element 1731 for each of the items corresponding information data strings 5409-5412. During this process, the group identifiers are updated on each of the reconciliation items 1701 using the new data group's identifier values 1665, 1670 and the system dates for both the reconciliation data object 1601 and the data group object 1661 are updated. After processing all reconciliation item sets, the application restores the set of system match queue objects 1631 and the set of group match queue objects 1641 from the related archive string's grpmchquedata 1815. This is achieved by using the reconciliation data object 1601 to retrieve or create a system match queue 1631 for each of the system identifiers in the string and then for each system match queue using the system match queue 1631 to add the group match queue object 1641 for the new data group object 1661, in 5413. After successfully completing these steps, the archive data object 1801 is deleted form the application in 5414 and if no errors have occurred in step 5415, the process ends with step 5417. If any errors do occur during the process, a restore from archive exception is thrown back to the caller in 5416, the effects of the process are reversed, and the process terminates with step 5417.

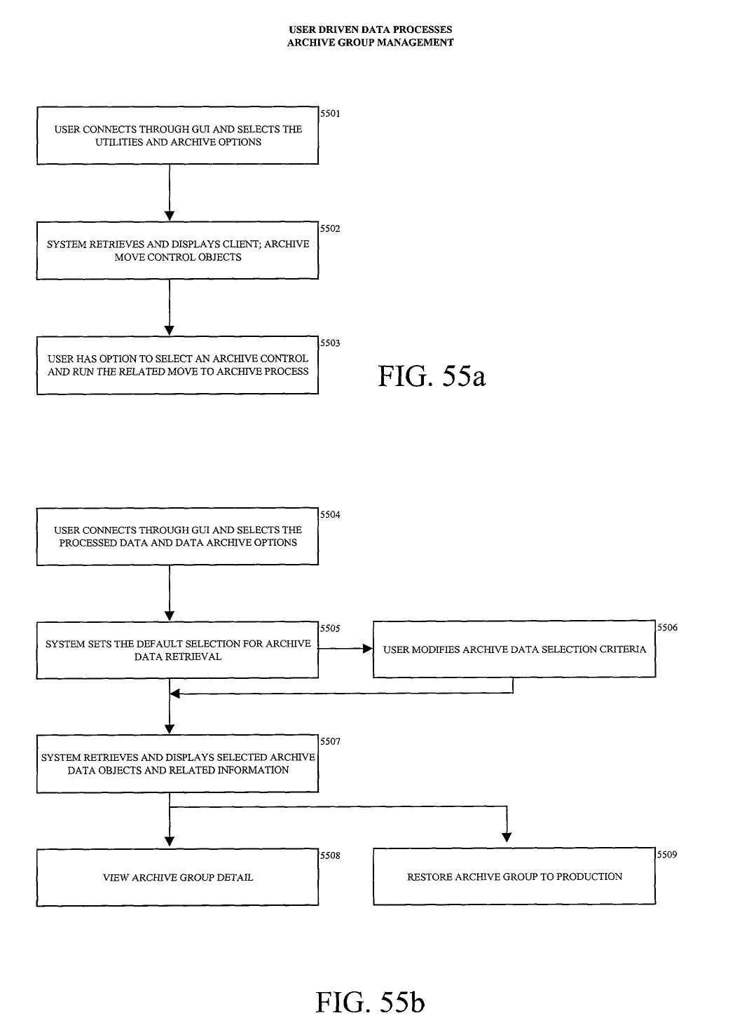

FIGS. 55a-b describes range of features available through the applications user interface for managing both archive processing and archive data. This figure is divided into two sections, each of which is accessible through related screens in the application's user interface. In FIG. 55a, in step 5501, the process of utilizing functionality for running the archive process for selected reconciliation begins. This facility is accessible through the utilities menu and the archive options menu in 5501. The application utilizes the adapter program 1162-1164 to retrieve and display the set of archive move control objects 1521 for the related client object 1211, in 5502. On completing the display process, the user may select a given control and initiate its archive data process. The archive data process retrieves the control objects archive move status objects 1541 and uses these in conjunction with the derived business or system cutoff date to retrieve a set of data group objects 1661, which it will attempt to archive. For each object in the set, the process calls the move data group to archive process of FIG. 53. Once all data groups in the set are removed, the process reviews the set of reconciliation data objects 1601 for the reconciliation and deletes any of these objects having no remaining child data group objects, in 5503.

In FIG. 55b, step 5504 begins the process of utilizing the applications features for reviewing and restoring the systems archived data groups. These features are accessible to client via the processed data and data archive menu options. Selecting these options will utilize the interface adapter programs 1151-1155 to provide the following set of options. On initial selection, the user interface is displayed for the first reconciliation in the list of user reconciliation and the default selection criteria of the related adapter program, in 5505. At any point, the user can reset selection option after making changes the screen will be refreshed. Some of the selection options provided include the ability to select a reconciliation and set which data group types are desired, unmatched, matched pending reconciliation, reconciled with data breaks, reconciled with no data breaks, manually closed, and manually ungrouped. Also included, is the ability to filter data groups on date range either by system processing date or by business date in 5506. On completing a selection, the related archive data objects 2001 are retrieved and presented to the user in 5507. The system then gives a number of options: a) the user can double click on an archive data objects in display all its related details in a separate popup window in 5508, b) the user may restore a group to production by pre-determined key stroke(s), which will then pass the selected group to the restore group from archive process 5400, in 5509.

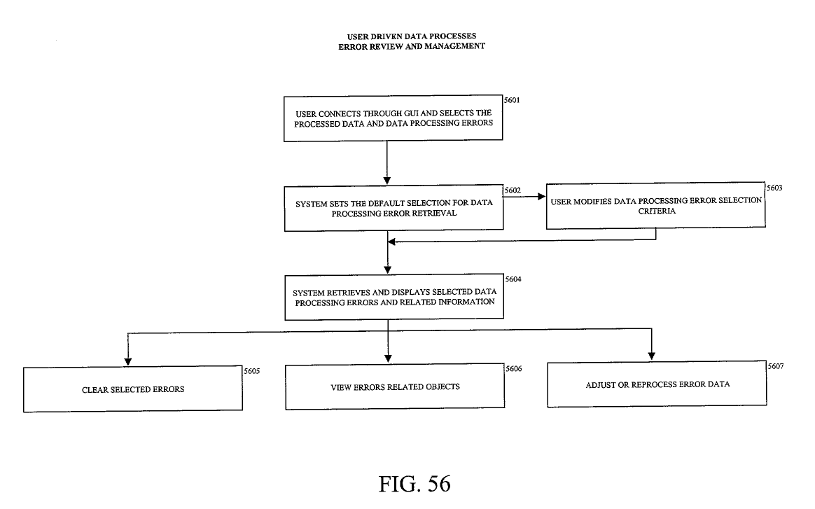

FIG. 56 describes the range of error management facilities available through the applications user interface. These features are accessible to a client via the processed data and data processing errors menu options. Selecting these options will utilize the interface adapter programs 1156-1157 to provide the following set of options in 5601. On initial selection, the user interface is displayed for the first reconciliation in the list of user reconciliation and the default selection criteria of the related adapter program in 5602. At any point, the user can reset selection option and after making changes the screen will be refreshed. Some of the selection options provided include the ability to select a reconciliation or all reconciliations. Also included is the ability to filter data groups on date range in 5603. On completing a selection the related data processing error objects 1921 are retrieved and presented to the user in 5604. The application then gives a number of options: a) the user can clear the related errors deleting these objects from the system in 5605, b) the user can retrieve the set of related objects by double clinking on the error in 5606, c) the user can execute a range of reprocessing options for the related objects. The specific options available depend on the individual object type. For example if the error is caused by a reconciliation item 1701 and its decomposition the user could attempt to reprocess the item beginning with decomposition process in 5607.

A second embodiment of the object architecture is a risk management system for monitoring exposure on open positions. Implementing the risk management system in the new architecture involves: first, setting up a product master for the instruments to be tracked; second, building a set of configurable exposure objects to determine which products go into the exposure calculation, what fields of what products are used for the calculation, and what the precise details of the calculation are. With this complete, an algorithm is constructed to interpret the configuration objects, perform the business function, and return the results into the environment. User interface, data storage, and report objects are then constructed around the configuration objects for each of exposure types defined in the system.

In summary, the present invention is a flexible multi-tier object architecture for supporting the processing requirements of a set of defined business functions. The architecture is unique in the automated flexibility and configuration it provides. Specific applications of the architecture are targeted at generic or high-level business processes, such as data reconciliation, position management, and/or risk management. For each of the target business function an independent application is provided which supports the automation of the given function under varying conditions. The foundation of flexibility across the architecture impacts every aspect of processing from data storage and display to the functioning of individual algorithms. One aspect of this flexibility is in the design of high-level processes for performing generic tasks and the use of configuration objects to guide the detailed implementation of a given task at run time.

The present invention uses advanced software techniques to construct each application with the following set of characteristics: first, the application supports a well-defined business function under all circumstances; second, the application supports variation in the business function through configuration; third, the application provides seamless integration with other systems while maintaining complete independence from other systems; and fourth, allows the application's availability over the Internet.

As discussed above, one embodiment of the present invention relates to the business process of reconciliation. Reconciliation processing is the essential task of identifying and tracking differences in the critical business data of an organization. This business function is characterized by high level of consistency in the process with wide divergence in the underlying business data. As noted above, some examples of this process include data integrity management and cash/stock management. The reconciliation software of the present invention provides support for the key processes of this business function while supporting the required variation in the underlying data. The reconciliation software of the present invention can, through configuration, perform new and different reconciliations without re-development or redesign. The configuration of new reconciliations is done at the business level and limits the amount of development time required to implement new reconciliation.

In data reconciliation, the primary tasks are defining the data sets to reconcile. Then, defining how the individual data records for any given data sets match together. Then, once a set of records is matched, define how the individual data points of the records are compared. In the present invention this process is supported by first, building a library of potential data sources. Second, constructing a set of flexible reconciliation configuration objects for determining which data sources match together and how the data elements are compared. With this complete an algorithm is constructed to interpret the configuration objects, perform the business process, and return the results into the environment. User interface, data storage, and report objects are constructed around the configuration objects.

It is to be understood that the above description is only representative of illustrative examples of embodiments and implementations. For the reader's convenience, the above description has focused on a representative sample of all possible embodiments, a sample that teaches the principles of the invention. Other embodiments may result from a different combination of portions of different embodiments. The description has not attempted to exhaustively enumerate all possible variations.

It should be recognized that the method and system of the present invention has many applications, and that the present invention is not limited to the representative examples disclosed herein. Alternate embodiments may not have been presented for a specific portion of the invention. Some alternate embodiments may result from a different combination of described portions, or other un-described alternate embodiments may be available for a portion. This is not to be considered a disclaimer of those alternate embodiments, because many of those un-described embodiments are within the literal scope of the following claims, and others are equivalent.

It is to be further understood that the tasks described in the following claims can be sequenced in many different orders to achieve the desired result. Thus, the scope of the present invention covers conventionally known variations and modifications to the system components and the method steps described herein, as would be known by those skilled in the art.

What is claimed is:

1. A method for performing a business function in an object architecture, comprising:
utilizing configuration information for directing at least one process to perform said business function;
utilizing a reference library for defining data external to the object architecture and supporting said configuration information;
interfacing said at least one process associated with the object architecture with at least one in-memory object; and
utilizing at least one data storage object for preserving the data affected by said at least one process.

2. The method of claim 1, wherein said reference library comprises at least one business process configuration object for managing said configuration information.

3. The method of claim 2, wherein said reference library comprises at least one data definition object for managing the definition of the data external to the object architecture.

4. The method of claim 3, wherein said business process configuration object directs said at least one process in conjunction with said data definition object.

5. The method of claim 4, wherein said data definition object is created by specifying source information for said data.

6. A method for supporting requirements of a business function, comprising:
creating a library of data source configuration objects;
constructing a plurality of flexible business function management objects;
receiving data based on the configuration objects;
decomposing said data based on the configuration objects;
interpreting said data source configuration objects;
performing at least one business function on the received data; and
returning the results of the processed information.

7. A method for reconciling data in a computing system, comprising:
utilizing configuration information for directing at least one process to perform reconciliation of data;
utilizing a reference library for defining data external to said computing system and supporting said configuration information;
interfacing said at least one process associated with the computing system with at least one in-memory object; and
utilizing at least one data storage object for preserving the data affected by said at least one process.

8. The method of claim 7, wherein said reference library comprises at least one business process configuration object for managing said configuration information.

9. The method of claim 8, wherein said reference library comprises at least one data definition object for managing the definition of the data external to the computing system.

10. The method of claim 9, wherein said business process configuration object directs said at least one process in conjunction with said data definition object.

11. The method of claim 10, wherein said data definition object is created by specifying source information for said data.

12. A method for monitoring data integrity in a computing system, the computing system having a plurality of data sources, comprising:
analyzing data from said plurality of data sources;
configuring the computing system to support data reconciliation for said data, said configuring based on the data analysis; and
reconciling data from said plurality of data sources, said reconciling dependent on information obtained during said configuring.

13. The method of claim 12, wherein said configuring comprises:
defining data characteristics for said plurality of data sources, said characteristics allowing identification and interpretation of said data;
creating at least one data integrity control in accordance with said analysis; and
configuring said at least one data integrity control, wherein said configuring determines the data sources containing said data, matches said data between said plurality of data sources, and compares individual data elements of the matched data.

14. The method of claim 13, wherein said reconciling comprises:
obtaining data from said plurality of data sources for said at least one data integrity control; and
decomposing, matching, and identifying inconsistencies in said data by utilizing said data characteristics, said data integrity control, and at least one system process to obtain data reconciliation analysis for said data.

15. The method of claim 14, further comprising:
determining corrective instructions for said data reconciliation analysis; and
utilizing information related to said corrective instructions.

16. The method of claim 15, wherein said configuring comprises:
configuring said at least one data integrity control for storing at least one field of an identifier for linking data records in the system to related data records in said plurality of data sources; and
configuring said at least one data integrity control for updating said information in said plurality of data sources.

17. The method of claim 16, wherein said utilizing comprises:
transmitting said information back to one of said plurality of data sources.

18. The method of claim 16, wherein said utilizing comprises:
transmitting said information back to an individual.

19. A computing device comprising a computer readable medium having computer readable code means embodied therein for supporting the process requirements for data reconciliation, said computing device further comprising:
means for creating a library of data source configuration objects;
means for constructing a plurality of flexible business function management objects;
means for receiving data based on the configuration objects;
means for decomposing said data based on the configuration objects;
means for interpreting said data source configuration objects;
means for performing at least one business function on the received data; and
means for returning the results of the processed information.

20. A system for performing a business function in an object architecture, comprising:
a. a memory unit; and
b. a processing unit disposed in communication with said memory unit, said processing unit configured to:
utilize configuration information for directing at least one process to perform said business function;
utilize a reference library for defining data external to the object architecture and supporting said configuration information;
interface said at least one process associated with the object architecture with at least one in-memory object; and
utilize at least one data storage object for preserving the data affected by said at least one process.

21. The method of claim 20, wherein said reference library comprises at least one business process configuration object for managing said configuration information.

22. The method of claim 21, wherein said reference library comprises at least one data definition object for managing the definition of the data external to the object architecture.

23. The method of claim 22, wherein said business process configuration object directs said at least one process in conjunction with said data definition object.

24. The method of claim 23, wherein said data definition object is created by specifying source information for said data.

25. A system for reconciling data in a computing system, comprising:
a. a memory unit; and
b. a processing unit disposed in communication with said memory unit, said processing unit configured to:
utilize configuration information for directing at least one process to perform reconciliation of data;
utilize a reference library for defining data external to said computing system and supporting said configuration information;
interface said at least one process associated with the computing system with at least one in-memory object; and
utilize at least one data storage object for preserving the data affected by said at least one process.

26. The method of claim 25, wherein said reference library comprises at least one business process configuration object for managing said configuration information.

27. The method of claim 26, wherein said reference library comprises at least one data definition object for managing the definition of the data external to the computing system.

28. The method of claim 27, wherein said business process configuration object directs said at least one process in conjunction with said data definition object.

29. The method of claim 28, wherein said data definition object is created by specifying source information for said data.

30. A system for monitoring data integrity in a computing system, the computing system having a plurality of data sources, comprising:
a. a memory unit; and
b. a processing unit disposed in communication with said memory unit, said processing unit configured to:
analyze data from said plurality of data sources;
configure the computing system to support data reconciliation for said data, said configuring based on the data analysis; and
reconcile data from said plurality of data sources, said reconciling dependent on information obtained during said configuring.

31. The system of claim 30, wherein said processing unit is further configured to:
define data characteristics for said plurality of data sources, said characteristics allowing identification and interpretation of said data;
create at least one data integrity control in accordance with said analysis; and
configure said at least one data integrity control, wherein said configuring determines the data sources containing said data, matches said data between said plurality of data sources, and compares individual data elements of the matched data.

32. The system of claim 31, wherein said processing unit is further configured to:
obtain data from said plurality of data sources for said at least one data integrity control; and
decompose, match, and identify inconsistencies in said data by utilizing said data characteristics, said data integrity control, and at least one system process to obtain data reconciliation analysis for said data.

33. The system of claim 32, wherein said processing unit is further configured to:
determine corrective instructions for said data reconciliation analysis; and
utilize information related to said corrective instructions.

34. The system of claim 33, wherein said processing unit is further configured to:
configure said at least one data integrity control for storing at least one field of an identifier for linking data records in the system to related data records in said plurality of data sources; and
configure said at least one data integrity control for updating said information in said plurality of data sources.

35. The system of claim 34, wherein said processing unit is further configured to:
transmit said information back to one of said plurality of data sources.

36. The system of claim 34, wherein said processing unit is further configured to:
transmit said information back to an individual.

37. A system for performing a business function in an object architecture, comprising:
means for utilizing configuration information for directing at least one process to perform said business function;
means for utilizing a reference library for defining data external to the object architecture and supporting said configuration information;
means for interfacing said at least one process associated with the object architecture with at least one in-memory object; and
means for utilizing at least one data storage object for preserving the data affected by said at least one process.

38. The system of claim 37, wherein said reference library comprises at least one business process configuration object for managing said configuration information.

39. The system of claim 38, wherein said reference library comprises at least one data definition object for managing the definition of the data external to the object architecture.

40. The system of claim 39, wherein said business process configuration object directs said at least one process in conjunction with said data definition object.

41. The system of claim 40, wherein said data definition object is created by specifying source information for said data.

42. A system for reconciling data in a computing system, comprising:
means for utilizing configuration information for directing at least one process to perform reconciliation of data;
means for utilizing a reference library for defining data external to said computing system and supporting said configuration information;
means for interfacing said at least one process associated with the computing system with at least one in-memory object; and
means for utilizing at least one data storage object for preserving the data affected by said at least one process.

43. The system of claim 42, wherein said reference library comprises at least one business process configuration object for managing said configuration information.

44. The system of claim 43, wherein said reference library comprises at least one data definition object for managing the definition of the data external to the computing system.

45. The system of claim 44, wherein said business process configuration object directs said at least one process in conjunction with said data definition object.

46. The system of claim 45, wherein said data definition object is created by specifying source information for said data.

47. A system for monitoring data integrity in a computing system, the computing system having a plurality of data sources, comprising:
means for analyzing data from said plurality of data sources;
means for configuring the computing system to support data reconciliation for said data, said configuring based on the data analysis; and
means for reconciling data from said plurality of data sources, said reconciling dependent on information obtained during said configuring.

48. The system of claim 47, wherein said means for configuring the computing system comprises:
means for defining data characteristics for said plurality of data sources, said characteristics allowing identification and interpretation of said data;
means for creating at least one data integrity control in accordance with said analysis; and
means for configuring said at least one data integrity control, wherein said configuring determines the data sources containing said data, matches said data between said plurality of data sources, and compares individual data elements of the matched data.

49. The system of claim 31, wherein means for reconciling data comprises:
means for obtaining data from said plurality of data sources for said at least one data integrity control; and
means for decomposing, matching, and identifying inconsistencies in said data by utilizing said data characteristics, said data integrity control, and at least one system process to obtain data reconciliation analysis for said data.

50. The system of claim 49, further comprising:
means for determining corrective instructions for said data reconciliation analysis; and
means for utilizing information related to said corrective instructions.

51. The system of claim 50, wherein said means for configuring the computing system further comprises:
means for configuring said at least one data integrity control for storing at least one field of an identifier for linking data records in the system to related data records in said plurality of data sources; and
means for configuring said at least one data integrity control for updating said information in said plurality of data sources.

52. The system of claim 51, wherein said means for utilizing comprises:
means for transmitting said information back to one of said plurality of data sources.

53. The system of claim 51, wherein said means for utilizing comprises:
means for transmitting said information back to an individual.

54. A computer device comprising a computer readable medium having computer readable code means embodied therein for performing a business function in an object architecture, said computer readable code means further comprising:
means for utilizing configuration information for directing at least one process to perform said business function;
means for utilizing a reference library for defining data external to the object architecture and supporting said configuration information;
means for interfacing said at least one process associated with the object architecture with at least one in-memory object; and
means for utilizing at least one data storage object for preserving the data affected by said at least one process.

55. The computer readable code means of claim 54, wherein said reference library comprises at least one business process configuration object for managing said configuration information.

56. The computer readable code means of claim 55, wherein said reference library comprises at least one data definition object for managing the definition of the data external to the object architecture.

57. The computer readable code means of claim 56, wherein said business process configuration object directs said at least one process in conjunction with said data definition object.

58. The computer readable code means of claim 57, wherein said data definition object is created by specifying source information for said data.

59. A computer device comprising a computer readable medium having computer readable code means embodied therein for reconciling data in a computing system, said computer readable code means further comprising:
means for utilizing configuration information for directing at least one process to perform reconciliation of data;
means for utilizing a reference library for defining data external to said computing system and supporting said configuration information;
means for interfacing said at least one process associated with the computing system with at least one in-memory object; and
means for utilizing at least one data storage object for preserving the data affected by said at least one process.

60. The computer readable code means of claim 59, wherein said reference library comprises at least one business process configuration object for managing said configuration information.

61. The computer readable code means of claim 60, wherein said reference library comprises at least one data definition object for managing the definition of the data external to the computing system.

62. The computer readable code means of claim 61, wherein said business process configuration object directs said at least one process in conjunction with said data definition object.

63. The computer readable code means of claim 62, wherein said data definition object is created by specifying source information for said data.

64. A computer device comprising a computer readable medium having computer readable code means embodied therein for monitoring data integrity in a computing system, the computing system having a plurality of data sources, said computer readable code means further comprising:
means for analyzing data from said plurality of data sources;
means for configuring the computing system to support data reconciliation for said data, said configuring based on the data analysis; and
means for reconciling data from said plurality of data sources, said reconciling dependent on information obtained during said configuring.

65. The computer readable code means of claim 64, wherein said means for configuring the computing system comprises:
means for defining data characteristics for said plurality of data sources, said characteristics allowing identification and interpretation of said data;
means for creating at least one data integrity control in accordance with said analysis; and
means for configuring said at least one data integrity control, wherein said configuring determines the data sources containing said data, matches said data between said plurality of data sources, and compares individual data elements of the matched data.

66. The computer readable code means of claim 65, wherein means for reconciling data comprises:
means for obtaining data from said plurality of data sources for said at least one data integrity control; and
means for decomposing, matching, and identifying inconsistencies in said data by utilizing said data characteristics, said data integrity control, and at least one system process to obtain data reconciliation analysis for said data.

67. The computer readable code means of claim 66, further comprising: means for determining corrective instructions for said data reconciliation analysis; and
means for utilizing information related to said corrective instructions.

68. The computer readable code means of claim 67, wherein said means for configuring the computing system further comprises:
means for configuring said at least one data integrity control for storing at least one field of an identifier for linking data records in the system to related data records in said plurality of data sources; and
means for configuring said at least one data integrity control for updating said information in said plurality of data sources.

69. The computer readable code means of claim 68, wherein said means for utilizing comprises:
means for transmitting said information back to one of said plurality of data sources.

70. The computer readable code means of claim 68, wherein said means for utilizing comprises:
means for transmitting said information back to an individual.

71. A system for supporting requirements of a business function, comprising:
a. a memory unit; and
b. a processing unit disposed in communication with said memory unit, said processing unit configured to:
create a library of data source configuration objects;
construct a plurality of flexible business function management objects;
receive data based on the configuration objects;
decompose said data based on the configuration objects;
interpret said data source configuration objects;
perform at least one business function on the received data; and
return the results of the processed information.

72. A system for supporting requirements of a business function, comprising:
means for creating a library of data source configuration objects;
means for constructing a plurality of flexible business function management objects;
means for receiving data based on the configuration objects;
means for decomposing said data based on the configuration objects;
means for interpreting said data source configuration objects;
means for performing at least one business function on the received data; and
means for returning the results of the processed information.

73. A computer device comprising a computer readable medium having computer readable code means embodied therein for supporting requirements of a business function, said computer readable code means further comprising:
means for creating a library of data source configuration objects;
means for constructing a plurality of flexible business function management objects;
means for receiving data based on the configuration objects;
means for decomposing said data based on the configuration objects;
means for interpreting said data source configuration objects;
means for performing at least one business function on the received data; and
means for returning the results of the processed information.

74. A method for supporting the process requirements for data reconciliation, comprising:
creating a library of data source configuration objects;
constructing a plurality of flexible business function management objects;
receiving data based on the configuration objects;
decomposing said data based on the configuration objects;
interpreting said data source configuration objects;
performing at least one business function on the received data; and
returning the results of the processed information.

75. A system for supporting the process requirements for data reconciliation, comprising:
a. a memory unit; and
b. a processing unit disposed in communication with said memory unit, said processing unit configured to:
construct a plurality of flexible business function management objects;
receive data based on the configuration objects;
decompose said data based on the configuration objects;
interpret said data source configuration objects;
perform at least one business function on the received data; and
return the results of the processed information.

76. A system for supporting the process requirements for data reconciliation, comprising:
means for creating a library of data source configuration objects;
means for constructing a plurality of flexible business function management objects;
means for receiving data based on the configuration objects;
means for decomposing said data based on the configuration objects;
means for interpreting said data source configuration objects;
means for performing at least one business function on the received data; and
means for returning the results of the processed information.
